(19) United States
(12) Patent Application Publication
(10) Pub. No.: US 2013/0304535 A1
(43) Pub. Date: Nov. 14, 2013

(54) BUSINESS SOLUTION MANAGEMENT (BSM)

(71) Applicants: David Cheng Hu, Foster City, CA (US); Charles Nelson, Gilroy, CA (US); Tim Landvoigt, Heidelberg (DE); James Tarver, Fremont, CA (US); Claribel Chan, Palo Alto, CA (US)

(72) Inventors: David Cheng Hu, Foster City, CA (US); Charles Nelson, Gilroy, CA (US); Tim Landvoigt, Heidelberg (DE); James Tarver, Fremont, CA (US); Claribel Chan, Palo Alto, CA (US)

(73) Assignee: SAP AG, Walldorf (DE)

(21) Appl. No.: 13/940,629

(22) Filed: Jul. 12, 2013

Related U.S. Application Data
(63) Continuation of application No. 10/624,860, filed on Jul. 21, 2003.
(60) Provisional application No. 60/397,320.

(51) Int. Cl. G06Q 10/06

(52) U.S. Cl. CPC G06Q 10/0637
USPC 705/7.27

(57) ABSTRACT

Systems and techniques to allow a user to design and manage business solutions. The business solution management system (150) comprises a portal layer (112), an application layer (104) and a data repository (106). The portal layer (112) comprises at least first and second agents (204, 208). The application layer (104) comprises at least first and second software applications (220, 224). The first and second agents (204, 208) provide user interfaces to the first and second software applications (220, 224). The first software application (220) is operable to allow a user to design a business solution with user parameters and user-selectable, pre-defined business process objects and pre-defined technology objects. The second software application (224) is operable to allow a user to manage the business solution. The data repository (106) comprises the pre-defined business objects (316) and pre-defined technology objects (314).

### CLAIM OF PRIORITY

The present application is a continuation of, and claims priority under 35 U.S.C. §120 to, U.S. patent application Ser. No. 10/624,860, filed Jul. 21, 2003, and entitled “Business Solution Management (BSM),” which claims priority to co-owned U.S. Provisional Application Ser. No. 60/397,320, entitled “Business Solution Management,” filed on Jul. 19, 2002. The entire contents of both earlier applications are incorporated by reference herein.

### BACKGROUND

Business entities are constantly trying to improve their ways of doing business, especially with new technology. Business entities are driven to improve their processes by internal pressure, i.e., owners, management, operators, suppliers and/or its customers, and external pressure, i.e., adversaries and competitors.

A “business solution” addresses or resolves internal and external business issues, and as a result, promotes growth and success of a business enterprise. A “business solution” may involve technology such as computer systems and software. A business solution may undergo constant changes, revisions and improvements. Changes in business solution methods, models, processes and systems are intended to improve the net results of the business enterprise. A complete lifecycle of a business solution can be divided into four phases: design, development, implementation, and management. The management phase of a business solution usually results in initiation of a design phase for one or more new or improved business solutions, which will replace, extend, or enhance the existing business solution. Business solution changes may be identified, defined, designed, created, and implemented while existing business solution methods, models, processes and systems are still operating productively.

Given the desire to improve business solutions, “business solution management” (BSM) is important to the success of a business entity. Business solution management may involve a large number of business users, including executives, managers, analysts, and performance experts from both the business areas as well as the information technology (IT) areas. Business managers understand that “business solution development” (BSD) is important both to increase demand and/or reduce costs to support demand. To successfully manage and develop a robust business enterprise, there should be a sustained focus on the development of business solution opportunities from concept up through the realization of business solution methods, models, processes and systems.

In addition to business solution development, business solution management may also include maintaining existing solutions to ensure that users can use them effectively and efficiently to produce the desired results. Before one can identify opportunities for improvements in the enterprise's business solution, one should be able to understand and manage the current solution. A current business solution's objectives, processes, configurations, hardware, software, and overall system architecture should be analyzed, monitored, and maintained with a sufficient level of detail to ensure optimal utilization by its users.

An enterprise may want to develop meaningful business solutions concurrently with advancing new supporting technologies. Business solutions for e-business processes may be complex. There may be extraordinary diversification and componentization of e-business technology and products. As a result, companies may view the technology landscape of e-business as a huge jigsaw puzzle of disparate or redundant technology components with incomprehensible acronyms that are fragmented, entangled, and impossible to navigate. Coupled with current economic conditions, business software customers are increasingly interested in designing and implementing a solution that aligns business objectives and goals during every step of the solution development process. Identification and evaluation of optimal business solutions can become incredibly complicated and confusing to all solution development participants.

A complete “business solution” may include (a) targeted business goals, objectives, and areas, e.g., a business solution could focus on increasing sales revenue for a certain product line by 30% in two years; (b) targeted business processes, e.g., a detailed analysis and improvement or replacement proposal for the sales channel management process could be included; (c) technology and/or product roadmap that will implement the business processes, e.g., sales system and infrastructure mappings of both the current and the proposed designs; (d) roll-out and management strategy of the solution, e.g., the plan includes prototyping, resource planning, implementation, and return on investment (ROI) measurements should be a part of a complete business solution; and (e) a comprehensive knowledge base that captures and retains all the business and technology information and experience from the creation and utilization of various business solutions throughout the lifespan of the company.

In general, conventional business solution management methods tend not to be integrated and automated by software applications.

### SUMMARY

The present application relates to computer systems, software and methodologies for business solution management (BSM). The BSM system described herein is a complete software application that enables a business enterprise to create and manage one or more business solutions. The BSM system may include a fully integrated, automated, computer-aided business solution (CABS), which includes an object-oriented design, software and services. The BSM system may allow a business entity to control an entire life cycle of a business solution from development, maintenance, management, enhancement, extension and/or replacement. The BSM system may allow an entity to engage in start-to-finish automated business solution management. The BSM system may provide a comprehensive methodology roadmap and tools that can integrate a proposed business design and technology engineering activities. The BSM system may include integration of backend business processes, integration of business processes across multiple collaborating enterprises, and support for these integration and collaboration goals.

Business solutions may be very small to very large and complex. Any business solution development effort should begin with a “methodology roadmap.” At the high end, the costs of defining, designing, evaluating, engineering, and implementing a complex business solution may be significant. High end business solutions may involve thousands of internal and external resources, from several unrelated vendors, over extended periods of months or even years.

The probability for successful development and realization of a business solution may be increased geometrically if there is a “methodology” or solution development technique that is well designed and well executed. There are some dominant “methodologies” in the environment today. These methodologies are an intrinsic, proprietary part of the services offered by a large consulting partner to the enterprise; a disparate aggregation of unrelated pieces of methodology provided by the variety of vendors to the enterprise; a homegrown stew of methods invented by the enterprise's own people; or some combination of these methodologies.

An enterprise's “methodology” is often a combination of methods. It is challenging to have these method combinations work effectively and efficiently together to develop a successful business solution. There are typically large areas of overlaps and many touch points. As a result, there are substantial risks of conflicts requiring resolutions between conflicting methods. Instead of conflict, there may be several critical solution development steps that are dropped between the cracks formed by disintegrated methods. The net effect on the enterprise is a serious potential for substantial waste in method resource efforts, substantial increases in time to implement a productive business solution, and a longer period before realization of their investment's value added to their business.

Some companies may provide methods, tools, and techniques for business solutions associated with software products. These software products have become increasingly useful for their respective focus areas. While there have been substantial improvements over the past few years in the methodology area, these tools are still predominantly focused on specific offerings and quite often unrelated to one another in an automated fashion.

The BSM system described herein may dramatically increase a business entity's probability for success, reduce or improve its time-to-value-added cost-of-ownership and return on investment (ROI), and improve its degree of innovation and agility. The BSM system may effectively and efficiently reduce a business enterprise's per initiative implementation costs across the entire spectrum of initiatives. Reduced costs may translate into additional product revenues from the company's savings in implementation or more competitive pricing.

The BSM system may touch on all levels of management and all sectors of the business. The BSM system may be used by decision-makers to individual expert users.

A high tech company has to manage many concurrent internal solution initiatives at a variety of phases across a global landscape of systems. The BSM system allows the company to evaluate alternative solutions more efficiently.

One aspect of the application relates to a business solution management system comprising software stored in a medium. The software is operable to allow a user to (a) design a business solution with user parameters and user-selectable, pre-defined business objects and pre-defined technology objects, and (b) manage the business solution designed by the user.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following figures.

FIG. 1 is a block diagram of a business solution management (BSM) system, which includes software and non-software business solution components.

FIG. 2 is a block diagram of a BSM technology architecture in accordance with an embodiment of the present application.

FIGS. 3A-3B show another block diagram of the BSM technology architecture of FIG. 2.

FIG. 4 illustrates a business solution development (BSD) methodology roadmap which may be implemented by the BSM technology architecture of FIG. 2.

FIG. 4A illustrates a hierarchy of business objectives and goals, a business solution or process, activities and steps.

FIG. 5A illustrates Functional Areas and Functions mapped to the methodology of FIG. 4.

FIG. 5B shows the Functional Areas and Functions of FIG. 5A.

FIG. 6 illustrates BSM user roles and their related BSM Functional Areas and Functions.

FIGS. 7A-7B show a user's design or model for a collaborative requirements planning scenario.

FIG. 8 shows a basic flow of activities that the system administrator may go through to set up roles, users, and integration interfaces.

FIG. 9 illustrates a high-level object model in the Solution Development Management functional area of FIG. 5B.

FIG. 10 illustrates a Methodology Management structure and the Solution Determination Structure (SDS) in FIG. 9 of the Solution Development Management (SDM) in FIG. 5B.

FIG. 11 illustrates a process of creating a BSM initiative in the Solution Design and Engineering functional area of FIG. 5B.

FIG. 12 illustrates a high-level object model in the Solution Design and Engineering functional area of FIG. 5B.

FIG. 13 illustrates an example scenario of Solution Development Management 516 of FIG. 5.

FIG. 14 illustrates creation of control objects 1004 with the Methodology Management structure and the Solution Determination Structure (SDS) in FIG. 10 of the Solution Development Management (SDM) in FIG. 5B.

FIG. 15 illustrates creation of classification control objects 1500 from the routines 1006 of FIG. 14.

FIG. 16 illustrates solution variants within a primary work area in Solution Design and Engineering.

FIGS. 17A-17B illustrates primary and alternate work areas in Solution Design and Engineering.

FIG. 18 illustrates a combined Solution Development Management and Solution Design and Engineering high level object model.

FIGS. 19A-19B illustrate a process of creating and specifying a BSM initiative, business area, process, and activity in the Solution Design and Engineering functional area of FIG. 5B.

FIGS. 20A-20B illustrate current and desired process business objects from a business process in FIGS. 19A-19B.

FIGS. 21A-21B illustrates a process-related technology solution work template.

FIGS. 22A-22B shows how a graphical assignment of business steps to technology objects may work.

FIGS. 23A-23B illustrates a final solution technology landscape or map.

FIG. 24 illustrates a Class diagram of a prototype application called ConcurrentEditor.

FIG. 25 illustrates a process of setting up a Business Connector (BC), an Advanced Planner and Optimizer (APO) and other configurations.

FIG. 26 illustrates project management and other functions of FIG. 5B.

FIGS. 27A-27J illustrate user views of sample graphical format business object templates which combine graphical and textual information in one depiction.

FIG. 28 illustrates an example of a parameter-based format business object template.

FIGS. 29A-34B illustrate examples of technology object templates 2900, 3000-3008, which are related to FIGS. 21A-23B.

Like reference symbols in the various drawings indicate like elements.

### DETAILED DESCRIPTION

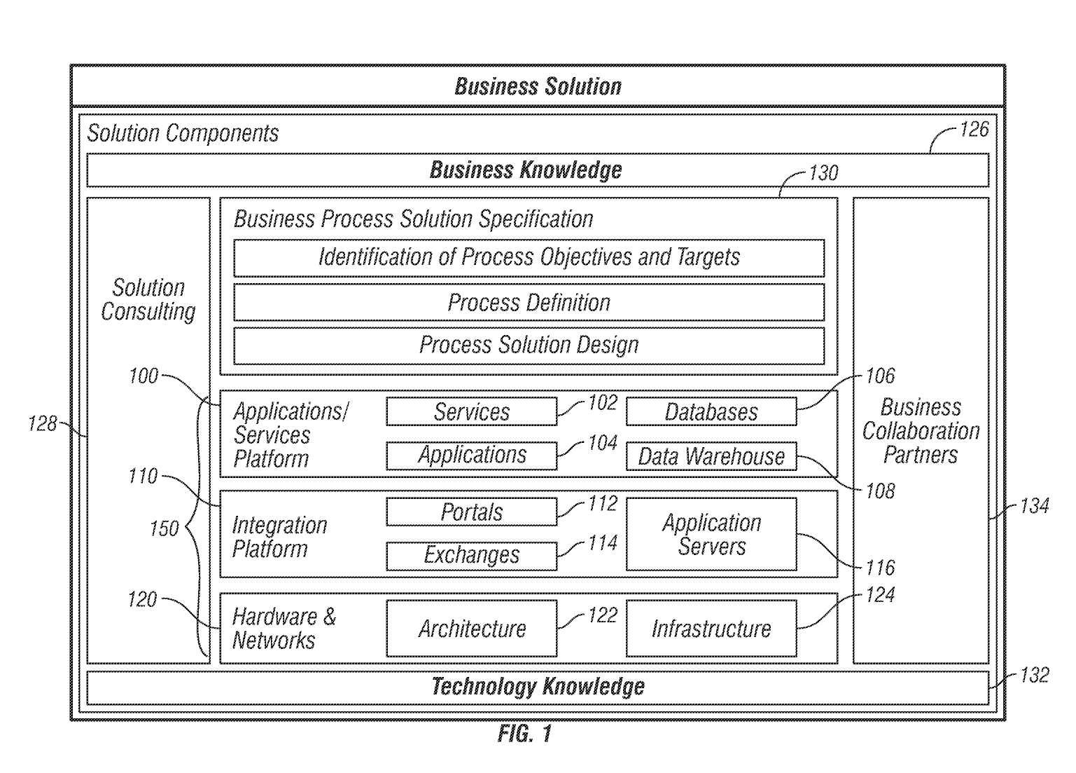

FIG. 1 is a block diagram of a business solution management (BSM) system 101, which includes software and non-software business solution components. Software business solution components may include an applications/services platform 100 and an integration platform 110. The applications/services platform 100 may include services 102, applications 104, databases 106 and a data warehouse 108. The integration platform 110 may include portals 112, exchanges 114 and application servers 116. Non-software business solution components may include hardware and networks 120, business knowledge 126, solution consulting 128, technology knowledge 132 and business collaboration partners 134. The hardware and networks 120 may include architecture 122 and infrastructure 124.

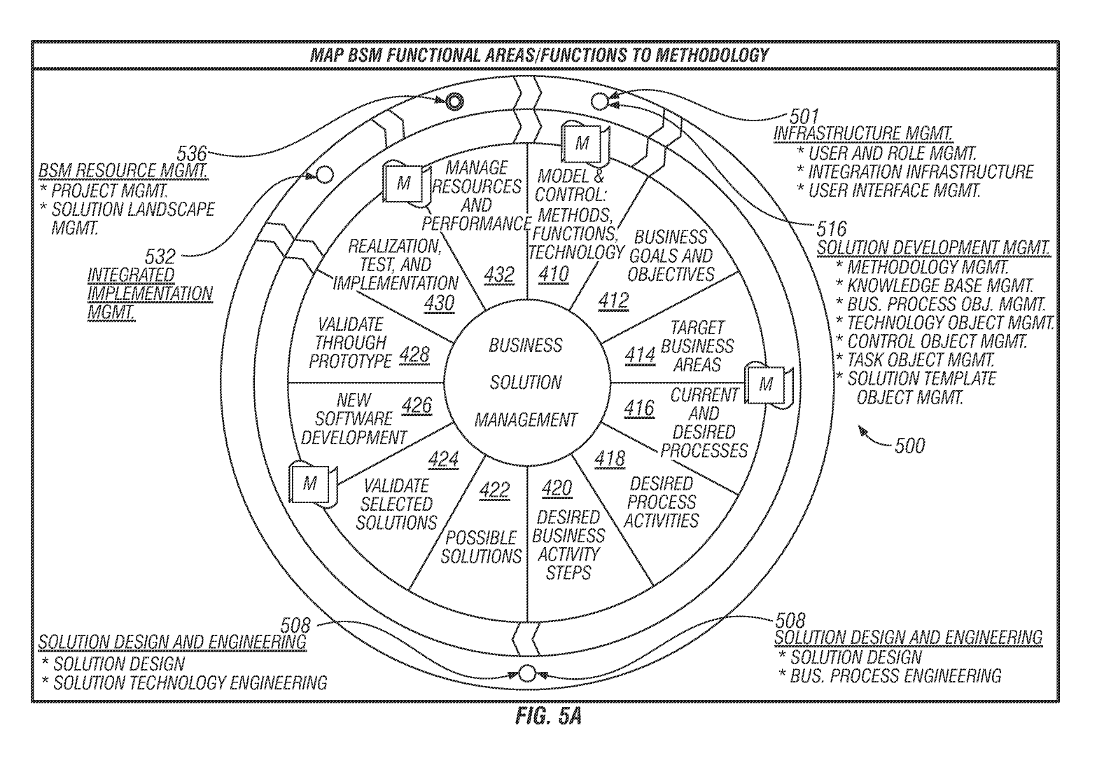

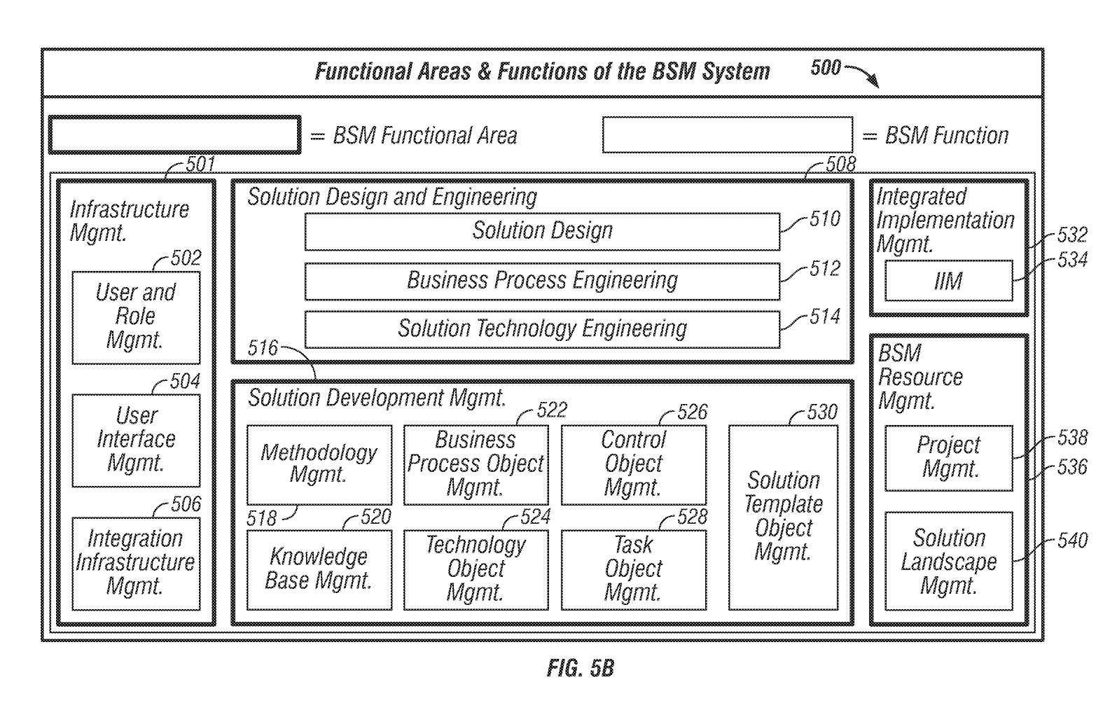

All components, business processes, and technology solutions within the BSM system 101 may be constructed in an object-oriented concept. For instance, the BSM system 101 may implement a question and answer process represented by instances of an object type that are defined as “parameter objects” (described below). Business components of a solution development effort may be defined as “business object” types, as described below with reference to Business Process Object Management 522 in FIG. 5B. Similarly, technology components utilized in the BSM system 101 may be implemented as instances of a “technology object” type. The complete object orientation of the BSM system 101 may achieve maximum flexibility and reusability of all objects in the BSM system 101.

BSM Technology Architecture

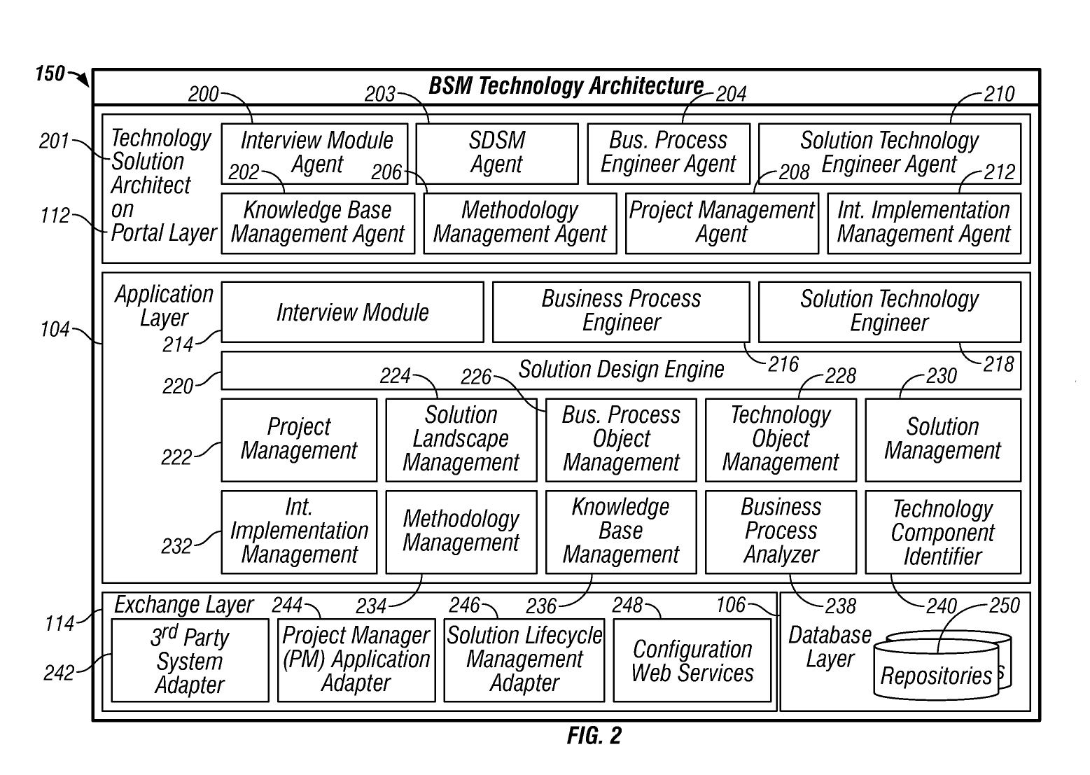

FIG. 2 is a block diagram of a business solution management (BSM) technology architecture 150 (also called “BSM system” or “BSM suite”) in accordance with an embodiment of the present application. The BSM technology architecture 150 may include one or more mySAP Technology components made by SAP AG of Germany, such as Portals, Web Application Server, and Exchange Infrastructure/Integration Platform. The BSM architecture 150 may be developed in accordance with SAP development standards, including Java programming language, Java 2 Platform, Enterprise Edition (J2EE) compatible constructs, eXtensible Markup Language (XML) and Extensible Stylesheet Language Transformations (XSLT) standards, and the Simple Object Access Protocol (SOAP). The BSM architecture 150 may be able to communicate with other SAP products or third party applications and infrastructure using standard web service channels such as Web Services Description Language (WSDL).

The BSM architecture 150 may be divided into four architectural areas or layers: a portal layer 112, an application layer 104, a database layer 106, and an exchange layer 114.

The portal layer 112 may take advantage of SAP portal technology to implement a unified user interface and access point. By using the portal infrastructure, BSM may extend many of its inherent features, such as authorization and personalization, to all functions within the BSM architecture 150.

The application layer 104 is where BSM application components 214-240 reside. Since development may be implemented on the SAP Web Application Server platform 100, the application layer 104 may have multiple tiers and/or multiple concurrent instances of the Web Application Server 100 to optimize performance and scalability.

The database layer 106 has a series of object repositories 250 and information storage structures, which may be accessed by BSM applications 214-240 through the Java Database Connectivity (JDBC) protocol.

The exchange layer 114 may be constructed on top of the mySAP technology exchange infrastructure. The exchange layer 114 may serve as the main communication conduit between the BSM architecture 150 and external applications, such as SAP R/3 enterprise. The communication method may be a XML-based document exchange using features offered by SAP exchange infrastructure.

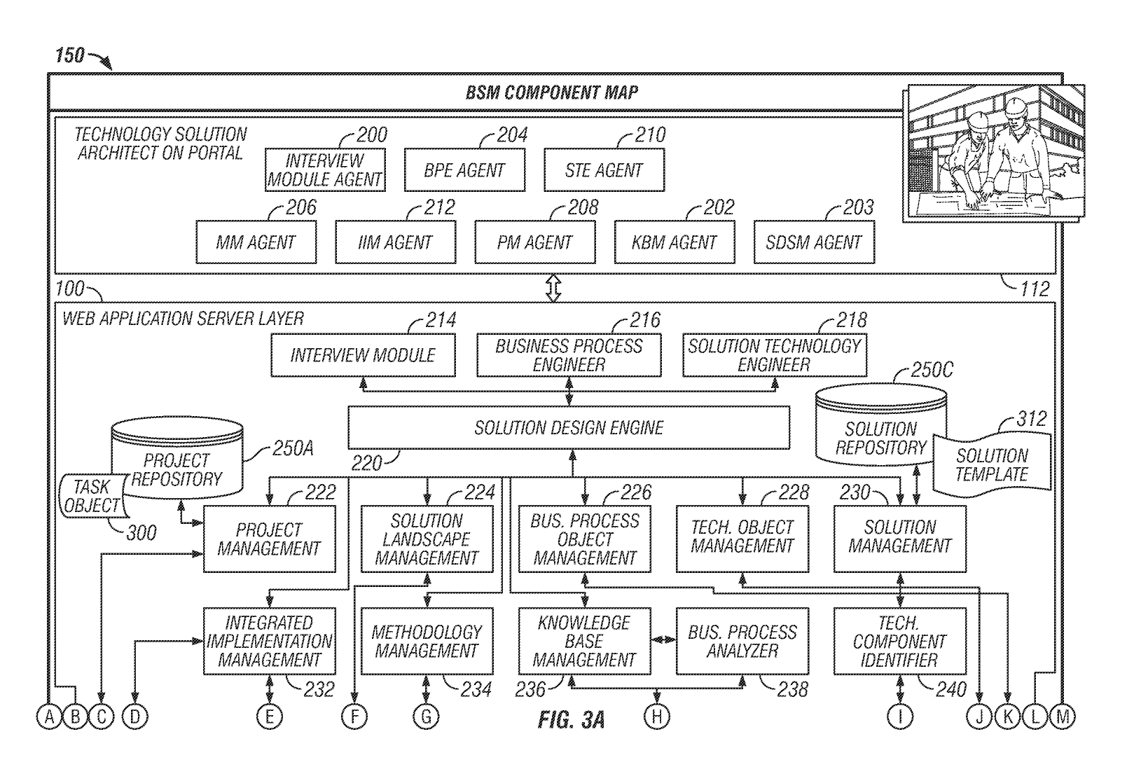

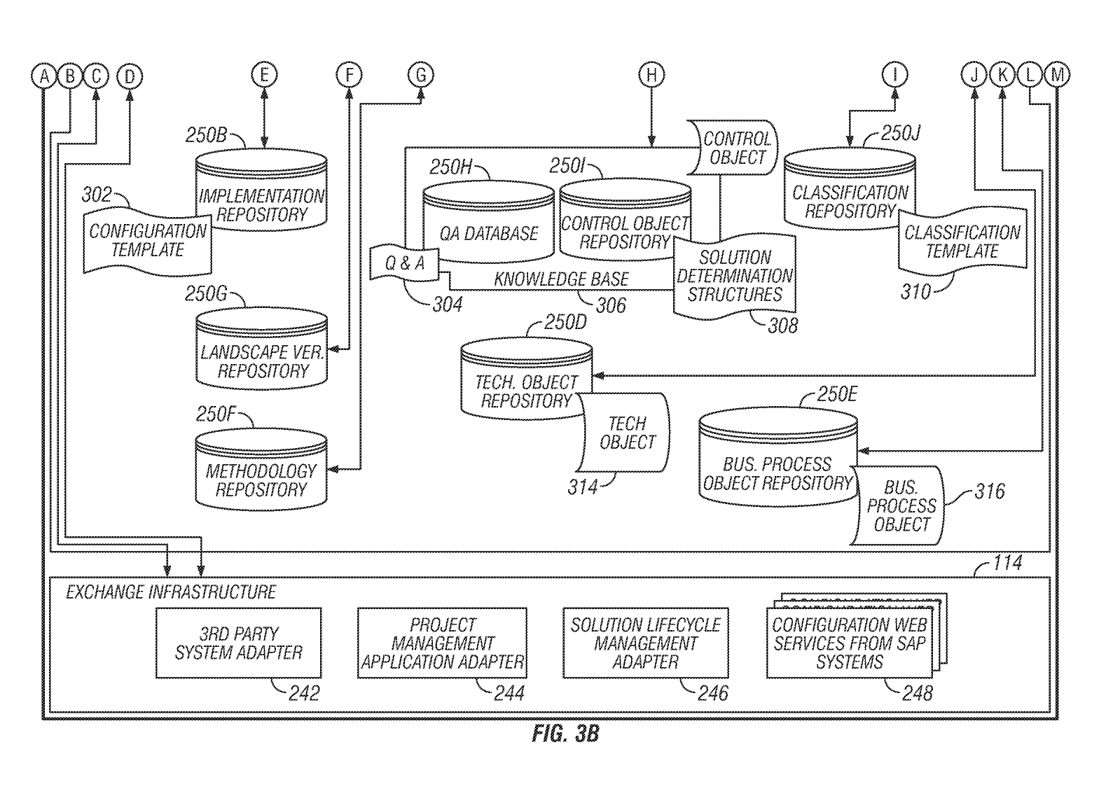

FIGS. 3A-3B show another block diagram of the business solution management (BSM) technology architecture 150 of FIG. 2.

Technology Solution Architect

A Technology Solution Architect (TSA) 201 in FIG. 2 may be a business package installed as an add-on package to a SAP Portal platform 112. TSA 201 may be viewed as a front-end control portal for an entire BSM application package in designing and managing a technology solution from a business process using a business solution development (BSD) methodology described below. The TSA package 201 may contain several iView application service components or agents 200, 202-212, such as an Interview Module Agent 200, a Solution Determination Structure Management Agent 203, a Business Process Engineer Agent 204, a Solution Technology Engineer Agent 210, a Knowledge Base Management Agent 202, a Methodology Management Agent 206, a Project Management Agent 208, and an Integrated Implementation Management Agent 212. The “agents” may be SAP Portal iViews.

The Business Process Engineer (BPE) Agent 204 is a user interface front-end of a Business Process Engineer application 216. The BPE Agent 204 may display (1) a tree structure that contains business process objects and their attributes and (2) a graphical window that shows different types of diagrams, which allow a user to graphically view and edit business processes.

The Solution Technology Engineer (STE) Agent 210 is a user interface front-end of two application components, a Technology Component Identifier 240 and a Solution Management application 230. A user may perform classification definition and management as well as technology/architecture construction using the STE agent interface 210.

The Methodology Management (MM) Agent 206 is a user interface front-end of a Methodology Management application 234. The MM Agent 206 may display a tree structure containing objects used by the BSM system 150 to model a Solution Determination Structure 308.

The Interview Module Agent 200 may act as the front-end user interface to access components of an Interview Module application 214.

Similarly, the other Agents 203, 202, 204, 208, 212 may act as user interface front-ends of applications in the Application layer 104.

BSM Application Components

As shown in FIGS. 2 and 3, the Interview Module (IM) application 214 may execute question and answer procedures. The Interview Module (IM) application 214 may communicate with a Solution Design Engine 220 to exchange information on appropriate questions and answers. The information is then transmitted to the Interview Module 214 and its agent 200 residing on the portal layer 112.

The Solution Determination Structure (SDS) Agent 203 and a Solution Determination Structure application 308 may be a multi-dimensional matrix that dynamically displays a nested tree structure of (a) business process objects, (b) system requirements implied by the business objects, and (c) technology objects to which the system requirements point. The Solution Determination Structure application 308 allows a user to map technologies to business needs.

The Business Process Engineer (BPE) 216 is a graphical modeling tool that communicates with a Business Process Object Management (BPOM) application 226 in order to display business process objects and generate business diagrams contained in the BPOM 226. BPE 216 can generate a multi-layered BSM business object modeler, as well as an integrated activity, use case, sequence, and class diagrams based on user input during a solution design. A user may graphically edit the generated models and diagrams. Changes made by the user are then reflected in the SDS 308 as well as the BPOM 226. Alternatively, the user may decide to build the business processes entirely from scratch in the Business Process Engineer 216 rather than starting the construction from the Interview Module 214. The resulting business process objects are also reflected in the SDS 308 and appropriate events may trigger inquiries from the IM 214. If the user creates new objects or modifies existing objects in the BPE 216, the BPE 216 should apply these changes to objects in the BPOM 226 accordingly.

The Solution Technology Engineer (STE) 218 is a graphical modeling tool that manages two major functions. The STE 218 handles graphical management of technology object component classification and communicates with the Technology Component Identifier 240. The STE 218 also handles graphical modeling and construction of a technology solution and communicates with the Solution Management application 230.

The Solution Design Engine (SDE) 220 is a central command center component for all solution design functions executed within the BSM application layer 104. The SDE 220 controls traffic and data communications between application components, agents residing in the TSA 201, and various object repositories 250A-250J in FIGS. 3A-3B. The SDE 220 may work in the background on the application layer 104.

A Knowledge Base Management (KBM) application 236 controls and manages a Knowledge Base 306 (FIGS. 3A-3B) in a database layer 106 (FIG. 2). The KBM 236 may include control object management, question and answer object (parameter objects) management, learning capabilities, and functions to manage a standard knowledge base such as indexing and fuzzy search. The KBM 236 may handle creation and maintenance of “Solution Determination Structures” (SDS) 308 (FIG. 2), which are structural chained constructions of parameter objects, solution determination procedures, and control objects to define a specific roadmap towards one or more possible solutions. The KBM 236 may control the application component Business Process Analyzer 238, which actually manages the rules and controls related to various parameter and technology object solutions.

The Knowledge Base 306 in FIGS. 3A-3B may collect and organize parameter objects, Q & As, system requirements, and control objects. The Knowledge Base 306 collects raw information regarding appropriate questions, which may be used in templates, and answers. Also, the Knowledge Base 306 may capture relationships between the Q & A and the derived question set. The Knowledge Base 306 may also handle searches, fuzzy questions, concept questions, and other typical knowledge base functions. The Knowledge Base 306 may have a certain degree of system intelligence coupled with standard data warehousing abilities.

A Business Process Analyzer (BPA) 238 allows users to design, create and manage “control objects.” The BPA 238 permits the creation of a forward-chaining, decision-making algorithm to guide the interview process from an initial set of questions all the way to the final system requirements. A “control object” defines the relationships and conditions among one or more “parameter objects.”

The Business Process Analyzer 238 may be invoked by the Knowledge Base Management 236 to serve as a rule-based engine to perform analytical tasks during the interview process. The Knowledge Base 306 may store all assigned control objects together with parameter objects.

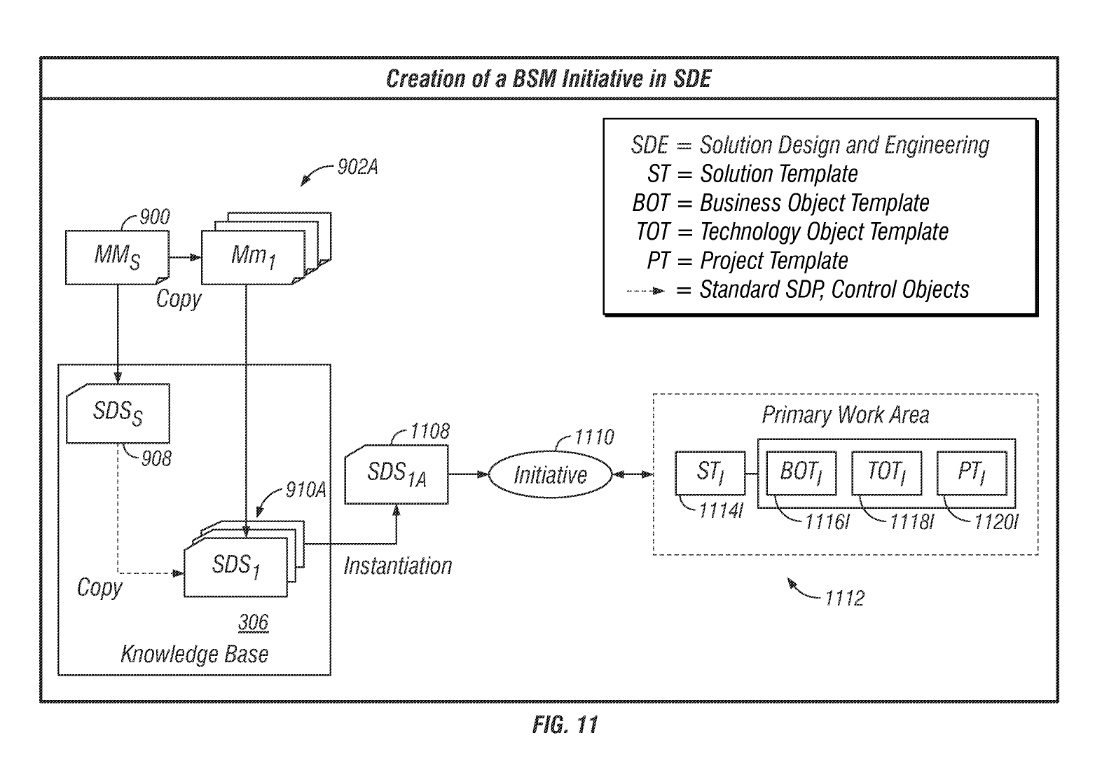

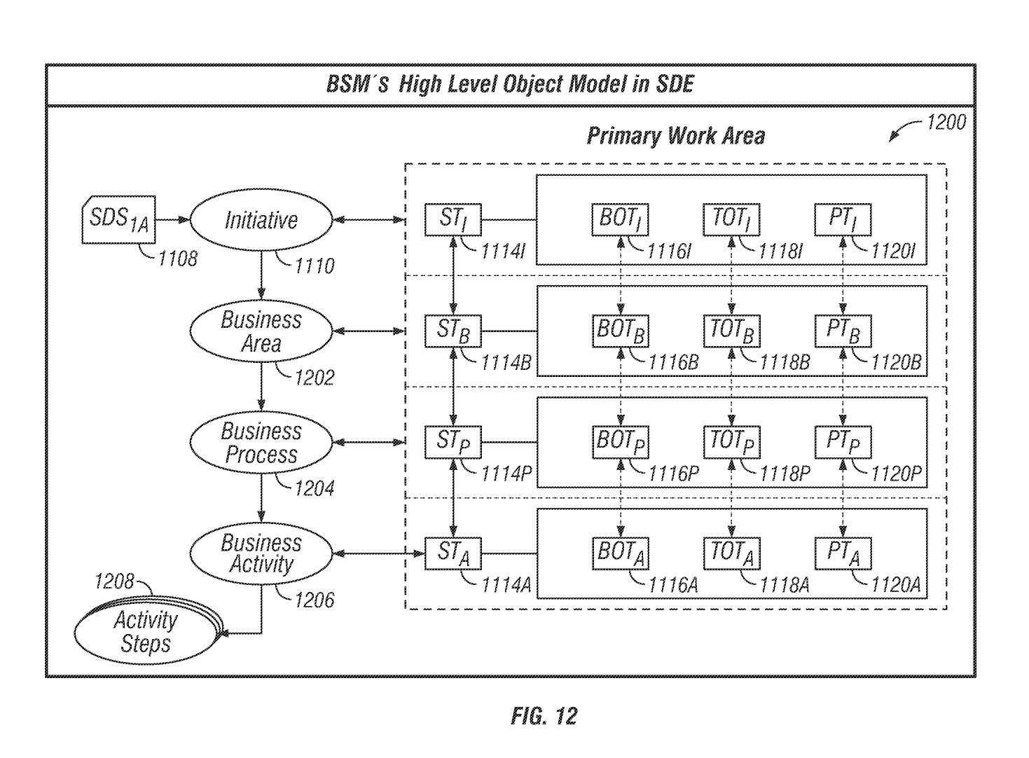

A Solution Management application 230 is the main controller of a Solution Repository 250C (FIGS. 3A-3B), which stores Solution Templates 1114 and Solutions (described below with reference to FIGS. 11-12) created by the BSM architecture 150. The Solution Management component 230 communicates with the Solution Design Engine 220.

A Technology Component Identifier (TCI) application 240 may be a classification system that supports multi-level class definitions (i.e., nested classes), multi-level characteristics definitions, and value assignment for the characteristics. TCI 240 may also support dependency, constraint definition, and classification object enforcement, as well as additional attribute assignments for instances of classes. TCI 240 may be very similar to classification systems used by SAP variant configuration and classification, such as iPC, as well as classification system products from other companies that focus on catalog management or multi-level configurable material management.

The Technology Component Identifier 240 may be invoked by the Solution Management application 230 to identify a particular class object, which can either be a representation of a Business Process Object or a Technology Object and to propose possible characteristics value determination procedures. The Technology Component Identifier 240 manages a Classification Repository 250J (FIGS. 3A-3B) with its pre-defined classifications (class definitions) and actual class objects.

A Business Process Object Management (BPOM) application 226 internally provides functions for creating and modifying business process objects and their attributes. The BPOM 226 has its own repository, Business Process Object Repository (BPOR) 250E in FIGS. 3A-3B. The Solution Design Engine 220 invokes BPOM 226 by either interpreting requests sent by BPE 216, MM 234, SM 230, or by its internal processing logic.

A Technology Object Management (TOM) application 228 internally provides functions for creating and managing technology objects and their attributes. TOM 228 has its own repository, Technology Object Repository (TOR) 250D in FIGS. 3A-3B. Similar to BPOM 226, the Technology Object Management component 228 is invoked by the Solution Design Engine 220.

A Project Management (PM) application 222 may process and formulate a schedule of multiple tasks in the form of a project plan. The PM 222 utilizes each task object invoked through association with each business process object and each technology component in the architectural landscape. The PM 222 incorporates these objects into a multi-level project plan. All the projects (with version control) are stored in a Project Repository 250A in FIGS. 3A-3B.

Project Management 222 can communicate with an external object-based project management application, such as Microsoft Project or the SAP R/3 Enterprise PS module to export/import project plans through Integrated Infrastructure using industry standard XML and WSDL protocols (defined above). Specific mapping and routing requirements should be determined during a Solution Development Management phase of the methodology described below.

Methodology Management (MM) 234 provides functions for modeling a methodology that determines the parameters of business solution development within the BSM architecture 150. A standard Methodology Structure may be included with the BSM system 150, but others may be created as well. Methodology Management 234 uses a Methodology Repository (MR) 250F in FIGS. 3A-3B for storing methodology and parameter objects.

An Integrated Implementation Management (IIM) application component 232 in the BSM suite 150 may provide an Integrated Implementation Management function. The Integrated Implementation Management function allows a user to make all solution component configurations within a single system. The Integrated Implementation Manager 232 stores the entire solution configuration in an Implementation repository 250B in FIGS. 3A-3B. For a business solution consisting of multiple components (where a component is an atomic part of the overall solution from a product view, e.g., APO, CRM, Enterprise Portal, R/3), all configurations necessary to run the solution can be performed in one central place, the Integrated Implementation Manager 232. Since each component may require configuration data to be in a particular format, IIM 232 transforms the configurations into formats recognized by the various components involved in the business solution, and then transmits the configuration data to the solution components.

A Solution Landscape Management (SLM) component 224 retrieves technology components in the architectural landscape, which are stored as Solution Templates, and structures them in a coherent manner for review and evaluation. SLM 224 may enforce version control. Every version of solution landscape snapshot can be linked with a corresponding project in the Project Management component 222 for a complete analysis of a BSM project.

BSM Functions

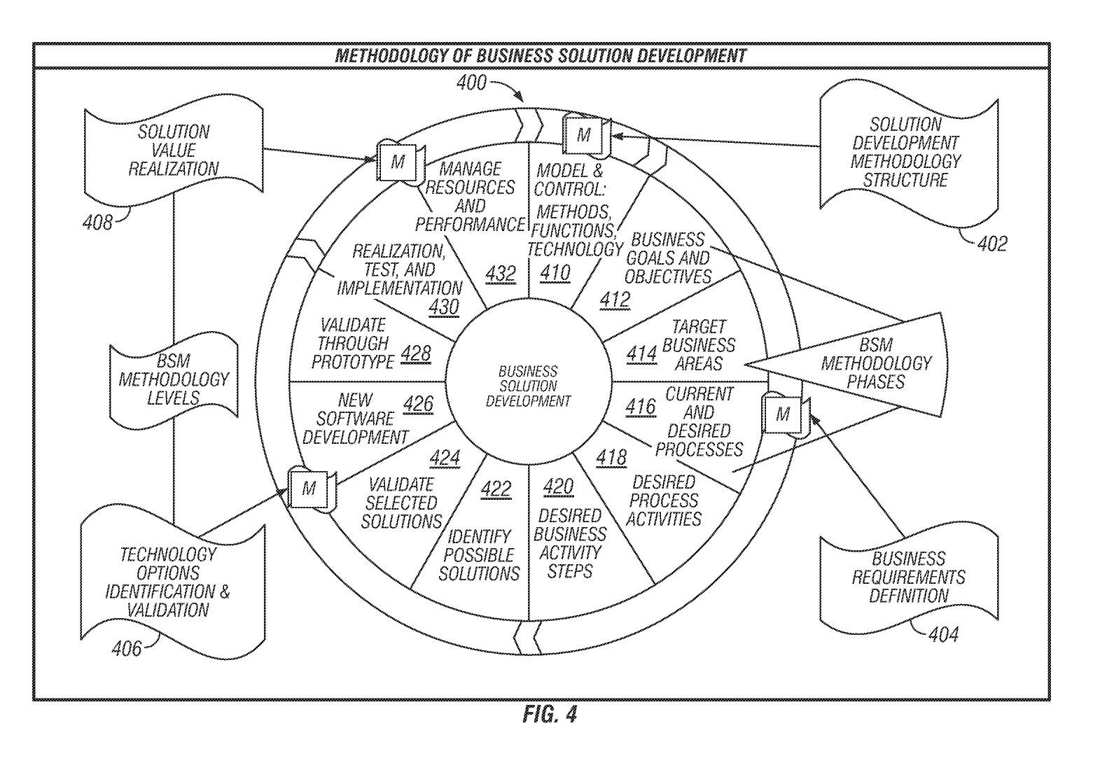

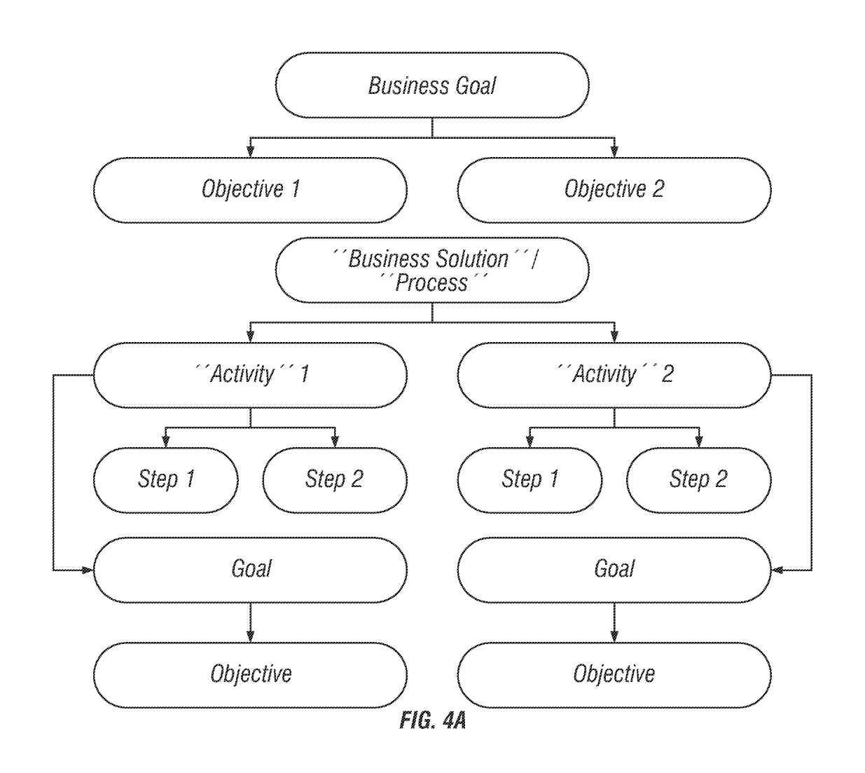

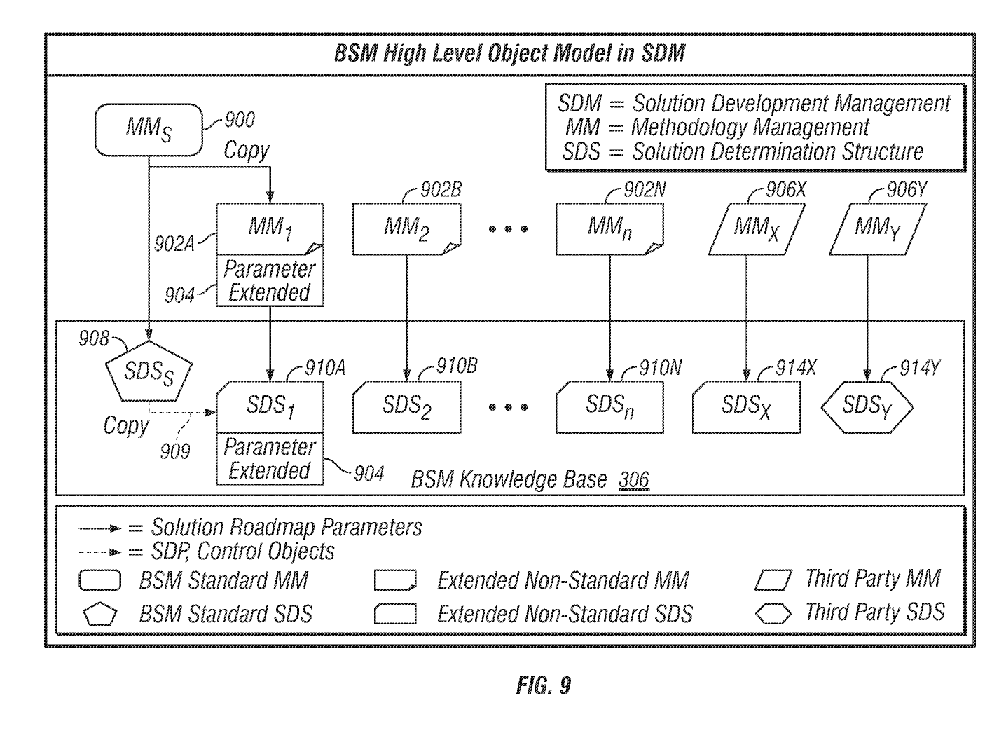

Functions of the BSM system 150 may be divided into two major categories: Business Solution Development and Solution Landscape Management. As used herein, Business “Solution Development” in FIGS. 4-5B refers to an overall abstract development of a business solution. “Solution Determination” in FIGS. 2-3 refers to specific, tangible work or tasks executed with actual procedural steps at a more detailed level than “Solution Development.” The tasks may be consolidated into the “development” of a business solution. “Solution design” is the first initial stage in a “solution development” project. First, a user starts with an initial “design” of what a business solution will look like from a higher level. Then the user creates a “Solution Determination Structure” 908 (FIG. 9) that will expand and drill down into detailed level of the “design” to figure out what exactly needs to be done. Then the user would use the final outcome from the result of running the Solution Determination Structure 908 using the BSM system 150 to realize the business solution.

Business solution development (BSD) methodology and related technology applications may only reflect levels of knowledge that were available when the BSD methodology and technology applications were created. The key requirements regarding knowledge as it relates to business solution management include: timely and meaningful acquisition of knowledge; maintenance of that knowledge in a structured repository; optimal access to that knowledge repository by users; and application of that knowledge in the best ways possible to develop business solutions.

Some enterprise software may be in pieces, i.e., the software focuses on industry-specific needs. Some enterprise software may accumulate knowledge to create solution maps, collaboration process scenarios, and industry-software solutions. This knowledge may be passed back to the enterprise for its business solution development. However, the enterprise software's processes of knowledge acquisition, maintenance, access, and application may be relatively limited in their degree of automation and integration with one another.

The BSM system 150 may make liberal use of all existing SAP Solution Lifecycle Management (SLM) and mySAP solutions, tools, functions, and designs that would support or complement the design described herein.

The BSM system 150 may provide a solution and technology foundation that has several common market applications. The BSM system 150 may help define, plan, design, engineer, and realize business solutions that produce computers, airplanes, ships, buildings, etc.

SAP has recently created a technology roadmap that establishes the SAP vision of future business software architecture. Since SAP crafted components of mySAP Technology to meet business solution challenges that companies are and will be facing, the BSM system 150 may liberally employ these components as a basis. The benefits of SAP's R/3 Enterprise Server, Supply Chain Management (SCM), Customer Relations Management (CRM), Product Lifecycle Management (PLM), Business Intelligence (BI), Human Capital Management (HCM), Portal infrastructure, Web Applications Server, and Exchange Infrastructure, in addition to other SAP technology or methods within its other components, may be applied comprehensively to support the demands of business solution management processes within the BSM system 150.

Business Solution Development

Business Solution Development (BSD) functions may be designed to operate in a landscape of heterogeneous solution components. BSD functions may encompass business requirements definition, mapping requirements to technology components, installations, configuration of technology components, design and realization of new software development, validation, testing, and implementation. BSD functions may include:

(a) definition of an individual business solution development initiative, including business objectives and goals; this may be called a “methodology roadmap”;

(b) a knowledge repository 250 (FIGS. 2-3) that contains relational linkage of defined business areas, processes, activities, steps, etc.; technology components that provide the related solutions; and configuration/customization as it applies to these components, all within a heterogeneous technology component landscape;

(c) an interactive question & answer (Q & A) roadmap, encompassing an entire business solution development spectrum of business and technology issues within a heterogeneous technology component landscape, which may draw on the knowledge repository 250;

(d) a graphical toolset that completely supports interactive modeling of business flows, processes, activities, steps, etc.; the business modeling graphical toolset may be completely integrated with the Q & A roadmap and a similar graphical toolset that focuses on the technology aspects of the business solution;

(e) a graphical toolset that completely supports the interactive modeling of technology components, interfaces, and flows that provide the related solutions in a heterogeneous landscape; this technology modeling graphical toolset may be completely integrated with the Q &A roadmap and the business solution modeling graphical toolset; and

(f) active and progressive links to installation, configuration, customization, and implementation of heterogeneous solution components.

Business Solution Development Methodology

The BSM system 150 may provide an out-of-the-box methodology that is completely setup and integrated throughout a standard BSM solution.

FIG. 4 illustrates a business solution development (BSD) methodology roadmap 400 which may be implemented by the BSM technology architecture 150 of FIG. 2. The methodology 400 includes:

(a) management of a business solution development initiative, including project management demands;

(b) identification and definition of multiple levels 402-408 and phases 410-432 of the business solution development methodology 400;

(c) business requirements definitions 404 from high level strategic objectives, goals and models down to the lowest intrinsic business activity steps;

(d) technology requirements definitions from high level systems down to the lowest intrinsic component definition and configuration to support a business step;

(e) validation 424, 428 on paper or in prototype form of one or more possible solution sets for the business requirements; and

(f) installation, configuration, testing, and implementation 430 of the desired solution set.

Furthermore, the BSM system 150 may recognize that a single provided methodology applied by the standard BSM system 150 may be insufficient to meet every business solution development challenge for every company. The BSM system's object-based design may therefore permit the enhancement or extension of the supplied methodology by the enterprise, i.e., allow users to efficiently load their own complete, alternative methodology and to make the BSM linkages to these other models with minimum difficulty.

Business Solution Development Knowledge Repository

The BSM system 150 may provide a fully integrated knowledge repository 250 that supports both business and technology solution objects in an automated fashion. The repository 250 may provide efficient acquisition of knowledge. The knowledge repository's structure may be object-based, pre-loaded with pre-determined content (e.g., from SAP), permit easy enhancement and/or extension of standard content, and allow a user to load knowledge to the repository 250.

The structure of the repository 250 may support multiple access channel demands with optimal application of the knowledge. Possible sources of theses access demands may come from a BSM business graphical modeling tool, a BSM technology graphical modeling tool, and an interrogative Q & A modeling tool.

Business Solution Development Solution Determination Q & A Roadmap

The BSM system 150 may supply a fully-integrated solution determination tool (e.g., Interview Module 214 in FIG. 2) that provides an interrogative-based solution Q & A process. A primary design objective is to use the knowledge repository content to arrive at a complete solution design that enables all methodology phases 410-432 from the start of a solution initiative through implementation.

The Solution Determination Structure 308 (FIG. 2) should come standard with pre-determined design and engineering content, such as content from SAP. However, the design of the Solution Determination Structure 308 and its maintenance should permit the enhancement or extension of the pre-determined content, as well as the loading of one or more complete alternative structures (described below). Further, the Solution Determination Structure 308 should employ both rules-based and classification/dependency-based methods (described below) for providing relational strings of business and technology solutions. Finally, the Solution Determination Structure 308 should support both graphic and non-graphic functions for Solution Design and Engineering 508 (FIG. 5B).

Business Solution Development Graphical Modeling

There may be two separate but integrated graphical-based solution modeling tools, one for “business modeling” and one for “technology modeling.” The business graphic modeling tool may include the business process engineer 216, business process object management 226 and business process object repository 250 in FIGS. 2-3. The business graphic modeling tool may be comprehensive and dynamic, with active integration links to the Solution Determination Structure 308, technology graphic modeling tool, configuration, and project management tool. These links may apply the knowledge repository and methodology through rules-based and dependency-based determination procedures.

The BSM system 150 may provide pre-loaded business objects 316 (FIGS. 3A-3B) for modeling, which gives the user the opportunity to start from some basic known components or from predefined strings of business solution components. Pre-defined objects permit a much faster focus and definition of the desired business down to the sub-atomic step levels. Again, a user can add his or her own objects to the overall object model, and the objects may include related parameters and linkages to the knowledge repository 250, Solution Determination Structure 308, technology modeling, and configuration aspects of BSM.

The BSM business graphic modeling tool may have a solution approach that graphically builds solution components as an evolving, layered combination of UML use case diagrams, activity diagrams, sequence diagrams, etc., which may result finally in focused, well-defined business activities down to the step level. The BSM business graphic modeling tool may be user-friendly for all users, but its predominant users may be business solution designers, engineers, and software developers.

The technology graphic model tool may include the solution technology engineer 218, technology object management 228 and technology object repository 250D in FIGS. 2-3. The technology graphic model tool may be comprehensive and dynamic, with active integration linkage to the Solution Determination Structure 308, business graphic modeling tool, configuration, and project management tool. These linkages may apply the knowledge repository and methodology through rules-based and dependency-based determination procedures.

The technology graphic model tool may utilize a comprehensive architecture of standard technology components. The overall technology model may be delivered already predefined. Further, technology solution components may come preloaded, solution-defining attributes completely setup, and linked to their appropriate generic technology solution components. The user may add new generic components to the technology model, and/or new solution components and related linkages to generic components.

The technology modeling tool may have a solution approach that graphically activates or deactivates generic solution components and/or individual, vendor-specific technology solution components. The technology modeling tool may be user-friendly for all users, but its predominant users may be business solution designers, engineers, and software developers.

Business Solution Development Project Management

A solution development initiative should have some form of project management to be successful. The BSM system 150 may provide an active link between results derived from Q & A and/or graphic modeling to automatically define the hierarchy of project management structures. These structures may include nested projects, project task items, assigned roles, various management charts, assignments, status management, notes, collaborative planning, history archiving, etc. Emphasis may be placed on resource management, enabling proactive planning and acquisition of all desired forms of resources for the initiative, project, item, and/or task. The “resources” should include people by attribute level (skill, experience, education, health, etc.), machines (development versus productive), software components (solution development versus productive), networks, etc. The project planning should apply solution network planning at the initiative, project, item, or task levels to manage constraints and optimize resource loading based on rules or dependencies.

The integrated project management tools should allow linking planned and actual cost and revenue values to roles, tasks, and projects. Automated standard ROI, Payback, time-adjusted return on rate of return (ROR), cost center, etc., analyses should be provided. Key performance indicators (KPIs) should be linked to project items and tasks. Alerts may be provided that permit management to respond to project management issues in a timely fashion.

Business Solution Development Integration and Execution

The BSM system 150 may extensively employ an object-based design. The BSM system 150 may provide internal integration between all of its solution development and solution management functions. This level of integration enables a BSM user to work in their preferred manner, and the BSM system 150 assures that overall integration is maintained. For example, solution design and engineering may be done in any one of three areas: the Q & A interrogative area, business graphical modeling, or technology graphical modeling. The BSM system 150 may update results of work from one area to other areas.

Another example is the level of integration between initiative planning, financials, project management, solution network analyses and monitoring, and solution design and engineering. There may be tremendous productivity, control, and organizational gains derived from their integration in the BSM system 150. This level of integration may provide substantial value to every aspect of business solution development.

Solution Landscape Management

Solution landscape management (SLM) may be the other major focus of the BSM system 150 besides Business Solution Development (BSD). BSM's solution landscape management functions permit the various solution-interested parties within the business enterprise to maintain the solutions within the overall, heterogeneous enterprise landscape. SLM's functional scope and design objectives may include:

ongoing maintenance of the entire heterogeneous landscape of the enterprise's business solution network;

architecturally- or functionally-based taxonomies of technology components, several of which can be grouped to structures representing a coherent functional unit within the overall solution network;

fully linked and integrated repositories 250 of each initiative, whether completed or in progress; each initiative may contain configurable attributes from Q & A, graphical business models, and graphical technology models, version attributes, rules- and dependency-based resolutions, etc.;

ability to utilize existing solution network components in defining related enhancements, extensions, and/or replacement solutions;

maintaining cost and revenue values associated with initiatives; and

resource management analyses and reporting.

Business Solution Development Methodology Roadmap

A business solution development initiative may begin with a methodology roadmap. The methodology may provide a comprehensive, solid basis and still permit expansion and extension, or the complete application of alternative solution methodologies within the same BSM architecture 150.

FIG. 4 is now described in greater detail. FIG. 4 illustrates a BSM solution development methodology roadmap 400, which may include a plurality of methodology levels 402-408 and phases 410-432. Each “methodology level” may be used to describe one aspect of an initiative's solution development, such as (a) defining the foundation of the solution development initiative 402, (b) establishing key business designs and requirements 404, (c) determining the technology solutions desired 406, and (d) realizing and implementing 408. Each level may provide a general description or categorization of one or more methodology phases.

Solution Development Methodology Structure Level

Solution development initiatives may vary from very simple to extraordinarily complex. A solution development methodology structure level 402 may provide a desired scope, flexibility and power for solution development with pre-defined and user-defined objects. It may be advantageous to define as much as possible within the solution development methodology level 402 before going on to any of the other levels 404-408 of the methodology 400. This establishes the business solution development pieces before putting the puzzle together. It may, however, be difficult to define all pieces of a solution before constructing that solution. Therefore, it is expected that the solution development methodology level 402 may be accessed and utilized on many occasions throughout a business solution's development.

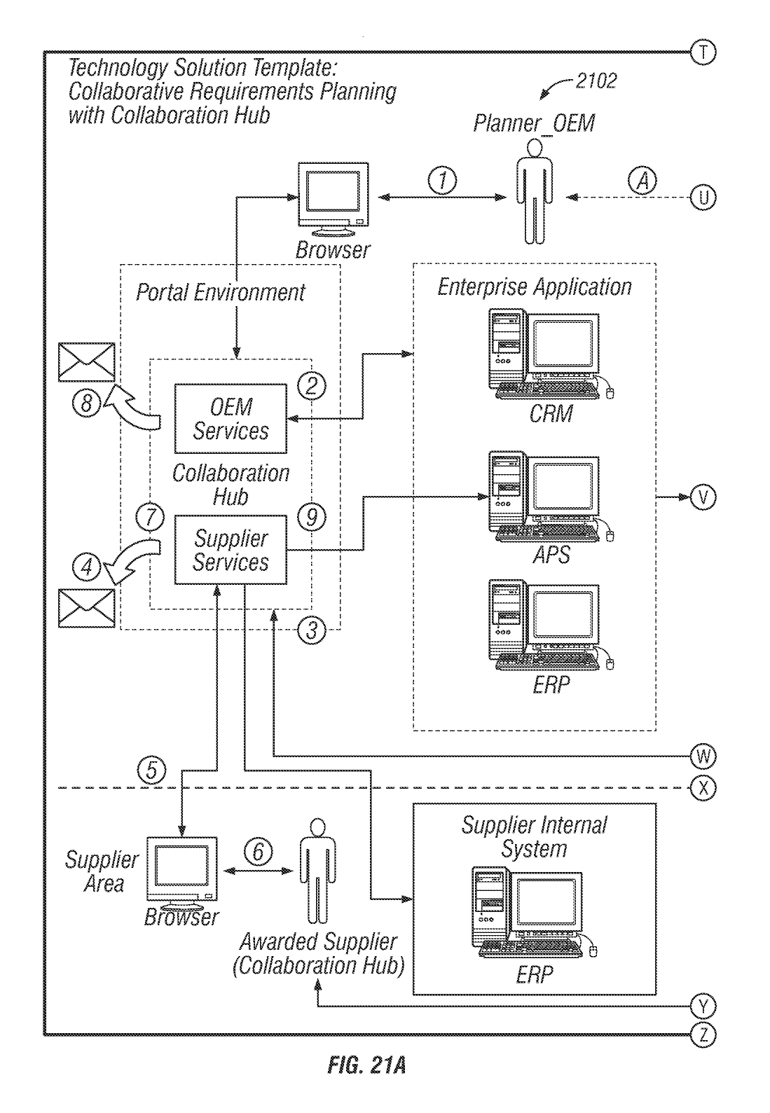

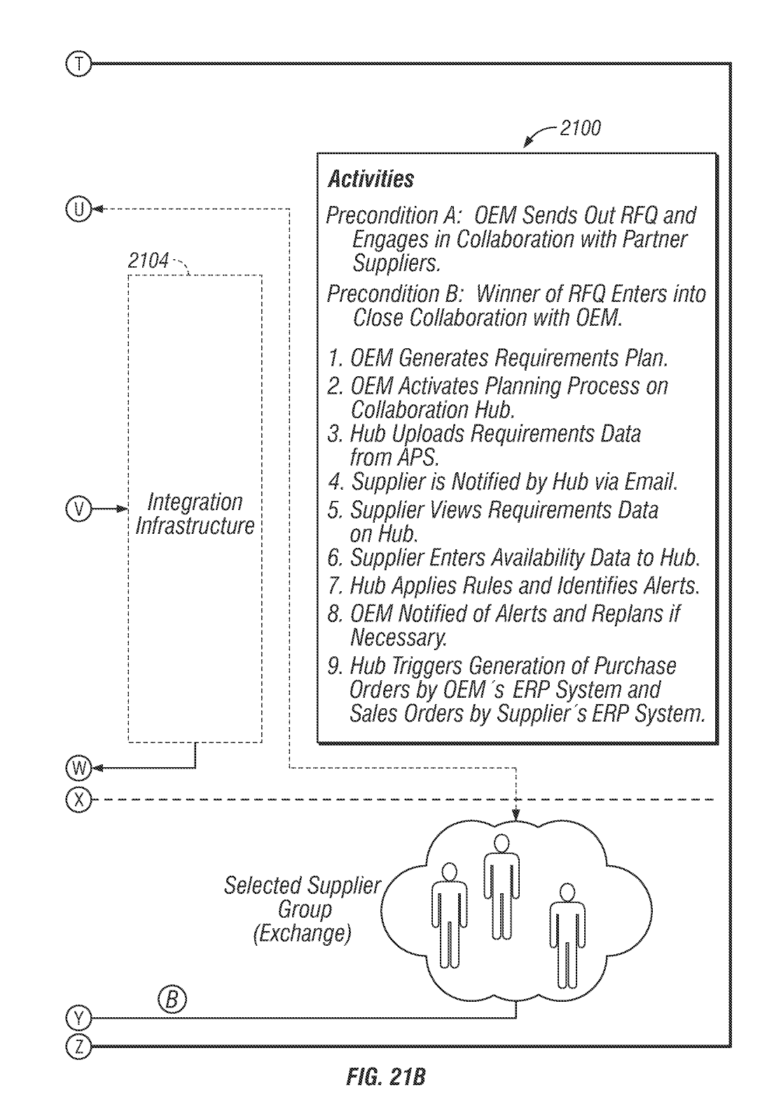

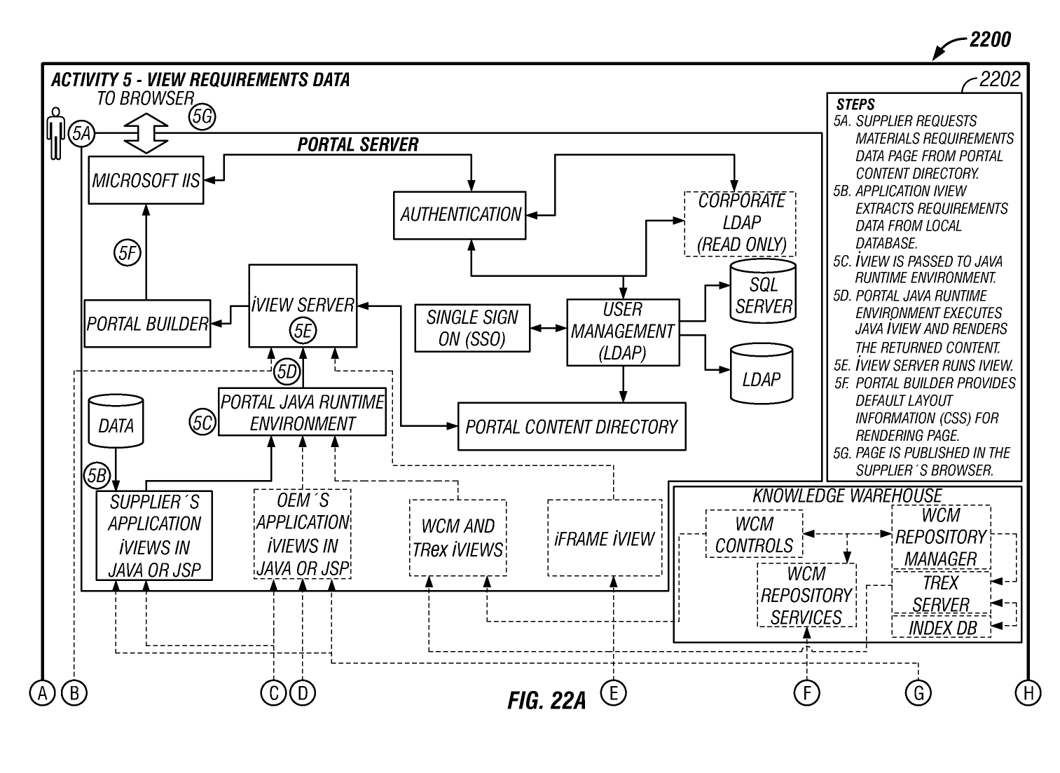

The solution development methodology level 402 may have a model and control methodology phase 410 for identifying, defining and assigning solution determination structures, methods, functions and technologies. Solution determination structures may, for example, provide maximum solution development flexibility in friendly and easy-to-use ways. These structures may provide desired levels of personalization and control within all BSM user interfaces, e.g., agents 200, 202-212 in FIG. 2. These structures may provide integration infrastructures 2104 (FIGS. 21A-21B) for internal BSM processes as well as for external solution systems. These structures may provide reusable key business processes, technologies, controls, and tasks. These structures may provide rules-based and dependency-based solution determination engines to drive the solution development process. These structures may provide a knowledge base repository 250 for automated solution definitions.

Business Requirements Definition Level

The BSM solution development methodology 400 may establish business requirements as a primary driver of an effective solution. A business requirements definition level 404 may focus on collecting, identifying, structuring and applying requirements to define and design business solutions. Business requirements may be defined throughout the business requirements definition level 404 and may revert back to the solution development methodology structure level 402 to change existing business solution determination structures or to develop additional structures and relationships. The business requirements definition level 404 may include five phases 412-420.

FIG. 4A illustrates a hierarchy of a business goal, objectives, business solution or process, activities and steps. A business goals and objectives methodology phase 412 (FIG. 4) may support the definition of a solution development “initiative” in terms of core business “goals” and “objectives” that establish the initiative's purpose and direction. In addition to an initiative description, these “goals” are important because they provide the mechanism for keeping solution activities in sync with the initiative's goals. Each “goal” should have one or more related business “objectives” that establish the metrics to be employed in determining success. Examples of objectives may include improvements in performance, financial results, quality parameters, quantity parameters, timeliness, efficiency, effectiveness, usability, etc. These “objectives” define the what, who, and when of key solution development performance indicators.

A target business areas phase 414 may build on the direction and purpose defined in the business goals and objectives phase 412. The target business areas phase 414 identifies targeted “business area(s)” where the general initiative's strategic business objectives are to be focused and where the related measurable goals are to be realized. FIG. 12 shows the hierarchy of an “initiative” 1110 and a “business area” 1202. Examples of “business areas” might be as broad as sales, procurement, or manufacturing. Alternatively, “business areas” may be more focused such as direct sales, direct material procurement, or make-to-order manufacturing.

In addition to a description of the “business area,” there may be a statement of the “objectives” and related “goals” that are ascribed to each individual business area that are more specific than, but still consistent with, the “objectives” and “goals” defined at the initiative business goals and objectives phase 412. Efforts in the target business areas phase 414 provide a more definitive mechanism for keeping solution activities in sync with the initiative's goals.

Extending on the initiative's information, the business area's objectives define the what, who, and when of key solution development performance indicators as they affect the business area, and in terms of results unique to the business area. Again, any “goal” may have one or more related business area “objectives” that establish metrics for the goal.

A current and desired processes phase 416 defines a desired business “process” within the target business area. Examples of business “processes” may include resale channel sales forecasting, request for quotations and order fulfillment distribution. The current and desired processes phase 416 of the methodology 400 may provide a critical process-centric focus. In addition to a description of a business “process,” there may be objectives and related goals defined for the specific, individual business process which are consistent with the business objectives and goals defined for both the related initiative and business area.

Where a current process is to be extended, enhanced, or replaced by a new desired process, it is possible to define, evaluate and compare both the current and desired processes. Unlike previous phases 412, 414 within the business requirements definition methodology level 404, the current and desired processes phase 416 may go beyond defining process objectives and goals. The “process” may be defined by a sequenced flow of activities, where the output or result of one activity becomes the input for a follow-on activity. The process identifies of all participating actors or entities across a defined chain of activities.

A desired process activities phase 418 defines each “activity” within a “process.” The individual activity's description, objectives and goals are defined to be consistent with the objectives and goals of the related “process.” The desired process activities phase 418 identifies participating actors, e.g., users or systems performing a defined role in person-to-person, person-to-system, or system-to-system actions. Just as a “process” is made up of a chain of one or more “activities,” an “activity” is made up of a chain of one or more “steps.”

A desired business activity steps phase 420 may be the lowest phase of the business requirements level 404, where “steps” of an activity are defined. By definition, a “step” has a declared purpose and should result in a defined change in some key object that is critical to the successful completion of an activity. Each step's purpose is described, and the “step” is defined by (a) a participant executing the step, (b) all forms and sources of desired data, (c) an initiating event or result of a preceding step that triggers this step, and (d) and an expected change or result on an identified object of the activity. “Steps” are described further below with reference to FIG. 12.

Technology Options Identification and Validation Level

Business solution development is driven by business requirements defined in the preceding methodology level 404. A technology options identification and validation level 406 defines technology components that will permit optimal realization of these expressed business requirements. Realization is labeled “optimal” because typically one technology component is a better fit for the desired business activities than another technology component. Alternatively, there may no technology components that will completely meet the desired business design. It is advisable to take the best fitting of two or more competing technology components solutions.

The technology options identification and validation methodology level 404 may be focused on (a) identifying and validating a select few possible technology components and networks; (b) developing any additional functionality that is desirable to meet the business requirements and fully develop the solution; and (c) selecting one or two best-fitting solution component network composites to prototype. As the process of technology selection produces a more refined picture of possible solutions, the process may revert back to the structure methodology level 402 described above to change existing technology solution component structures, or to add new structures of technology solution component and create new relationships with existing structures with the final purpose to create an improved business solution.

The technology options identification and validation level 406 may include four phases 422-428. An identify possible solutions phase 422 identifies a number of possible technology solution components that will meet the business requirements. Throughout the business requirements definition methodology level 404, each attribute of the desired business processes, activities, and steps that is defined is actually defining a parallel landscape of desired technology components. These attributes eliminate a need for some types of technology and focus on other types of technology. The technologies in scope here include everything from software to hardware, and from networks to servers, etc.

As the identify process 422 defines the most detailed of the proposed solution attributes, the identify process 422 narrows the selection of vendor-specific solutions that deliver these attributes. Thus, this identify phase 422 of the business solution development methodology 400 produces specific structures or solution component networks that appear to be excellent candidates to deliver the desired results.

A validate selected solutions phase 424 validates a select number of identified possible solution component network alternatives. The validate selected solutions phase 424 may establish a number of test cases. Each test case is designed to define a method for testing a solution's ability to meet the desired business requirements. As each test case is defined, there may be changes or additions to the structures and/or requirement attributes described in the earlier methodology levels 402, 404. The methodology 400 recognizes the fluidity of definition and realization parameters.

The validation process may use configuration of components along the lines of the test cases' requirements. The result of this phase 424 may be to focus on the possible alternates. Where no existing options exist, the next phase 424 determines the optimal new software development opportunities.

A new software development phase 426 may develop new software to fill any gaps recognized in the preceding phase 422. The gaps are completely defined as steps, activities, and/or processes that may be filled. Any development is again validated against the associated test cases. Any gaps may be filled by tested new software developments.

A validate through prototype phase 428 creates working prototypes of the best possible one or two solution component networks. These prototypes represent scaled models of key activities and processes, defined with an appropriate balance between cost, valued added, and management of risks associated with doing less than complete solution tests.

In this technology options identification and validation level 406, any of the selection and validation efforts may produce results that take the business solution development back to previous phases for additional validation, additional equipment, or additional new software development. These recursive phases within the same phase, among phases with a methodology level, or among levels of the methodology, are expected.

Solution Value Realization Level

The primary objective of the business solution development methodology 400 thus far has been the definition and creation of an optimal business solution throughout levels and phases discussed above. A solution value realization level 408 covers the realization of the desired business solution in a productive context, as well as the ongoing needs for project management throughout all levels 402-408 of the methodology 400, in two methodology phases 430, 432.

Solution realization, testing, and implementation 430 brings together all of the parts of the overall solution into one comprehensive productive technology solution network. On the other hand, project management is important to planning and task management throughout the process of business solution development.

The realization, test and implementation phase 430 begins with a complete definition of a preferred business solution. This “business solution” is made up of one or more “business activities” (FIGS. 4A and 12) across one or more solution technology component networks. It is quite likely that testing has not occurred across the complete productive implementation of the overall solution.

First, the BSM system 150 may pull the business solution together into the one comprehensive overall business solution defined in the business requirements definition and created in the solution technology landscape. The “realization” of the complete solution enables the BSM system 150 to do the first complete testing in an expected production environment. This again may need changes to the structures and relationships defined in earlier levels and phases, based on experiences with unforeseen limitations or opportunities that are identified here.

The testing extends the previous limited test to the complete activities and processes of the initiative. Master data, control data, interfaces, integration, etc., are completely tested here. When these tests are successfully completed, the BSM system 150 can sign off the implementation for production. However, business solution development should not be signed off until some period after implementation assures that the solution's bugs and kinks have been satisfactorily worked out, and the risk to the enterprise is acceptable.

The success of business solution development may not be achieved without a strong commitment to management of (a) project resources and (b) the performance of project tasks against expectations. A Manage Resources and Performance phase 432 of business solution development may not be performed chronologically, i.e., the phase 432 may be performed on an ongoing basis literally from the definition of the objectives and goals of the strategic solution development initiative.

There may be a variety of resources desired to deliver a business solution. Skilled and knowledgeable people may be the most critical resources, but one should also have the proper systems, networks, software, etc., available at the right place and at the right time. Project and resource management 432 begin with effectively planning efficient disposition of resources in an optimal manner to achieve the desired results. Project planning should be done at the “task” level. “Tasks” should be collectively identified to deliver a “project.” For some initiatives, the scope of the projects may need a nesting of projects within other projects.

Finally, performance should be measured against expectations on a timely and meaningful basis. These measurements produce information that allows project leaders and managers to coordinate deliverables across all facets of the solution development scope. In addition to task performance and percentage completed, it may also be important to establish buffers for resources and deliverables, especially where some key resources are commonly used in multiple tasks or in situations where there is a dependency between the results of one task or project and the successful completion of another task or project. The performance management should be used to re-optimize the resources and project planning to meet the best possible expectations.

BSM Functional Areas

As stated above, the BSM system 150 provides two focus areas: Business Solution Development and Solution Landscape Management, i.e., management of the enterprise's overall business solution landscape. A solution development initiative should be viewed in the context of the enterprise's existing business solution landscape. Similarly, the business solution landscape of the enterprise would be incomplete if new initiatives' solution developments in progress were not incorporated.

These two BSM focus areas may have a substantial degree of overlap, but the design emphasizes integration of all BSM components in FIGS. 1-3 as well as integration of BSM components to external systems (FIG. 1) to define, create, validate, and implement solutions in the productive landscape of the enterprise.

FIG. 5A illustrates Functional Areas 501, 508, 516, 532 and 536 and Functions mapped to the methodology 400 of FIG. 4. FIG. 5B shows the Functional Areas 501, 508, 516, 532 and 536 and Functions of FIG. 5A. A Solution Design function 510 is included in a Solution Design and Engineering Functional Area 508. FIG. 5A shows that the functional composition of BSM (FIG. 5B) is designed to support the business solution methodology 400 (FIG. 4) defined above.

BSM User Roles and Related BSM Functions

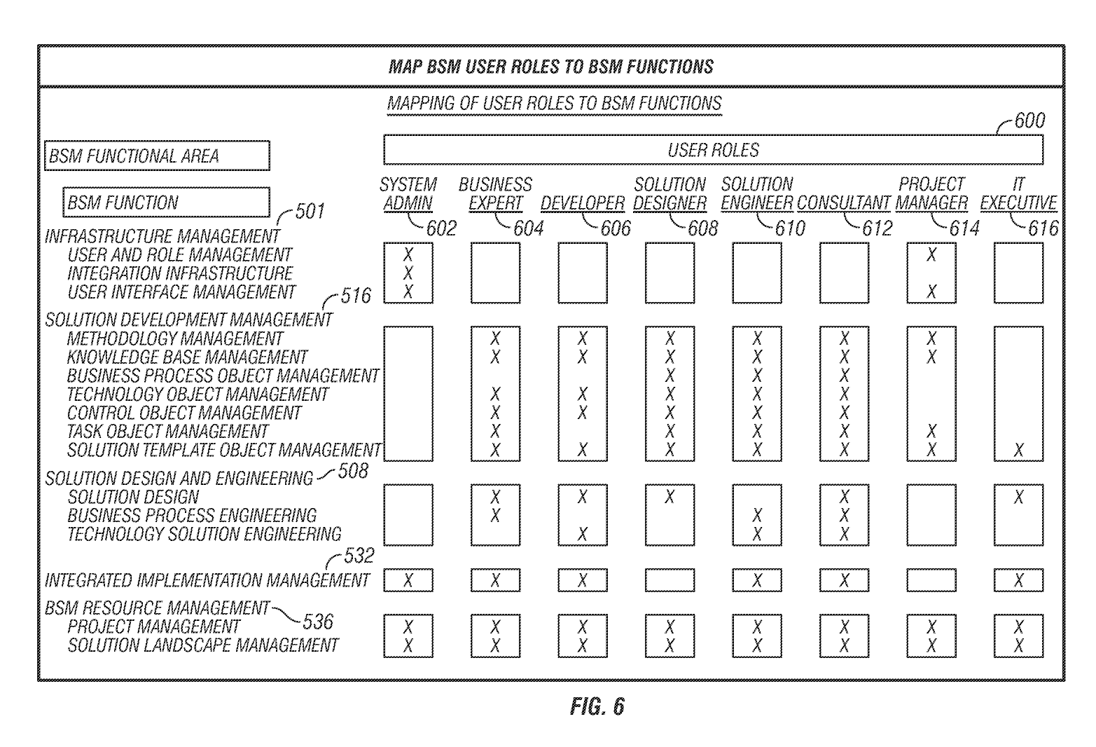

There may be several key user roles in an enterprise that employs the BSM system 150 of FIG. 2. FIG. 6 illustrates BSM user roles 600 and their related BSM Functional Areas 501, 516, 508, 532 and 536 and Functions.

A System Administrator 602 sets up and maintains the BSM system's master data and configuration and supports the operation of the BSM system 150 by its users.

A Business Expert 604 is a member of the user community. The Business Expert 604 has the business domain knowledge that is critical to successful business requirements definition, solution design, and solution engineering. The Business Expert 604 may also be a champion of an initiative or a key stakeholder.

A Developer 606 creates enhancements to current software components or creates new software components.

A Solution Designer 608 defines and designs business process and activity solutions to the business requirements, and/or defines and designs the technology components of the solution to the technology requirements.

A Solution Engineer 610 engineers the business process and activity solutions to the business requirements, and/or engineers the technology components of the solution to the technology requirements.

A Consultant 612 supports the definition of business and/or technology requirements. The Consultant 612 may also provide advice, testing, and implementation resource for the business process and activity solutions to the business requirements, and/or for the technology components of the solution to the technology requirements.

A Project Manager 614 manages a solution project through all phases from creation of Initiatives to Implementation.

An Information technology (IT) executive 616 may be a CIO, CTO, or VP of IT. The IT executive 616 is a principal IT decision-maker responsible for the enterprise's business solution management, whether a solution that is in production or a solution development that is in progress.

BSM Functions

Following is a description of Functional Areas, Functions of FIGS. 5A and 5B and a common scenario across all of the BSM Functional Areas. The common scenario provides examples throughout the Functional Area descriptions below of how the BSM system 150 would work within each Functional Area. The common scenario assumes that the BSM system 150 is used to replace an existing requirements planning process with a collaborative requirement planning process between an original equipment manufacturer (OEM) and key suppliers on critical components and sub-assemblies that the OEM purchases.

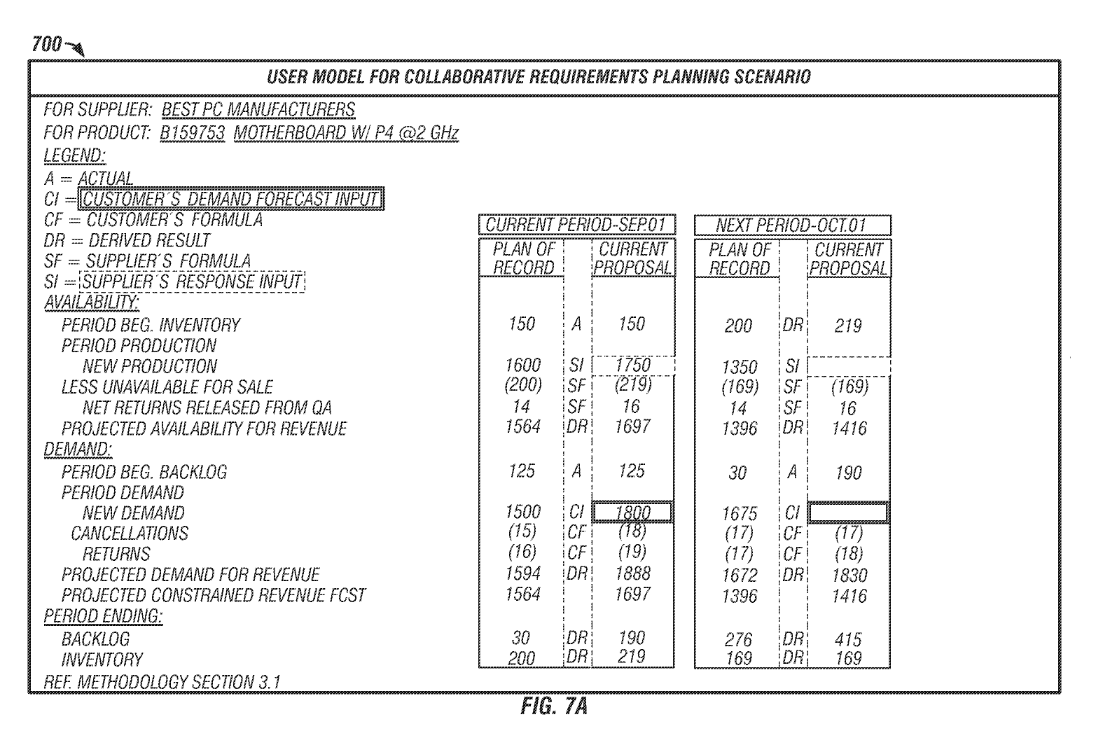

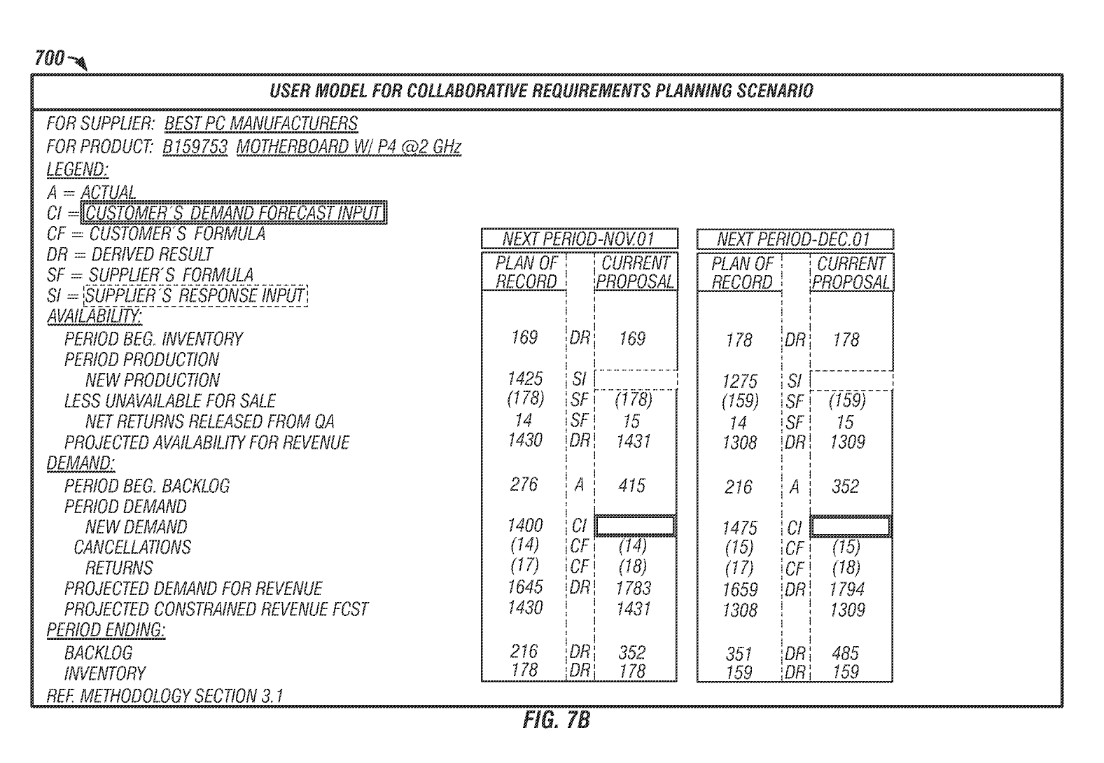

FIGS. 7A-7B shows a user's design or model 700 for a collaborative requirements planning scenario.

Infrastructure Management

Secure and optimal utilization of the BSM system 150 by its users may be a primary concern. There may be significant value provided by the BSM system 150 in pre-defining and applying reusable objects, structures, and relationships that are critical to the work of business solution management. The BSM system 150 may provide integrated configuration of various technology components, as well as final cross-component integration of an overall solution landscape. An Infrastructure Management functional area 501 in FIG. 5B may include User and Role Management 502, User Interface Management 504 and Integration Infrastructure Management 506.

User and Role Management

User and Role Management 502 may include:
A definition of the user roles within the BSM system 150;
A definition of worksets within the BSM system 150;
A definition of authorization requirements for the BSM system 150;
An assignment of worksets to user roles;
An assignment of authorization requirements to user roles;
An assignment of individual users to user roles; and
Secure access to appropriate BSM content and operations without multiple log-ons required.

The system administrator 602 may be the primary user responsible for these definitions and assignments with the input of users and management.

The BSM system 150 may span all levels and phases of solution management. The various user roles (FIG. 6) involved in the different phases of solution development as well as solution landscape management may be managed within the BSM system 150.

The definition of “worksets” is an activity that results in the grouping of BSM's steps, activities and processes. Authorization parameters may be defined for access and utilization of these worksets.

Distinct user profiles or user roles may be separately defined and created (e.g., FIG. 6). Then the worksets are assigned to the user roles. Authorizations are assigned to the user roles and related worksets. Finally, individual BSM user IDs may be created, and the desired roles are assigned to the appropriate user IDs.

These structures and assignments ensure that every user of the BSM system 150 is presented the right functions and data after log-on. These structures and assignments also enforce security by applying authorizations to functions and data, so that every user can only access designated information. Furthermore, these structures and assignments enable personalized information for every user, allowing for example individual configurations of the user interface or individual work items to be saved per user.

In addition to these tasks, the BSM User and Role Management function 502 enables a project manager 614 to assign activities, steps or deliverables to user roles and/or users. In this manner, project tasks may also be defined within the workset and role-based definition of the BSM system 150.

A key technology component of the User and Role Management function 502 is a central directory for all user, role, and workset information. The central directory provides an administrative user interface for the system administrator 602 as well as an application program interface (API) which permits access to other system components. The central directory may be based on SAP's Portal Content Directory, which is part of the mySAP Portal Infrastructure.

User Interface Management

A User Interface Management function 504 may include:
Improved user performance through an enriched, synchronized, and coherent presentation of information;
A common corporate user interface strategy that provides a complete and consistent user experience;
A single, integrated interface for every user providing a well-defined and well-organized working environment; and
A customizable look-and-feel that permits personalization of contents and functionality.

The User Interface Management 504 is the portal for BSM roles at the individual user level. Any user who uses any BSM application in the Application layer 104 in FIG. 2, whether to design questions or answers, to execute solution design engineering process, or to manage a BSM project, should utilize this role-based, workset-centric portal as the sole gateway into the BSM system 150.

The User Interface Management function 504 relies on the Technology Solution Architect (TSA) component 201 (FIG. 2) within the BSM system 150 to allow communication of objects across a common object model design that is implemented by integrated BSM object repositories 250. For the user, a simple logical drag and drop movement will trigger a backend cross-component action. This functionality streamlines and unifies the various activities of business solution management in one work area. Moreover, when information in one section in the portal 112 is modified, synchronous updates should immediately be visible in other related sections. The TSA component 201 within the BSM system 150 may be based on SAP Portals technology.

Integration Infrastructure

An Integration Infrastructure Management function 506 may include:
Management and execution of BSM's outbound communication to external software applications;
Management and execution of BSM's inbound communication from external software applications; and
Offering these communication services to all BSM functions and components.

As shown in FIG. 1, there are several points where the BSM system 150 should be integrated with various external systems involved in solution management. The Integration Infrastructure function 506 may be used directly by the system administrator 602 responsible for configuring BSM's integration with external systems. The Integration Infrastructure function 506 may be used indirectly by all user roles 600 in FIG. 6, since it supports all external communications of all components of the BSM system 150.

The system administrator 602 maintains a BSM integration repository (not shown) by loading all possible BSM-to-external-system interface descriptions. All possible integration adapters, WSDL message format transformation mapping, internal or external APIs, URLs, transport protocols, etc. may be maintained in this integration repository.

An interface directory may also be maintained. The integration repository may be the source for the integration directory's definition and configuration contents.

Before sending internal and after receiving external messages, the data may have to be transformed into different formats. A BSM integration engine (not shown) executes the transformations based on pre-defined WSDL mapping schemas stored in the Integration Directory. Transformation of messages may need access to the object repositories 250 (FIGS. 3A-3B) for attributes, meta data, as well as the actual data set (payload) of the instance of an object class. The response could also be abstract information for an object (e.g., object definition).

After data transformation and mapping, data may be sent to external applications and data may be received from external applications. The data communication functionality may be the lowest layer in the integration infrastructure 2104 (FIGS. 21A-21B), which includes executing queuing and routing of messages. Based on content of a message, which includes message type, sender ID and receiver ID, the data communication function determines and then associates this data with the physical addresses of the source or destination systems. All communication may be performed using secure communication standards.

The BSM integration repository, directory, engine and server may be based on the mySAP Exchange Infrastructure technology.

Applying the BSM Infrastructure Management function 506 to the Collaborative Requirements Planning example/scenario (FIGS. 7A-7B) is now described. The user role described here is the BSM system administrator 602. The activities and steps encompass the setup utilizing various components of the BSM system 150.

The BSM system 150 may be delivered with pre-defined and pre-configured user roles, worksets, authorization profiles, and predefined assignments of worksets and authorizations to the user roles, which may encompass many of SAP's offerings. However, the system 150 will allow a user to define additional roles, worksets, authorization profiles, and related assignments. This can be done by creating a completely new “object” and defining it. As another approach, the user can copy an existing “object,” assign a new ID, and then change, delete or add what they wish to that object. These objects and assignments may be delivered as part of the Technology Solution Architect (TSA) component 112 within the BSM system 150.

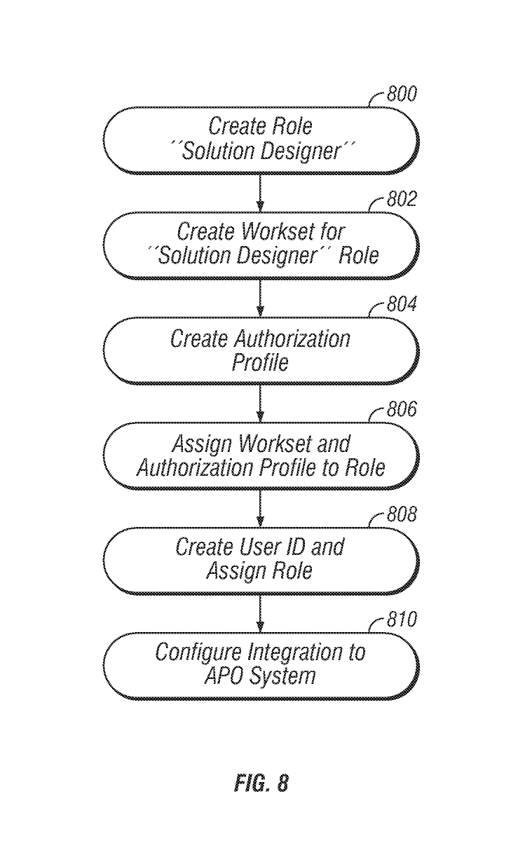

FIG. 8 shows a basic flow of activities 800-810 that the system administrator 602 may go through to set up roles, users, and integration interfaces, which enables BSM users to create a Collaborative Requirements Planning business solution (FIGS. 7A-7B).

In block 800, the system administrator 602 creates a new role called “Solution Designer.” The system administrator 602 creates a user role ID, a role title, and a role description as attributes for this object. These activities and actions are executed in the BSM Portal Role Editor (not shown). The system administrator 602 may copy a BSM pre-defined role, e.g., “Designer,” into the Role Editor to facilitate the creation of “Solution Designer” role simply as a copy of the “Designer” pre-defined role. The description above indicates that the Solution Designer 608 is responsible for all solution design activities associated with the definition of business requirements, the business structures of the solution, the technology components of the solution, the configuration and testing of the components of the solution, etc.

In block 802, the system administrator 602 identifies or creates a “workset” (transactions, data, and views of the activities) that a Solution Designer 608 will use to perform the scope of this role. Various BSM activity tools (transactions, data, and views of the activities) may be grouped into one or more “worksets,” which may be defined at a very high level such as functionality area, or a very lower area such as a specific activity within a function. The system administrator 602 assigns the comprehensive BSM solution design activities of the Solution Development Management functional area 516 to a workset. The system administrator 602 may create a separate workset to encompass Solution Design and Engineering 508 and a third workset for Project Management 538.

In block 804, the system administrator 602 creates a new authorization profile for a user permitted to change a design object that has been created by another user. The BSM system 150 may include many pre-defined authorizations and authorization profiles.

In block 806, the system administrator 602 assigns this Design object change authorization to a new or existing Design authorization profile that provides the desired secured access and utilization that a user will need to perform the role of Solution Designer 608. “Authorization profiles” are groupings of authorizations that control the internal BSM access to functionality within the BSM system 150, and the external BSM access to other systems, such as the SAP Advanced Planner and Optimizer (APO) system. A “profile” is a grouping of authorizations for using certain functions or editing certain objects that are logically connected. For example, the profile “Manage scheduling agreements” may include rights to view, create and change the layout of scheduling agreements. The profile “Enter planning data” may only include rights to enter demand figures in the scheduling agreements. A “role” is a grouping of profiles that a user (being in a specific role when using the system) needs to fulfill the user's tasks. In the example, the role “Purchasing Manager” would have the authorization profiles “Manage scheduling agreements” and “Enter planning data” in addition to several other profiles. The role “Material Planner” would only have the profile “Enter planning data.” In block 806, the system administrator 602 activates the role. The system administrator 602 assigns the three worksets and the Design authorization “profile” to the “role” as attributes. This may be done using the BSM Portal Role Editor (not shown).

Now the BSM system 150 is ready to assign this active “role” to actual users. This includes the approved assignment of the role to a new user, John Smith, who is expected to perform the various BSM solution development activities. In block 808, the system administrator 602 creates a new user ID for John Smith in the BSM Portal Administration (not shown). After creating a user ID for the specific Solution Designer 608 responsible for the Collaborative Requirements Planning solution (FIGS. 7A-7B), the administrator 602 assigns the Solution Designer role to John's user ID object in the BSM Portal Editor.

In block 810, the Solution Designer 608 then requests the administrator 602 to configure the connections between BSM and an APO system. This or any connection configuration can be to non-SAP systems as well as SAP systems.

The system administrator 602 defines and assigns the relevant communication (connectors, adapters, etc.), transformation (such as XSLT), routing, etc., information regarding the desired APO access into the BSM system's Integration Repository and Directory (not shown). This will permit a Solution Designer 608, working within the BSM system 150, to directly communicate master data, configuration data, activity data, etc., to the APO system by performing the desired data transformations and message routings during run-time. The data in the BSM Integration Repository and Directory is available to all BSM functions, such as the Integrated Implementation Management 532.

After the initial set up is completed using the BSM Integration Infrastructure function 506, the system administrator 602 should extend the user-related information to encompass activities of John Smith within any appropriate external systems, such as the external SAP APO system that the solution designer 608 uses. The execution of this synchronization using Integration Infrastructure 506 will enable the Solution Designer 608 to work seamlessly with the external APO systems during the BSM solution development for the Collaborative Requirements Planning project (FIGS. 7A-7B). A general description of BSM's methods for external system authorization is described in the Integrated Implementation Management functional area 532 below.

Solution Development Management

A Solution Development Management functional area 516 is now described. The BSM system 150 may support a natural solution progression. Solution development may be based on a methodology 400 (FIG. 4) that supports designing, engineering, and realizing an optimal solution. In the BSM design, rules and dependencies may be applied to the methodology 400. The result is the knowledge base 306 (FIGS. 3A-3B) that provides a solution determination roadmap for the solution development processes. The BSM system 150 may use this knowledge base roadmap to integrate text-based, interrogative processes with graphical solutions.

Graphical solutions may cover business processes and technology components, which support the business requirements. The graphical solutions for the technology components may span two levels. The first level is used to identify and define generic technology components as active or inactive regarding the business requirements. The second level provides the vendor-specific components, including applications and interface configurations, in an architecture that has been selected to support the business requirements.

The BSM system 150 prepares and then applies these tools in the solution design, engineering, and realization processes. The BSM system 150 identifies and defines a business solution development methodology that the BSM system 150 will use to execute solution determination. The BSM system 150 pre-defines business design objects to be used at various levels. The BSM system 150 pre-defines technology solution objects from their linkage to a generic component to the details of their configuration. The BSM system 150 identifies and defines key rules and dependencies, which are assigned to desired steps of a Solution Determination Structure 308. The BSM system 150 links the solution determination rules and dependencies to the desired business design objects and the related technology solution objects.

The Solution Development Management functional area 516 provides identification, definition, and assignments of the various critical solution development objects to support solution determination, design, engineering, and realization.

The Solution Development Management functional area 516 in FIG. 5B may include a plurality of functions such as Methodology Management 518, Business Process Object Management 522, Technology Object Management 524, Control Object Management 526, Task Object Management 528, Solution Template Object Management 530, and Knowledge Base Management 520.

Methodology Management

The Methodology Management function 518 may include standard BSM solution development methodology, non-standard extensions and enhancements to methodology, and an object-based design, which permits loading or creation of alternative methodologies in the BSM system 150.

FIG. 9 illustrates a high-level object model in the Solution Development Management functional area 516 of FIG. 5B. FIG. 9 also illustrates a relationship between a standard Methodology Management (MM) object 900 and Solution Determination Structures (SDSs) 908, 910A-910N, 914X, 914Y.

The BSM system 150 is designed to support solution development across any business process with any mix of SAP and non-SAP applications and technology components. The BSM system 150 is also designed to support the application of a standard SAP solution development methodology 900, a third party methodology 906X or 906Y, an internal legacy methodology, or combinations of these options.

SAP provides a complete standard solution development methodology 900 that encompasses all of SAP's application and technology offerings, from business requirements down to the configuration of components. This is an object-based design that will permit maximum flexibility in solution development activities. The standard methodology structure 900 is updated (copies 902A, 902B) as new objects are provided by SAP or other partner applications and technology components in new releases.

BSM users may decide to create multiple internal versions 902A, 902B of the standard BSM methodology 900. They may then add their own new step-level parameters, phases, and/or levels within these non-standard methodologies 902A, 902B. When updates to the standard methodology 900 occur, the system 150 will walk the user through the update process regarding these other methodologies.

Users may load one or more additional object-based solution development methodologies 906X, 906Y to the BSM system 150. Or users may create their own methodology using the tools of the BSM system 150. These non-SAP methodologies should follow the basic structure of the SAP methodology object model defined above. The individual solution development parameters of a methodology should fit within a two-tiered methodology structure similar to SAP's Methodology Level and Methodology Phase 400 in FIG. 4. The user is not limited to the number of levels and/or phases included in the BSM methodology 400.

BSM's methodology 400, 900 and all other methodologies to be employed by BSM are maintained in the BSM Methodology Repository 250F in FIGS. 3A-3B. The user may not be able to modify the standard BSM methodology 400, 900. For all other methodologies, the user can use both graphic-based and text-based BSM processes to configure the basic process flow of a methodology by editing the levels, the phases within the levels, and/or the steps within the phases. The user can add and modify each of these object types to enhance and modify the methodology according to the practical experiences of the BSM user.

Knowledge Base Management

The BSM system 150 (FIG. 2) may provide a standard Solution Determination Structure (SDS) 908 that is linked to its corresponding standard BSM solution development methodology 900. The Solution Determination Structure 908 is object-based.

The Knowledge Base Management function 520 may include the standard BSM SDS 908 linked to the standard BSM Methodology 900. The Knowledge Base Management function 520 may provide a definition/assignment of Solution Determination Procedures 909 at the parameter level with connection to other parameters, business objects, technology objects, task objects, and solution templates. The Knowledge Base Management function 520 may provide non-standard extensions and enhancements to create new SDS structures 910A-910N. The Knowledge Base Management function 520 may have an object-based design, which permits loading or creation of alternative structures 910A-910N in the BSM system 150. The Knowledge Base Management function 520 may permits linkage of new structures 910A-910N to new methodologies 902A-902N.

A methodology may not be directly applied in the solution development process. A methodology may be transformed into a Solution Determination Structure 908, which is applied by the BSM system 150 directly to solution development processes. This design assures separation of the maintenance of methodologies from the corresponding definition of structures that may be applied to one or more solution development projects in progress.

The standard BSM SDS structure 908 may be loaded with pre-defined and pre-assigned business process objects, technology objects, control objects, task objects, and solution template objects that represent application and technology offerings from SAP. These objects may be maintained by the Solution Development Management function 516 separately from Knowledge Base Management function 520. The management of these objects is described in greater detail below.

The scope of the Knowledge Base Management function 520 encompasses the assignment linkage of SDS structures 910A-910N to methodologies 902A-902N, and the assignment linkage of individual parameters within a specific SDS structure to a Solution Determination Procedure (SDP) 909. The SDP 909 is a structured object that utilizes the user's parameter selections 904 to define a prescribed progression of control objects 1004 and related solution design, engineering, and configuration routines 1006. These routines 1006 are applied within the user's process parameter-selection to identify:
Subsequent SDS parameter relationships;
Business objects for graphical modeling;
Technology objects for graphical modeling;
Task objects for project management activities; and
Solution templates encompassing business, technology, and task objects.

Users can create their own SDS structures 910A-910N. Linking a methodology 902 with a new SDS structure 910 will create the contents of that SDS structure 910. This results in the population of the selected methodology's parameters from the selected base methodology 900. Additionally, where two SDS structures 910 exist with common parameters, the user may copy the SDPs, control objects, and routine assignments from one SDS 910 to the other. In one configuration, enhancements or modifications may not be made to the standard SDS 908. Non-standard SDS, SDPs, control objects, and routines are object structures that can be enhanced, extended, or modified. Users may choose to completely create their own structures.

Business Process Object Management

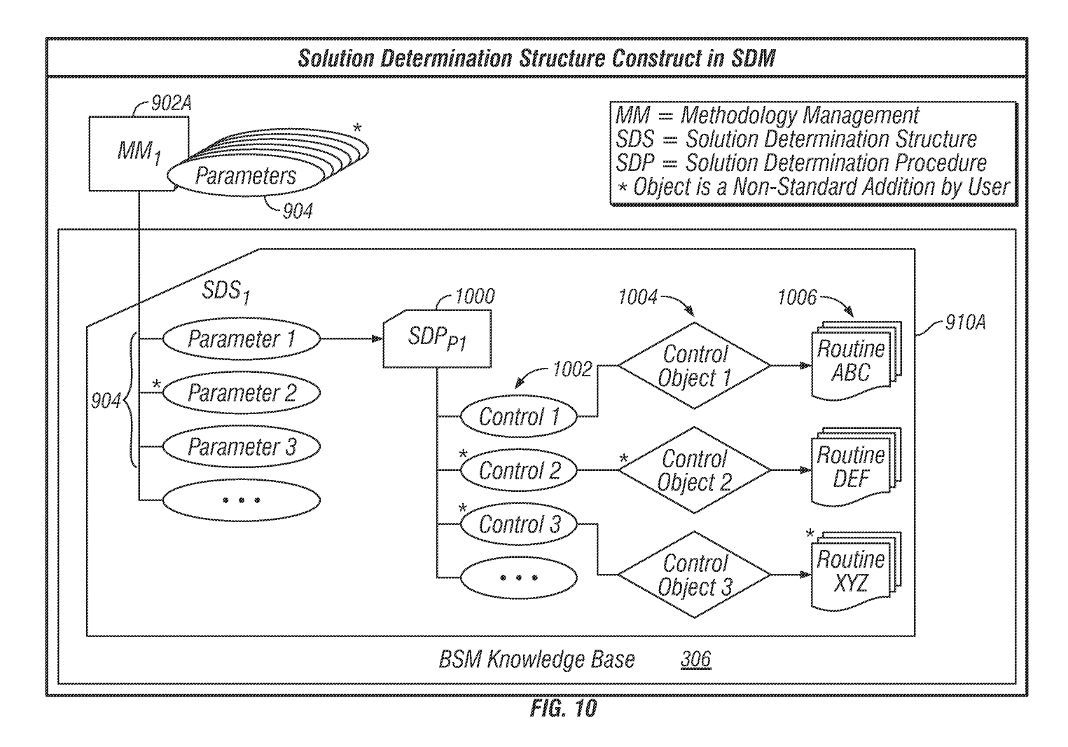

FIG. 10 illustrates a Methodology Management structure 902A and the Solution Determination Structure (SDS) 910A in FIG. 9 of the Solution Development Management (SDM) 516 in FIG. 5B.

FIG. 11 illustrates a process of creating a BSM initiative 1110 in the Solution Design and Engineering functional area 508 of FIG. 5B.

FIG. 12 illustrates a high-level object model in the Solution Design and Engineering functional area 508 of FIG. 5B.

Business Process Object Management 522 (FIG. 5) provides standard BSM “business objects,” which encompass “business areas” 1202, “processes” 1204, “activities” 1206 and “steps” 1208 (FIG. 12). The Business Process Object Management function 522 may allow a user to create new objects and manage objects and instantiations. A “business object” contributes to the object-based business requirements definition of a solution. Within the BSM system 150, there may be several types of “business objects.”

An “initiative object” 1110 (FIG. 11) is created when a BSM user wishes to begin the solution development process. The initiative object 1110 represents the highest level of the object model for a specific business solution development. It provides the business “objectives” and “goals” of the overall solution scope.

A “business area object” 1202 is used when the BSM user identifies a business area targeted in the scope of the initiative 1110. The business area object 1202 provides the business objectives and goals, etc., of the area solution scope.

A “business process object” 1204 is used for each process that the user is designing in the scope of the target business area 1202. The business process object 1204 provides the business objectives and goals of the process scope.

A “business activity object” 1206 is employed for each activity that the user is designing within the scope of the business process 1204. The business activity object 1206 provides the business objectives and goals, etc., of the activity scope.

A “business step object” 1208 is employed for each step that the user is designing within the scope of the business activity. The step 1208 is the lowest level of the business process objects in a solution's modeling.

SAP provides an extensive repository of the business area, process, activity, and step objects to support its application offerings. These objects 1110, 1202, 1204, 1206, 1208 may not be changed, but they can be copied to new object IDs 1114-1120 and then modified. Additionally, users may choose to create their own objects. The user can also create, modify, and delete instances of these objects. Every “object” may contain certain parameters that are assigned to the object's definition and are filled with values when creating an instance.

The Business Process Object Repository (OR) 250E in FIGS. 3A-3B supports all forms of business object management. The Business Process OR 250E has a central directory that is able to store generic object definitions and their instances. The Business Process OR 250E has a user interface that allows modelers of BSM SDS structures to interactively create and edit objects. The Business Process OR 250E also offers APIs for object operations to the other components of the BSM system 150.

Technology Object Management

A Technology Object Management function 524 may include standard pre-defined and pre-configured BSM technology objects 314 (FIGS. 3A-3B), creation of new technology objects, and management of technology objects and instantiations. The Solution Determination Structure 910A includes parameters 904 that will directly define the need for a technology component. There may be various types of technology objects 314.

“Generic component objects” are used to identify general architectural components such as Lightweight Directory Access Protocol (LDAP), Portal Content Management, Demand Planning, etc.

“Generic integration objects” are used to identify generic, standard aspects of integration such as remote function calls (RFCs), APIs, protocols, interfaces, methods, techniques, etc.

“Solution component objects” are used to identify vendor-specific components that will be a part of the actual solution realized.

“Solution configuration objects” are used to identify the active aspects of the configuration of a technology component object.

“Solution integration objects” are used to identify non-standard aspects of the solution's integration.

SAP provides an extensive repository of technology objects applied throughout its offerings. While these technology objects may not be changed, they can be copied to new object IDs and then modified. Additionally, users may choose to create their own technology objects. A user can also create, modify, and delete instances of these technology objects. Every technology object contains certain parameters that are assigned to its definition are filled with values when creating an instance.

A “technology object” exists for each technology component and each configuration structure in the architectural landscape. The attributes for the components/structures are captured within the technology object. Thus, the technology object clearly describes the functionality and its purpose in the architecture, as well as other specific information.

The Technology Object Repository (OR) 250D supports all forms of technology object management. The Technology OR 250D has a central directory that is able to store generic technology object definitions and their instances. The Technology OR 250D has a user interface that allows modelers of BSM SDS structures to interactively create and edit technology objects. The Technology OR 250D also offers APIs for object operations to the other components of the BSM system 150.

Control Object Management

A Control Object Management function 526 may include standard pre-defined and pre-configured BSM “control objects,” creation of new control objects and management of control objects and instantiations.

A “control object” 1004 is identified within the Solution Determination Procedure 1000 that is assigned to each parameter 904 of the SDS 910A in FIG. 10. The “control object” 1004 is used as an automated method for defining and executing the actual solution development roadmap. The BSM system 150 allows its users to design, create, and manage a linked chain of solution development decision-making parameters through the application of these control objects 1004. Control objects 1004 can be either rules-based and/or classification and dependency-based. The control object 1004 is the determinant bridge between an SDS parameter setting 904 by the BSM user, and the resultant connection to another SDS parameter, to a business object, a technology object, or a task object.

“Rules-based” control objects employ a “conditional logic” to determine the next step that is executed by the SDS parameter's assigned Solution Determination Procedure 1000 (FIG. 10). The logic compiles a string of data from the user's solution design efforts. This is compared to the control object strings within the Solution Determination Procedure 1000. Where there is a match, a connection to the identified control routine 1006 is made, and the routine 1006 is then executed. A condition can be a simple IF-ELSE situation that drives the chain or a more complex CASE situation where a combination of parameters determines the result from the condition.

In contrast to the “conditional logic” approach, a “classification and dependency-based” control object is based on a classification and grouping technique. Distinct class, characteristic, and characteristic value objects may be linked to business, technology, task, or template objects (FIG. 11). When this type of control object is employed within the Solution Determination Procedure 1000, the system 150 produces a separate set of classification parameters 904 for the user to choose. The unique combinations of the characteristic value selections utilize the pre-defined dependencies between characteristic values to initiate the call of a specific routine 1006. This routine 1006 then applies the optimal business, technology, task, or template object(s) (FIG. 11), and/or the routine 1006 may be used to literally configure the selected objects.

Task Object Management

Task Object Management 528 may include standard pre-defined and pre-configured BSM project task objects 300 (FIGS. 3A-3B), creation of new task objects 300, and management of task objects 300 and instantiations.

A “task object” is used to define a project task item. The “task object” is used as an automated method for defining and executing the actual solution development tasks. The BSM system 150 provides a complete repository 250A of SAP solution development tasks covering all SAP application and technology offerings. These are pre-assigned to SAP-provided control objects as well. While these standard task objects cannot be changed, they may be copied to new object IDs and then modified. Additionally, users may choose to create their own task objects. A user can also create, modify, and delete instances of task objects. Every task object contains certain parameters, which are assigned to its definition, and which are filled with values when creating an instance.

The Task or Project Object Repository 250A in FIGS. 3A-3B supports all forms of task object management. The Project Object Repository 250A has a central directory that is able to store generic object definitions and their instances. The Project Object Repository 250A has a user interface that allows modelers of BSM SDS structures to interactively create and edit objects. The Project Object Repository 250A also offers APIs for object operations to the other components of the BSM system.

Solution Template Object Management

Solution Template Object Management 530 may include standard BSM Solution Determination Procedures 1000 with Control Objects 1004, standard BSM Business Object Template objects 1116 (FIG. 11) that are pre-defined and pre-configured with business objects 316 (FIGS. 3A-3B), standard BSM Technology Object Template objects 1118 that are pre-defined and pre-configured with technology objects 314, and standard BSM Project Template objects 1120 that are pre-defined and pre-configured with task objects 300.

The Solution Template Object Management 530 may handle creation of new Solution Determination Procedures 1000, new Business Object Templates, Technology Object Templates and Project Templates. The Solution Template Object Management 530 may handle nesting of business and technology object Templates 1116, 1118 and Project Templates 1120.

The objects and structures that have been defined and managed above may be configured into groups of object structures. For control objects 1004, the configured grouping is a Solution Determination Procedure 1000. Task objects 300 are configured into Project Templates 1120. Business objects 316 and technology objects 314 are respectively configured into Business Object Templates 1116 and Technology Object Templates 1118. Each of these configured groupings can be nested within other like groupings, creating a hierarchy of structures or templates within their respective areas of control, project, business, and technology.

Finally, a Solution Template 1114 is a configured grouping of templates 1116-11120 that represents the complete linkage and integration of business object templates 1116, technology object templates 1118, and project templates 1120 into one. Solution templates 1114 can also be nested. An installed, productive “solution base” is made up of these solution templates 1114. Whenever an initiative 1110 is created, the BSM system 150 creates a work-in-progress (WIP) Solution Template structure 1114 that consists of WIP Templates structures for the business, technology, and project areas.

The BSM system 150 provides a comprehensive repository 250C of SAP templates covering all SAP application and technology offerings. This includes industry-specific and best practices object templates. These are pre-configured and pre-integrated. While these template and structure objects may not be changed, they can be copied to new object IDs and then modified. Additionally, users may choose to create their own objects and create their own configurations of groups. A user can also create, modify, and delete instances of these objects. The user may use tools of the Solution Engine 510 for defining tree object structures. They can also use the Business Solution Engineer 216 as well as the Technology Solution Engineer 218 for their respective graphical structures.

The BSM system 150 will rationalize the configurations and identify structural conflicts for the users to the extent possible based on the defined object structures and their attributes. The configured groupings shall inherit the attributes of their collective individual objects.

The Solution Repository 250C supports all forms of solution object management. The Solution Repository 250C has a central directory that is able to store generic object definitions and their instances. The Solution Repository 250C also offers APIs for object operations to the other components of the BSM system.

Application of Solution Development Management to Example Scenario

A user completes the Infrastructure Management setup 501 (FIG. 5B) for the configuration of the BSM system 150 to support development of the Collaborative Requirements Planning solution (FIGS. 7A-7B). The user is now ready to begin functional configuration of the BSM system 150.

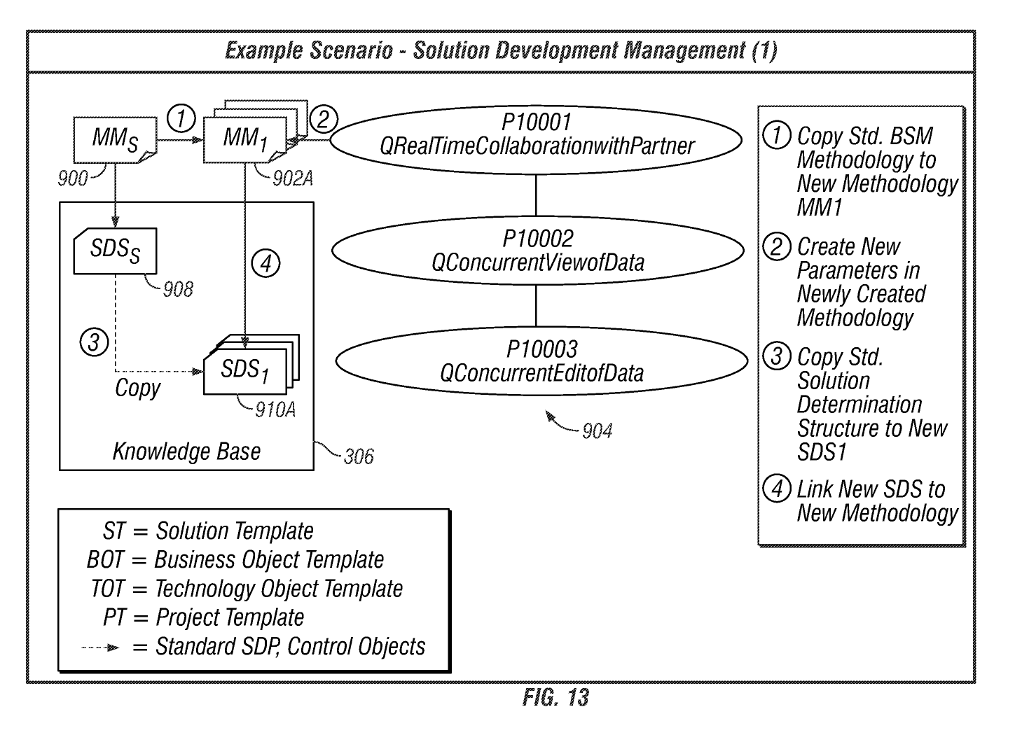

FIG. 13 illustrates an example scenario of Solution Development Management 516 of FIG. 5. The first step is Methodology Management 900. The user copies the standard BSM solution development methodology 900 to a new Methodology, MM1 902A. The user then places additional parameters 904 as new objects into the MM1 methodology 902A as desired. The user creates the solution determination parameters 904 within the Methodology MM1 902A that will allow the BSM system 150 to provide real-time collaboration solutions when that is what the customer needs.

P10001 Create parameter “QRealTimeCollaborationWithPartner”: Do you wish real-time collaboration on your forecast?

P10002 Create parameter “QConcurrentViewOfData”: Are both participants able to view the forecast concurrently?

P10003 Create parameter “QConcurrentEditOfData”: Are both participants able to enter the forecast data concurrently?

The user then copies the standard BSM Solution Determination Structure 908 into a new SDS, called SDS1 910A. The user maintains the SDS1 structure 910A within the Knowledge Base Management function 520 to link it to the methodology MM1 902A.

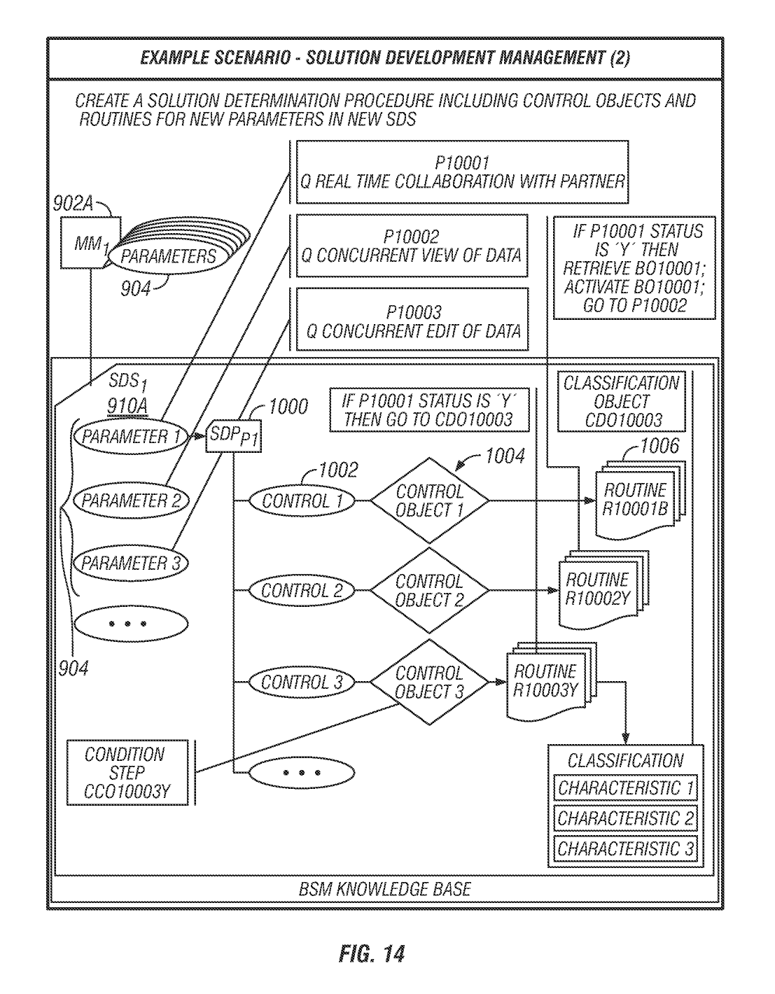

The BSM system 150 identifies to the user that there are three recently added parameters 904 in MM1 902A that will need proper configuration. The user searches the system 150 for processes and activities within the Demand Planning business area that deal with collaborative requirements planning The user identifies that there are two activities in SDS1 910A that should be modified to deal with real-time collaborative requirements planning The user then creates new determination routines 1006 and control objects 1004 for these new SDS1 parameters 904, as shown in FIGS. 10 and 14.

FIG. 14 illustrates creation of control objects 1004 with the Methodology Management structure 902A and the Solution Determination Structure (SDS) 910A in FIG. 10 of the Solution Development Management (SDM) in FIG. 5B. These routines 1006 and control objects 1004 are placed in Solution Determination Procedures 1000 that correspond to the parameters 904. The user creates the routines 1006, the control objects 1004, and the corresponding business objects using the Business Process Object Management function 522 and the technology objects using the Technology Object Management function 524.

In the description below, P=Parameter, R=Routine, BO=Business Object, TKO=Technology Object, PTO=Project Task Object, CCO=Conditional Control Object, CDO=Classification/Dependency Control Object, and CDC=Classification/Dependency Characteristic Object.

If the Control Objects 1004 are “rules-based,” i.e., objects that employ a conditional logic (if/elseif/else) or (case 1/case2/ . . . /case n)):

CCO10001B is a condition step. FIG. 11, label 1004 illustrates a condition step, which is also known as Control Object 1. Each control can be linked to one of three possible conditional control objects, depending upon the status of the parameter. The parameter may have status Yes (Y), No (N), or Blank (B). Each conditional control object executes a particular routine. In this case, the conditional control object CCO10001B executes the routine R10001B; the conditional control object CCO10001Y executes the routine R10001Y; and the conditional control object CCO10001N executes the routine R10001N.

The assigned routine is: R10001B (FIG. 11, label 1006; linked to CCO10001B)

If P10001 status is ‘ ’, then do nothing (Definition of R10001B).

CCO10001Y is a condition step.

The assigned routine is: R10001Y.

If P10001 status is ‘Y’, then access BO repository; retrieve BO10001; activate

BO10001 in the business object template of the solution; go to P10002.

CCO10001N is a condition step.

The assigned routine is: R10001N

If P10001 status is ‘N’, then go to P2115.

CCO10002B is a condition step.

The assigned routine is: R10002B

If P10002 status is ‘ ’, then end.

CCO10002Y is a condition step.

The assigned routine is: R10002Y

If P10002 status is ‘Y’, then access BO repository; retrieve BO10002; activate

BO10002 in the business object template of the solution; go to P10003.

CCO10002N is a condition step.

The assigned routine is: R10002N

If P10002 status is ‘N’, then go to P9951.

CCO10003B is a condition step.

The assigned routine is: R10003B

If P10003 status is ‘ ’, then end.

CCO10003Y is a condition step.

The assigned routine is: R10003Y

If P10003 status is ‘Y’, then go to CDO10003.

CCO10003N is a condition step.

The assigned routine is: R10003N

If P10003 status is ‘N’, then go to P9952.

BO10001 RealTimeCollaborationWithPartner. Real-time collaboration may not be a standard process. Thus, the user copies the object CollaborationWithPartner and renames the copy RealTimeCollaborationWithPartner as a new process.

BO10002 ConcurrentViewOfData. The user creates the activity by renaming a copy of the standard business object.

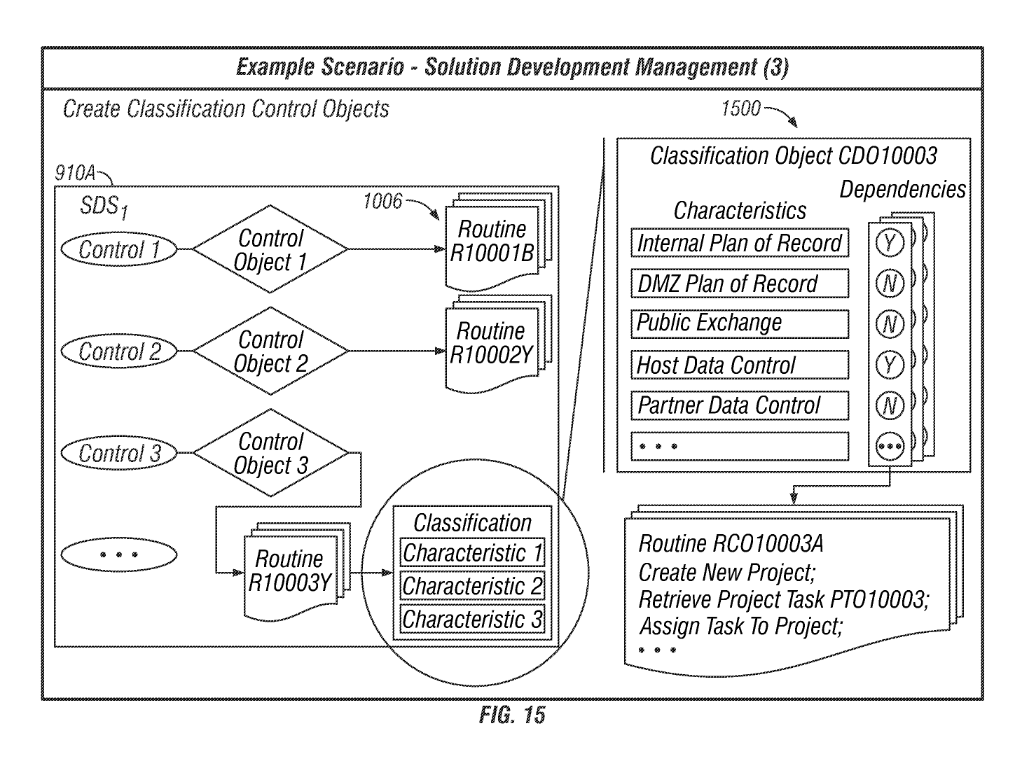

If the Control Objects 1004 are “classification/dependency-based” (most of these objects are listed between FIGS. 13 and 14 and are referenced in FIG. 15; the classification/dependency-based control objects may require multiple parameters to specify a particular routine to execute:

BO10003 ConcurrentEditOfData. The user creates the activity by renaming a copy of the standard business object.

TKO10003 ConcurrentEditView. The user creates the technology object by renaming a copy of the standard technology object.

TKO9999999 Create new application (between FIGS. 13 and 14)

TKO9999999LJ Identify application language as Java (between FIGS. 13 and 14)

CDO as a class consists of the following characteristics:

CDC100031POR InternalPlanOfRecord: Is the plan of record in the internal ERP?

CDC10003DPOR DMZPlanOfRecord: Is the plan of record in the DMZ DB?

CDC10003PXG PublicExchange: Do you wish to collaborate on a public exchange?

CDC10003HDC HostDataControl: Will you control the data being collaborated upon?

CDC10003PCT PartnerControl: Will your partner control the data being collaborated upon?

CDC10003CPR CollaboratelnPlanOfRecord: Will you collaborate with your partner directly on the plan of record of the data controller?

CDC10003HIN HostInitiation: Will you be able to initiate the collaboration?

CDC10003PIN PartnerInitiation: Will your partner be able to initiate the collaboration?

CDC10003DMS DataMaster: Can data which is stored in your plan of record be overridden by the collaboratively-sourced data?

The dependencies set at the class level are if the following is the outcome, it calls routine RCO10003A.

When: CDC100031POR value is ‘Y’, and
CDC10003DPOR value is ‘N’, and
CDC10003PXG value is ‘N’, and
CDC10003HDC value is ‘Y’, and
CDC10003PCT value is ‘N’, and
CDC10003CPR value is ‘N’, and
CDC10003HIN value is ‘Y’, and
CDC10003PIN value is ‘Y’, and
CDC10003DMS value is ‘N’, then

Go to routine RCO10003A

RCO10003A is a routine: Create new project under existing project.

Access task object repository 250A;

retrieve project task object PT010003;

assign this task under new project;

alert project manager of new item by email;

access BO repository 250E;

retrieve BO10003;

activate BO10003 in the BOTemplate of the solution: access TO repository 250D;

retrieve TKO10003;

retrieve TKO9999999;

retrieve TKO9999999LJ;

activate TKO10003 in the TOTemplate 1118 (FIG. 11) of the solution;

activate TKO9999999 in the TOTemplate 1118 of the solution;

activate TKO9999999LJ in the TOTemplate 1118 of the solution;

go to P10019.

Then the user creates the Solution Determination Procedures SDP10001 through SDP100003. The user assigns the R10001 condition steps to the SDP 10001; the R10002 condition steps to the SDP 10002; and the R10003 condition steps to the SDP 10003. The user then activates the SDS1 structure 910A (FIG. 14) as ready for use.

Note that the user configures CD010003 to instantiate several objects. One is the technology object TKO9999999, since the desired ConcurrentEditor application does not yet exist. Another is the task object PT010003 for NewDevelopmentConcurrentEditor, since a new application is to be developed, and development takes resources and time that should be managed in the project context. Note also that the user has established the result TKO9999999LJ so that the new application will be developed in Java.

FIG. 15 illustrates creation of classification control objects 1500 from the routines 1006 of FIG. 14.

With the exception of a “step” in FIG. 12, every business object consists of other sub-objects. As stated above and shown in FIG. 12, a “process” includes “activities,” which include “steps.” Where sub-objects are expected, the BSM system 150 creates a corresponding business template 1116 to specify what makes up the business object. For the business object B010001—RealTimeCollaborationWithPartner, the user creates the business template BT10001—BTRealTimeCollaborationWithPartner by copying the standard business template. The user then uses the BSM system 150 to modify the copy by adding BO10001—RealTimeCollaborationWithPartner to the new BO template using the Business Object Management function 522.

Most technology objects 314 also consist of other sub-objects. For example, ConcurrentEditView may include two tables: the host's data table and the partner's data table. Therefore, for the view TKO10003-ConcurrentEditView, the user creates the technology template TT10003—TTConcurrentEditView by copying the standard technology template. The user then modifies the copy by adding TKO10003—ConcurrentEditView to the template using the function Technology Object Management.

Project templates 1120 (FIG. 11) contain all task objects that are related to the business or technology objects within the business or technology object templates 1116, 1118. Accordingly, the user creates a new project template PT10003 by copying the standard project template. The user then inserts the task object PT010003 into the newly created project template using the Task Object Management function 528.

A solution template 1114 (FIG. 11) includes the combination of a business template 1116, a technology template 1118, and a project template 1120. A completely configured solution template 1114 may require that the technology templates 1118 contain all of the technology objects desired to realize the business process model in the business template 1116, with the Project Template 1120 containing all of the task objects desired to realize the solution. The user copies the standard solution template 1114 and modifies the copy by adding the templates BTRealTimeCollaborationWithPartner and TTConcurrentEditView. The new solution template may not be completely configured. The user creates and modifies the solution template using the Solution Template Management function 530. The objects described above are used in the following Solution Design and Engineering's example scenario.

Solution Design and Engineering

FIGS. 11-12 are described further. After completing Solution Design and Engineering 508, the user has identified, defined, created, and/or realized the following:

new business processes 1204 (FIG. 12) used to meet the user's business goals;

system requirements resulting from the new business processes 1204;

candidate technologies that may meet the system requirements;

variant IT landscapes that may meet business requirements;

critical development of any software desired to fill functionality gaps; and

validation of solution variant proposals through analyses and/or prototypes.

The BSM system 150 has a suite of applications 100 that enables a user to manage an entire business solution lifecycle. The BSM system 150 may encompass every business process 1204, activity 1206, and step 1208 of the enterprise business models, as well as the entire architectural landscape of the technology components supporting these business models.

The BSM Solution Design and Engineering functional area 508 utilizes the objects defined and configured in Solution Development Management 516 to identify, design, create, and realize the business solutions used by the enterprise. Solution Design and Engineering 508 is fundamentally based on the complete application of a Solution Determination Structure 1108 (FIG. 11) to produce the desired business solution across four BSM application areas.

A complete Solution Determination Structure 1108 contains the solution design, engineering, and realization parameters 904. The Solution Determination Structure 1108 may be is interactively represented in a Q & A interrogative context. The entire solution process may be based on the knowledge, rules, and dependencies contained in this structure 1108.

A complete graphical modeling toolset and representation of the business requirements definition from an initiative's goals and objectives down to the individual steps 1208 (FIG. 12) within a business solution's activities.

A complete graphical modeling toolset and representation of the generic technology landscape that will accommodate the entire range of small to the very largest enterprises. This generic landscape is the bridge from the solution's business requirements to the vendor- and configuration-specific technology requirements.

A complete graphical modeling toolset and representation of the vendor- and configuration-specific technology requirements to support the desired business requirements.

These four areas may be completely linked and integrated, where the Solution Determination Structure 1108 provides one consistent roadmap across all four areas. The user may start the solution development process within any of these four areas. While working in progress on the same solution template structure 1114, the user may migrate seamlessly from solution development in one area to performing solution development within another area. The user may be able to dynamically see the effects of work done in one area from the other areas because the Solution Determination Structure 1108 provides integration and consistency across all areas.

There may be several alternative methods for solution development provided by the BSM system 150. Each method is focused on a specific user pool. For example, any user might utilize the parameter-based ‘Q & A’ process to produce a collection of answers (parameter selections) that establishes business and system requirements, which gradually defines the business requirements and candidate technologies. Alternatively, as a graphical modeler of the business requirements paints the picture of the desired business processes 1202, activities 1206, and steps 1208, the BSM system 150 is gradually defining the business requirements and candidate technologies. A third method would support a graphical modeler of the generic technology architecture painting the picture of the desired generic technology components, whereby the BSM system 150 is gradually defining the business requirements and candidate technologies. In a fourth method, a graphical modeler of the vendor- and configuration-specific technology components paints the picture of the desired technology components, permitting the BSM system 150 to gradually define the business requirements and candidate technologies. The Q & A and the 3 sets of graphical applications complement one another, in that some requirements and/or technologies may be easier to determine via a question and answer process, while others may be easier to determine via a graphical process. Since the applications may be tightly integrated, with changes in one application being immediately reflected in the other, the user may freely choose any of these methods' application, secure in the knowledge that the user may switch to the other applications at any time within the business solution development effort.

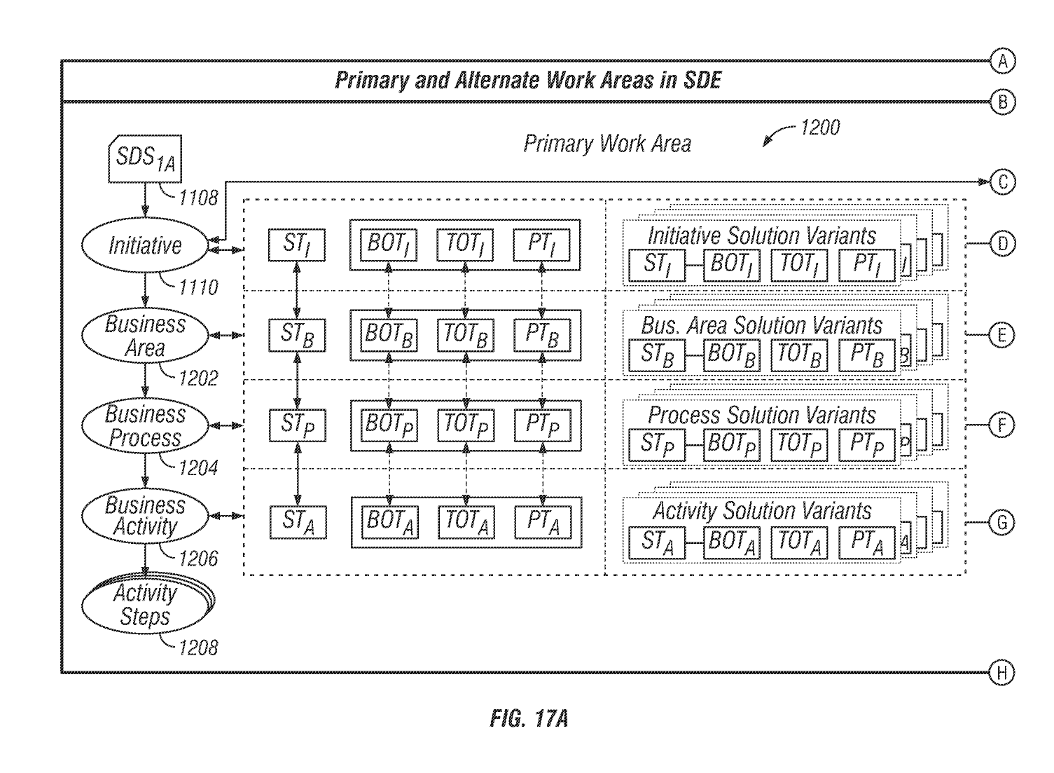

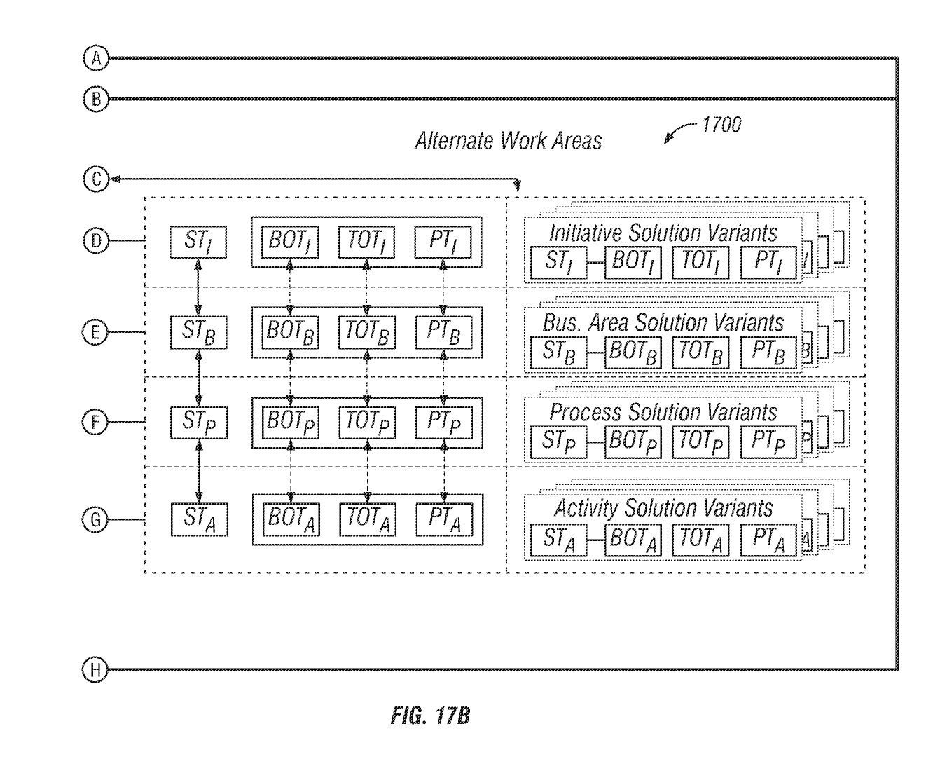

The BSM system 150 may also allow the user to add or subtract components in the IT landscape and step through stored business processes (e.g., best practice business processes) to evaluate how well the landscape satisfies the requirements of the given business process. The user can have several parallel variant work areas 1700 (FIGS. 17A-17B) nested within the overall solution work area. This supports the evaluation and comparison of alternative solutions. The BSM system 150 may allow the user to see which processes use given technologies. The user can then weigh the criticality of the processes against the cost of implementing the specified technologies. The user can also weigh the cost of implementing the specified technologies against the cost of building the needed functionality from scratch.

Once the evaluation is complete, the user validates the landscape solution by building a prototype of that solution.

Solution Design

Solution Design 510 (FIG. 5) may include creation of a solution development Initiative object 1110 (FIG. 11), linkage to a selected Solution Determination Structure 1108, creation of Work Area 1112 and Templates 1114-1120, WIP Work Areas, creation of a Business Area object 1202 (FIG. 12), creation of a Process object 1204, creation of an Activity object 1206, creation of a Step object 1208, determination of generic technology systems requirements, and determination of specific technology components and configurations.

The primary method of BSM solution development assumes that the user first creates business requirements. The Solution Design function 510 begins with the creation of a Solution Development Initiative 1110 (FIG. 11). The initiative 1110 is expected to be in most cases created first whenever the user wishes to begin a specific business solution development effort. The initiative 1110 will be assigned an ID, a title and a description. The primary business objectives of the initiative 1110 are defined, as are the performance goals, performance measurement indicators, ROI, ROAE, etc., parameters. An initiative executive champion, primary stakeholders, and an overall initiative manager may be identified. Its creation may require the identification and linkage of a Solution Determination Structure (SDS) 1108 that is to be applied throughout the life of the initiative 1110. A complete Solution Determination Structure 1108 that contains the solution design, engineering, and realization parameters that are to be employed in the initiative 1110 is identified and assigned to the initiative 1110. Within the solution design function 510, this structure 1108 is interactively represented in a Q & A interrogative context. The entire solution development process is based on the knowledge, rules, and dependencies contained in this structure 1108.

The creation of the SDS 1108 (FIG. 11) may also initiate the creation and linkage of several other objects. The BSM system 150 creates a new business object template 1116, a new technology object template 1118, and a project template 1120. The BSM system 150 then creates a new solution template 1114, and assigns the other templates to this solution template 1114. The BSM system 150 then creates a primary work area 1112, and assigns the solution template 1114 to the primary work area 1112. Finally, the primary work area 1112 is assigned to the initiative 1110. This design assures the proper integration and control of the solution development efforts.

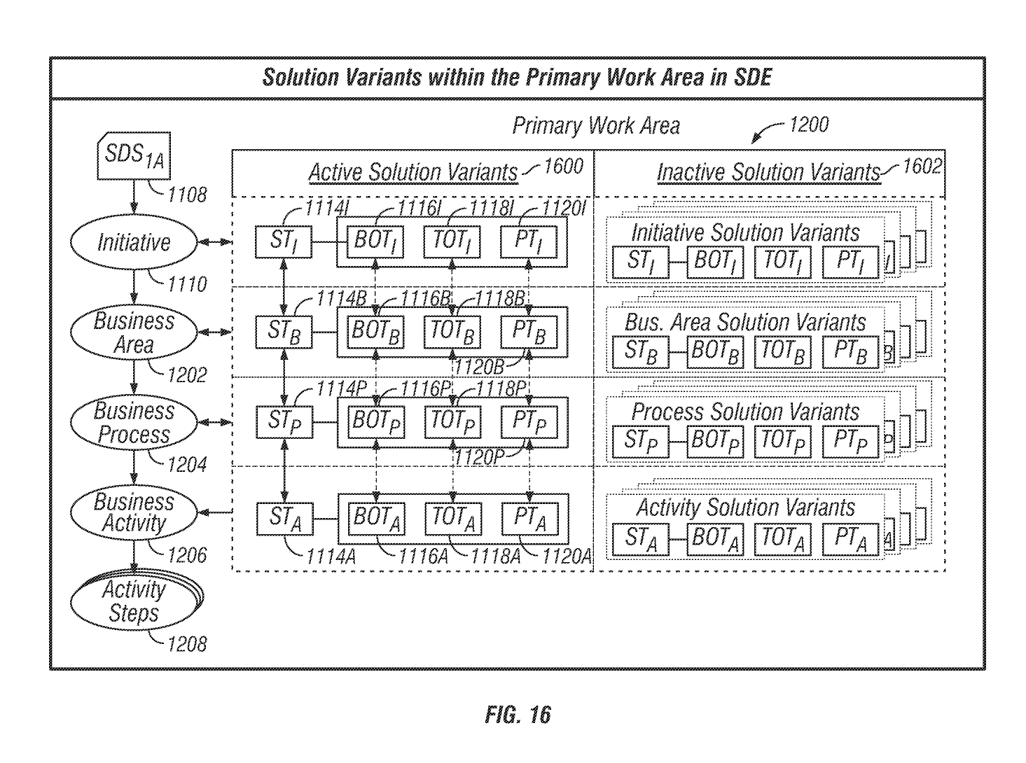

The BSM system 150 may permit the creation of an unassigned WIP work area (not shown) where there is no linkage to an initiative object 1110 made by the user. This permits the user to assign any template into the work area and then work within that template, etc. Since there is no initiative object linkage, there is no Solution Determination Structure linkage, and this means that there can be no complete, automated linkage between any templates within these WIP work areas. When the user is ready, they can assign their WIP work area to an initiative object 1110. Just as templates can be nested, work areas may be nested within one another hierarchically, as shown in FIGS. 16-18.

FIG. 16 illustrates solution variants 1600 within a primary work area 1200 in Solution Design and Engineering 508.

FIGS. 17A-17B illustrates primary and alternate work areas 1200, 1700 in Solution Design and Engineering 508.

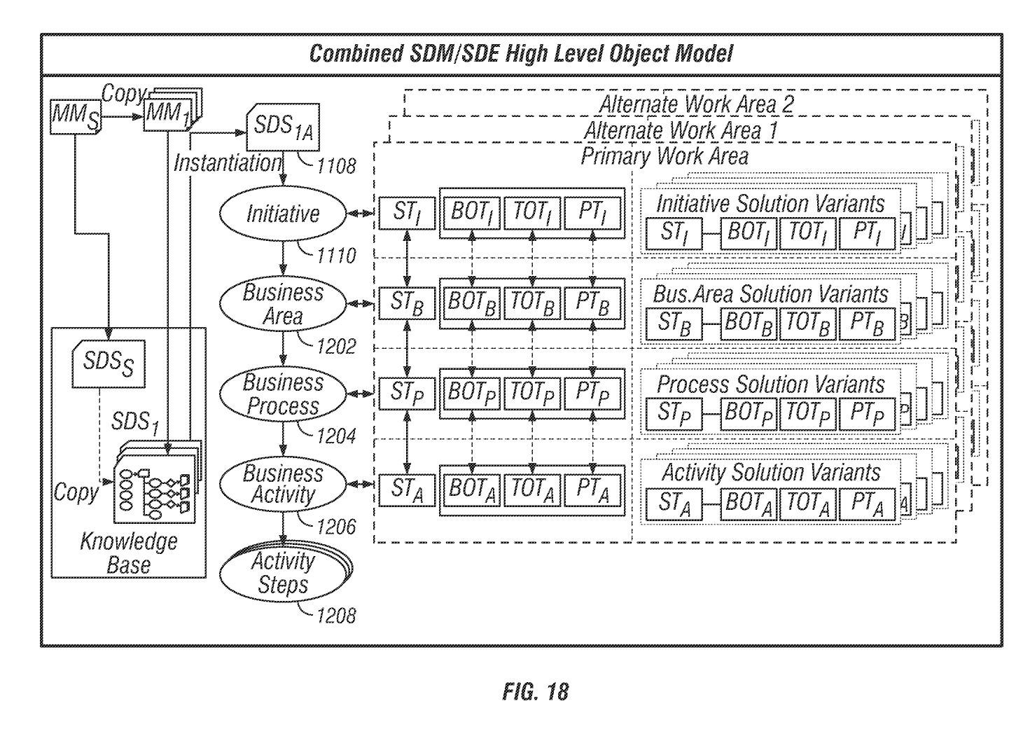

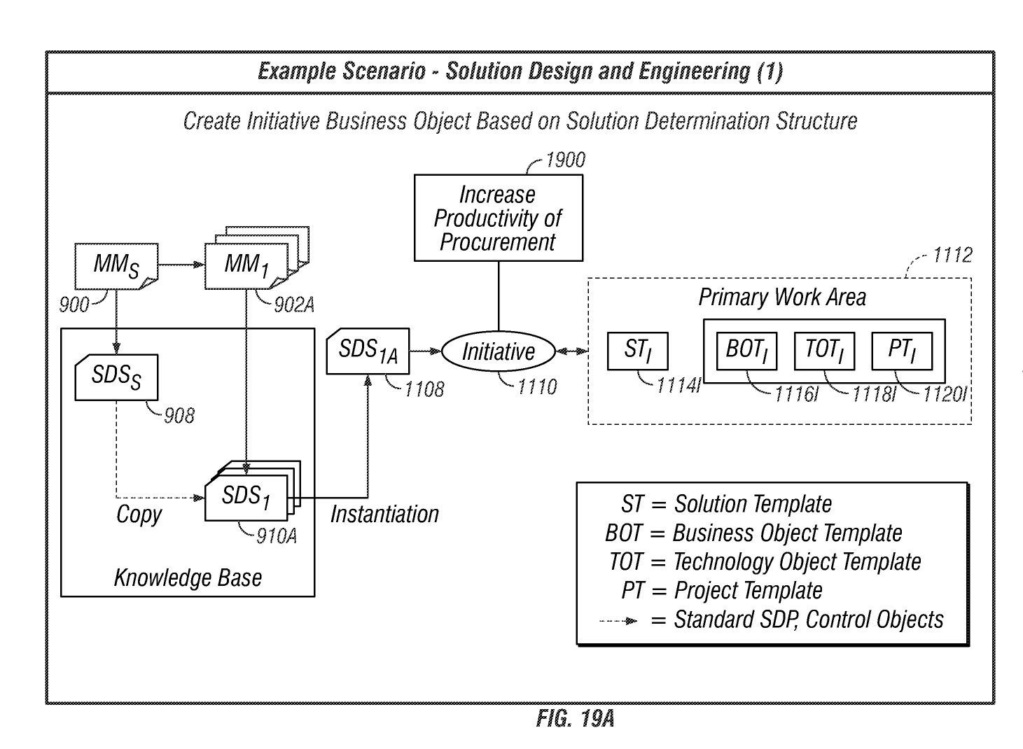

FIG. 18 illustrates a combined Solution Development Management and Solution Design and Engineering high level object model.

The BSM Interview Module component 214 in the BSM system 150 supports the Q&A process based on the parameters of the assigned SDS 1108. The module 214 poses questions to a customer to elicit business needs and technical constraints. The module 214 uses the answers in one of two ways. Initially, the module 214 uses an answer to point to new questions in the process of identifying business goals, business processes 1204, and business activities 1206. Eventually, the module 214 uses the accumulated answers to point to system requirements. These system requirements point in turn to technology object(s) that will satisfy the business needs. The results are subsequently stored in the active Solution Determination Structure 1108 assigned to the initiative 1110.

The user may follow the roadmap provided by the SDS 1108 assigned to the initiative 1110 to create the following structures and relationships within the initiative 1110. Alternatively, the user may choose to create these structures and relationships directly. In either case, the progression may be the same.

Following the creation of the initiative 1110 and all of its attendant structures, the user creates one or more Business Area Objects 1202 within the initiative 1110. A “business area” 1202 represents a targeted area of business operations, for example Sourcing and Purchasing, which is to be included within the overall initiative 1110. Similar to the initiative 1110 above, the business area 1202 will be assigned an ID, a title and a description. The primary business objectives of the solution development in this targeted business area 1202 are defined, as are the performance goals, performance measurement indicators, ROI, ROAE, etc., parameters. A business area management champion, primary stakeholders, and an overall solution development business area manager are identified.

This business area object 1202 is assigned to the initiative 1110. Its creation also initiates the creation and linkage of several other objects. The BSM system 150 creates a new business object template 1116B, a new technology object template 1118B, and a project template 1120B. The system 150 then creates a new solution template 1114B, and assigns the other templates to this solution template 1114B. The system 150 then assigns the solution template 1114B to the initiative's primary work area 1200. All of the templates are assigned hierarchically to the work area 1200, but may be nested within their individual area. For example, the business object template 1116B at the business area level 1202 is also hierarchically linked to the business object template 11161 at the initiative level above.

Now, the user creates one or more Business Process Objects 1204 within each Business Area 1202. A “business process” 1204 represents a defined structure of business processes that have a focused result. For example, Collaborative Requirements Planning (FIGS. 7A-7B) may be a “business process” within the “business area” of Sourcing and Purchasing. Similar to the initiative 1110 and business area 1202 above, the business process 1204 will be assigned an ID, a title and a description. The primary business objectives of the solution development in this business process 1204 are defined, as are the performance goals, performance measurement indicators, ROI, ROAE, etc., parameters. A process management champion, primary stakeholders, and an overall solution development business process manager are identified.

This business process object 1204 is assigned to the business area 1202. The BSM system 150 creates a new business object template 1116P, a new technology object template 1118P, and a project template 1120P. The system 150 then creates a new solution template 1114P, and assigns the other templates to this solution template 1114P. The system 150 then assigns the solution template 1114P to the initiative's primary work area 1200. All of the templates are assigned hierarchically to the work area 1200, but may be nested within their individual area. Therefore, the business object template 1116P at the business process level is also hierarchically linked to the business object template 1116B at the business area level above.

The user then might choose to create one or more Business Activity Objects 1206 within each Business Process 1204. A “business activity” 1206 represents a defined structure of business operations that have a focused result. For example, Enter/Edit Requirements Data may be a “business activity” within the “business process” of Collaborative Requirements Planning Similar to the initiative 1110, business area 1202, and business process 1204 above, the business activity 1206 will be assigned an ID, a title and a description. The primary business objectives of the solution development in this business activity 1206 are defined, as are the performance goals, performance measurement indicators, ROI, ROAE, etc., parameters. An activity manager is identified.

This business activity object 1206 is assigned to the business process 1204. The BSM system 150 creates a new business object template 1116A, a new technology object template 1118A, and a project template 1120A. The system 150 then creates a new solution template 1114A, and assigns the other templates to this solution template 1114A. The system 150 then assigns the solution template 1114A to the initiative's work area 1200. All of the templates are assigned hierarchically to the work area 1200, but may be nested within their individual area. The business object template 1116A at the business activity level may be hierarchically linked to the business object template 1116P at the business process level above.

The user then creates one or more Business Step Objects 1208 within each Business Activity 1206. A “business step” 1208 represents the lowest level of a business activity 1206. For example, “Supplier enters availability data through its browser” may be a “step” within the “business activity” of Enter/Edit Requirements Data. Similar to the initiative 1110, business area 1202, and business activity 1206 above, the business step 1208 will be assigned an ID, a title and a description. The primary business purpose of the step 1208 is defined as well. The activity manager is responsible for defining steps 1208.

This business step object 1208 is assigned to the business activity 1206, and is reflected within the templates of the activity 1206.

The outcome of the Q & A applications of the assigned SDS 1108 results in a mapping of the business objects (the business goals, processes 1204, activities 1206, and steps 1208) to the system requirements, and a mapping of the system requirements to the technology objects that are maintained in the SDS 1108.

The user may need to pursue several alternative design and engineering solution opportunities at any or all levels of the solution development initiative 1110, as shown in FIGS. 16-18. For example, a current solution and proposed alternative solutions might be required. Further, the user may wish to compare the alternatives. The BSM system 150 provides additional functionality to support these comparisons.

First, the BSM system 150 may allow a user to create two or more solution variants 1600, 1602 (FIG. 16) at each level of the primary work area 1200 of an initiative 1110. The solution variants include two or more initiative solution variants, two or more business area solution variants, two or more business process solution variants, and two or more business activity solution variants within the original primary work area 1200 of the initiative. Each solution variant 1600, 1602 includes a solution template 1114 and linked business object template 1116, technology object template 1118, and project template 1120. When a user chooses to create two or more solution variants for any solution development level, the user should identify the active solution variant 1600. All others 1602 will be considered inactive.

Further, the BSM system 150 recognizes that one corporate initiative may require multiple possible work areas 1200, 1700, as shown in FIGS. 17A-17B. This occurs when a single strategic initiative 1110 has two or more completely distinct solution development efforts that should be defined, designed, created, and engineered (perhaps down through a through a prototype stage) from top to bottom. The BSM system 150 allows the user to create two or more works areas 1200, 1700 assigned to a single initiative 1110. When a user chooses to create two or more work areas 1200, 1700, the user should identify the primary work area 1200. All others 1700 will be considered alternatives.

Business Process Engineering

Business Process Engineering 512 may include:
Graphical tools for direct modeling of business requirements at all levels;
Complete diagrammatical representation of the entire business design landscape;
Creation of a solution development Initiative object 1110;
Linkage to a selected Solution Determination Structure 1108;
Creation of a Work Area 1200 and Templates 1114-1120
WIP Work Areas;
Creation of a Business Area object 1202;
Creation of an Activity object 1206;
Creation of a Step object 1208;

Business process engineering 512 is very tightly integrated with the functions within both Solution Design 510 (discussed above) and Solution Technology Engineering 514 (discussed in the following section). This integration is based on the application of a Solution Determination Procedure 1000 at the Initiative level 1110.

Everything that was described above in the context of the Q & A application of the assigned SDS 1108 can be done here within the Business Process Engineering (BPE) function 512. The difference is that BPE 512 uses a graphical modeling set of tools to dynamically produce a layered set of solution diagrams, while the Solution Design Q & A used an interrogative approach to produce its results. However, the attributes and features of the two applications 510, 512 may produce the same results. The description below focuses on key differences from the Solution Design 510 described above.

The primary difference is that BPE 512 presents the business object templates 1116 identified during the solution development process in a graphical model. The user applies the BPE 512 to describe the business requirements by dragging and dropping business objects or templates. This may begin with a clear page with nothing at the start of modeling.

When there is an initiative 1110 with an assigned SDS 1108, the system 150 can assure complete integration. As a business object is graphically dropped to the business object template 1116 with BPE 512, the system 150 determines what unresolved parameters exist from the SDS 1108 and then presents these to the user for their resolution in the Q & A format. This feature can be configured to be triggered according to the combination of the user and the application at each occurrence, or only on request or save. If the SDS 1108 has not been assigned or there is no initiative, then the WIP Business Object Template 1116 may not permit the identification of unresolved parameters.

Therefore, the user can choose to design business processes 1204 and activities 1206 by using a Solution Design tree structure in the Interview Module 214 (FIG. 2). The Business Process Engineering (BPE) function 512 allows the different user roles of the BSM system 150 to graphically view and edit these objects. Alternatively, the user may decide to build business processes from scratch in the BPE function 512.

BPE 512 may utilize a layered graphical approach. The core model may address every aspect of the engineering process. The core model may span the generic use case, sequence diagram, activity diagram, and class diagram, etc., to encompass classes, actors, activities, steps, data models, interfaces, timing, frequency, etc. The diagrams are cross-linked to the parameters in the SDS 1108, the Business Object Templates 1116, and the Technology Object Templates 1118. The “use cases,” for example, can be used to provide a “bridge” between process-driven business requirements and possible technology solution candidates.

The steps within one activity's use case become interactions of technology objects. The user can add, delete or change use cases and actors using the graphical editor. Also, the user can create relationships between use cases, such as generalization, “extends,” and “includes” relationships. The modifications and additions made to the use case diagram are directly reflected in the corresponding “Use Case” objects (not shown). “Use Case” objects are related to one or more Activity objects 1206, and consist of steps 1208. The steps 1208 describe the flow of events within a use case.

A “step” may be defined as the change of the state of a technology object. When specifying a “step,” the user therefore needs to identify one or more technology objects to the step.

Solution Technology Engineering

Solution Technology Engineering 514 may include:
Graphical tools for direct modeling of technology solutions at all levels;
Complete diagrammatical representation of the entire technology design landscape;
Determination of generic technology systems requirements; and
Determination of specific technology components and configurations.

Solution Technology Engineering (STE) 514 may be very tightly integrated with the functions within both Solution Design 510 and Business Process Engineering 514. This integration is based on the application of a Solution Determination Procedure 1000 at the Initiative level 1110.

Everything described above in the context of the Q & A application as it pertains to the determination of generic and specific technology solutions can be done here within the STE function 514. The difference is that STE 514 uses a graphical modeling set of tools to dynamically produce a pre-defined landscape of generic and specific technology architectures that transcend all levels down to the configuration. The Solution Design Q & A used an interrogative approach to produce its results, while STE 514 uses graphical modeling tools.

However, the attributes and features of the two applications 510, 514 may produce the same results. Key differences are described. The primary difference is that STE 514 presents the technology object templates 1118 identified during the solution development process in a graphical model. The user applies the STE 514 to describe the technology requirements by dragging and dropping technology objects or templates. In contrast to the BPE modeling, this may very well begin with a comprehensive technology architecture page with all components inactive or grayed out at the start of modeling.

When there is an initiative 1110 with an assigned SDS 1108, the system 150 can assure complete integration. As a technology object is graphically dropped to the technology object template 1118 with STE 514, the system 150 determines what unresolved parameters exist from the SDS 1108 and then presents these to the user for their resolution in the Q & A format. This feature can be configured to be triggered according to the combination of the user and the application at each occurrence, or only on request or save. If the SDS 1108 has not been assigned or there is no initiative 1110 then the WIP Technology Object Template does not permit the identification of unresolved parameters.

Parallel to designing technology solutions by using a Solution Design tree structure, the STE 514 allows different user roles (FIG. 6) of the BSM system 150 to graphically view and edit these objects. Alternatively, the user may decide to build (activate) the technology architecture from scratch in the STE 514 rather than building them in the Solution Design Interview Module 214. The resulting technology objects are also reflected in the Solution Determination Structure 1108.

The STE diagrams are cross-linked to both the parameters in the SDS 1108, the Technology Object Templates 1118, and the Business Object Templates 1116. The “use cases,” for example, can be used to provide a “bridge” between process-driven business requirements and possible technology answers.

A change of the state of a technology object is accomplished through a “business step.” The set of technology objects identified for a certain “use case” represents the system requirements that are desired to construct this use case. The steps then describe in which way the technology objects are employed in the specific use case. An example for a simple use case could be “User logs on.” The first two “steps” of this use case are “User enters username and password in Browser” and “Browser passes username/password combination to user management component.” The two “technology objects” involved in the second step are “browser” and “user management component.” The step action is “pass username/password combination.” During robustness analysis, the system 150 categorizes the technology objects in the categories of interface, control and entity objects, and checks the identified set of technology objects for completeness and rationality, based on certain interaction rules for the different technology object types.

The system 150 can generate a “class diagram” for every process based on the sequence diagrams. The “class diagram” contains the technology objects of the sequence diagrams as “classes,” and the interaction steps between the objects as methods of these classes. The class diagram also shows relationships between these classes based on the interactions in the sequence diagram. The generation of class diagrams is likely for use cases and/or business processes, for which new software development may be needed. A class diagram is therefore mainly aimed at development consultants and developers to create the first draft of system architecture.

STE 514 also enables a domain expert to evaluate how well an IT landscape executes standard business processes. The expert works with a base landscape that may be either an actual landscape or a standard landscape that closely mimics the actual landscape. In the first case, STE 514 will guide a system administrator in the steps used to store the actual landscape within the system 150. The user takes the base landscape and manipulates it by adding or subtracting various components. The user then chooses from a list of stored business processes and views the process flow within the manipulated landscape as follows. For each step in the business process, certain technology components are used to provide the functionality to execute that step. Therefore, those specific components are highlighted in the solution architecture. Components that are not involved in the execution of that step are grayed out. The user may store the base landscape, the changes to it, and the desired business processes in the Solution Determination Structure 1108 for further evaluation.

In addition to the automated solution development rationalization provided by the BSM system 150, developers can employ STE 514 to generate visual product specifications based upon the processes, activities, and steps highlighted in the SDS 1108. These visual product specifications can take the form of UML diagrams, and the UML diagrams would allow the developer to specify a complete API for the product(s) used to fill the functionality gaps. The existence of the API enables the application to generate a skeleton of the product to be developed. Developers can also determine technical constraints specific to a candidate solution landscape by viewing the manner in which the functionality being developed will be deployed in that landscape.

Once the graphical solution architecture has been validated and any discrepancy in functionality resolved by new software development, a prototype is created to complete the validation process. Every critical business scenario is identified, and the technical consultant designs the prototype to enable the execution of that scenario.

For each “step” 1208 in the business process, the technology components involved in its execution are configured for the given scenario, and the functional consultant executes the process upon completion of the configuration. Failure is flagged for immediate investigation due to the critical nature of the process. The prototype is declared a success once all of the critical scenarios have been executed properly. The consultant can then proceed in an iterative fashion to implement the technology components used for the next-most critical group of processes. Failure to execute a particular process no longer implies failure of the solution as a whole.

Application of Solution Design and Engineering to the Example Scenario

In the previous Functional Area application to the example scenario, Solution Development Management (SDM) 516 was applied to configure the BSM suite 100. The system 150 created a methodology MM1 902A based on the standard BSM methodology 900 with some additional parameters 904. A Solution Determination Structure SDS1 1108 was created based on the standard BSM solution. MM1 was assigned to SDS1. Several control objects, business objects, and technology objects were created. Several Solution Determination Procedures 1000 were created and assigned several rules-based and classification-based control objects and related routines.

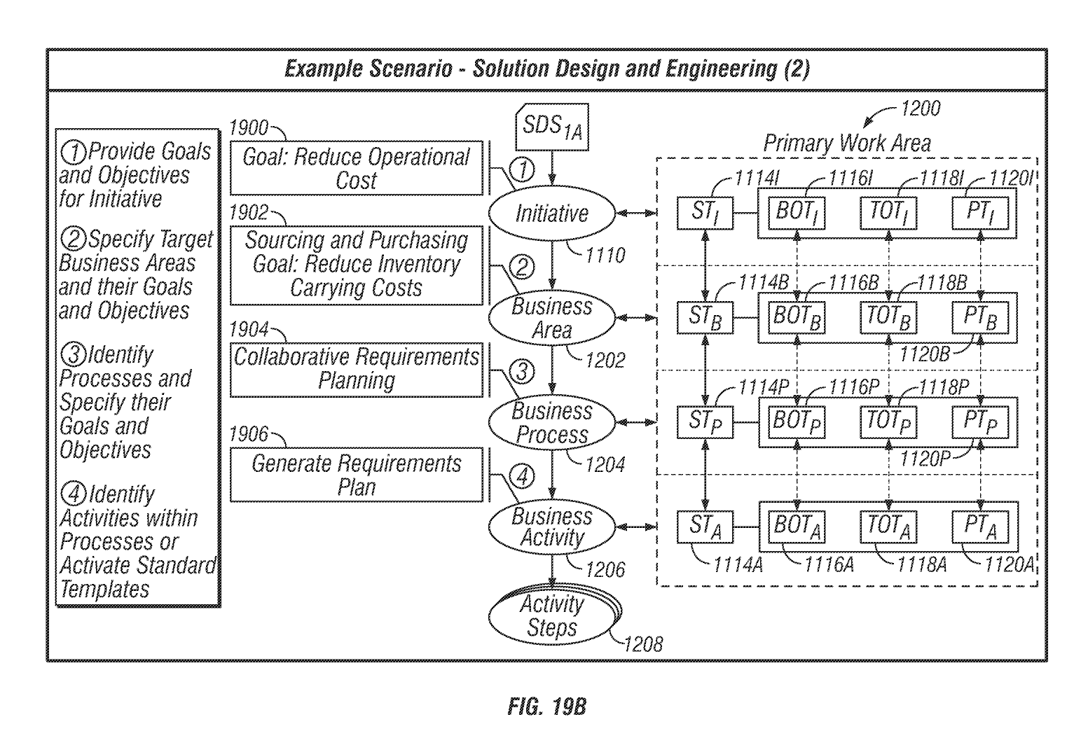

FIGS. 19A-19B illustrate a process of creating and specifying a BSM initiative 1110, business area 1202, process 1204, and activity 1206 in the Solution Design and Engineering functional area 508 of FIG. 5B. The user begins by instantiating an Initiative business object 1110. The creation of the Initiative object 1110 results in the creation of a business object template 1116I, a technology object template 11181, and a project template 1120I. Additionally, a solution template 1114I is created and all three of the other templates 1116I-1120I are assigned to it. A work area 1112 is created and the solution template 1114 is assigned to the work area 1112. The work area 1112 is assigned to the Initiative 1110.

The user defines the business goals and objectives expected to be achieved by the initiative 1110. The system 150 prompts the user to specify the company's initiative 1110. The answer, “to reduce costs substantially” (or “increase productivity”) 1900 (FIGS. 19A-19B), is stored as an objective of the Initiative object 1110. The system 150 next prompts the user to identify quantifiable performance goals that can be used to measure how well the company is meeting the objectives. The answer, “to reduce materials-related operational costs across the corporation by 10%,” is stored as the goal of the Initiative object 1110. Both goals and objectives are attributes of Initiative objects 1110.

Finally, the system 150 prompts the user to specify the target business areas 1202 for meeting the initiative's objectives. The user's responses, “Sourcing and Purchasing, Warehouse Management, and MRO Management” 1902, are stored as components of the instantiated business template 1116B.

The above process—instantiation of a business object, identification of the objectives of the object, specification of quantifiable goals that ensure the objectives are met, and determination of targeted business area sub-objects for meeting the objectives—is repeated for each of the business areas 1202 that the customer has specified.

In the business area 1202 of Sourcing and Purchasing, the user identifies the following as “objectives”:

1. Reduce transactional cost per purchase part

2. Reduce carrying costs for inventory

3. Consolidate purchasing of parts and commodities

The user specifies the following as performance “goals” for meeting the objectives:

1. Transactional costs reduced 8%

2. Reduce safety stock by 25%

3. 95% of parts purchased using same procurement mechanism

The SDS parameters have led the user through Q & A to establish an initiative 1110 and the related business areas 1202. The user then identifies the following processes 1204 for consideration: Supplier qualification, Requirements planning, Purchase order cycle, Detailed scheduling, Receiving, and Payment authorization.

The user selects to apply the BSM Interview Module's Q & A process to the supplier qualification process 1204 assigned within the Sourcing and Purchasing business area 1202. The results are that the user has instantiated a business object, identified the goals of the object, specified quantifiable objectives that ensure the goals will be met, and determined the targeted business sub-objects for meeting the objectives.

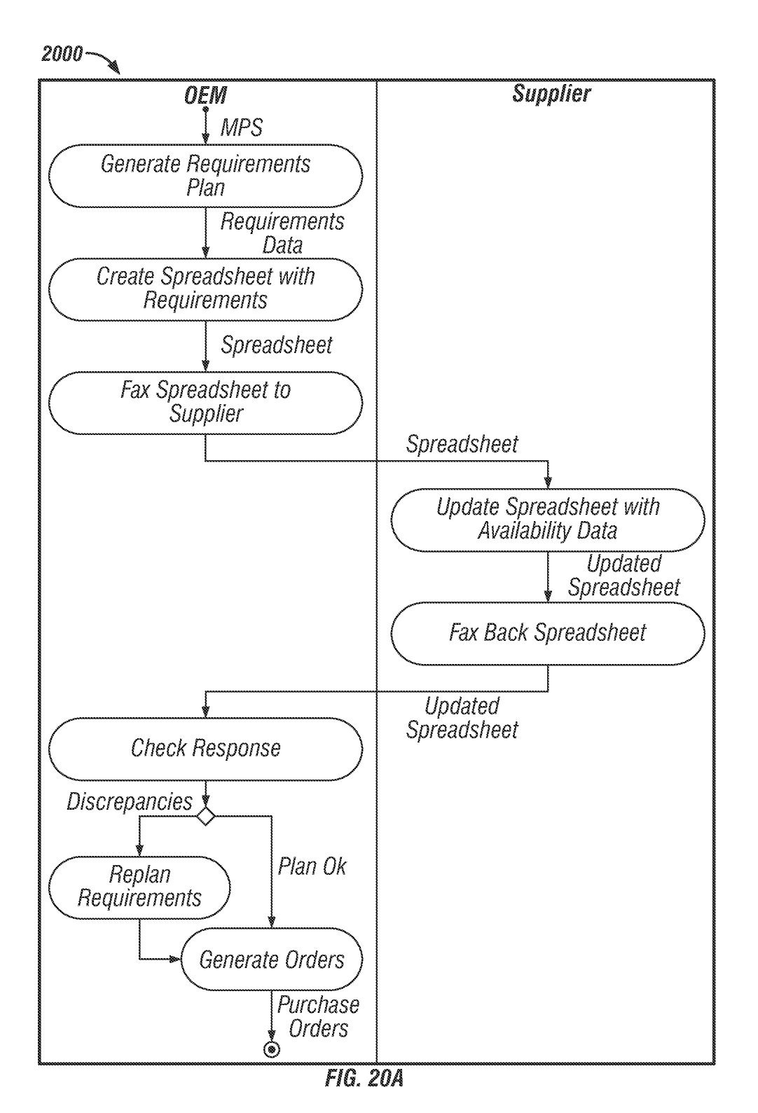

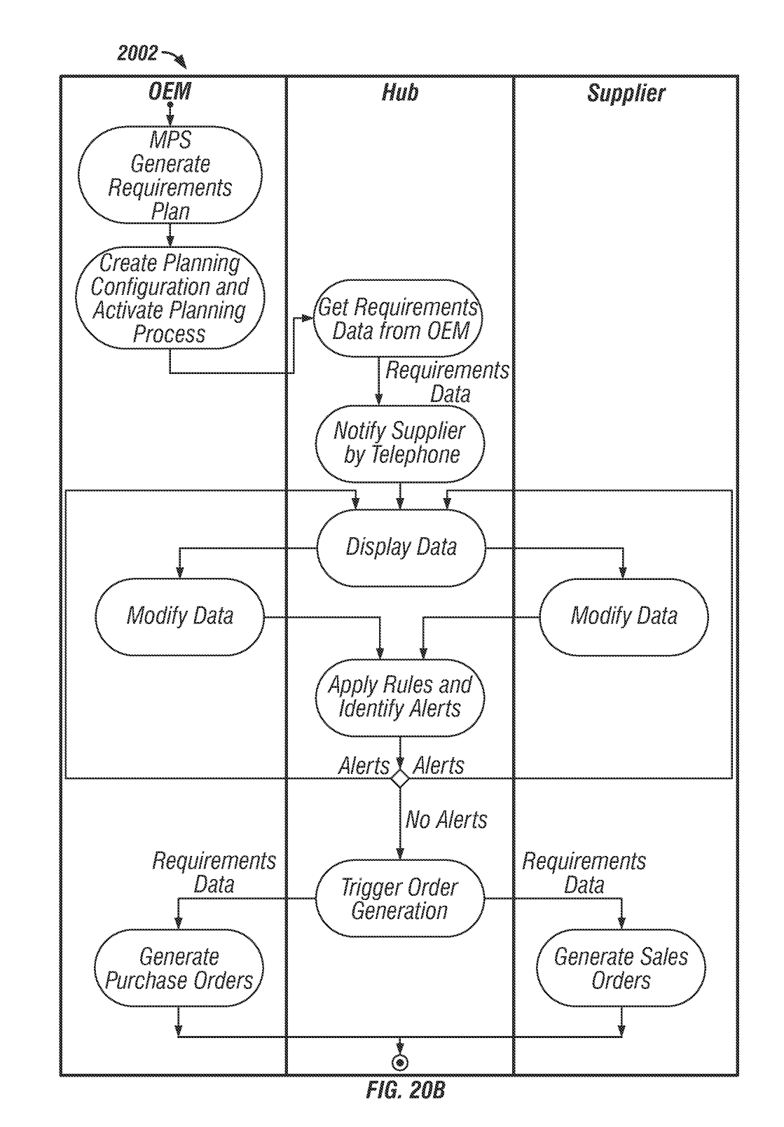

The user may choose a different application for the requirements planning process. The user decides to graphically model the requirements planning process in BSM's Business Process Engineering (BPE) function 512. The user may model a current process 2000, as shown in FIG. 20A.

FIGS. 20A-20B illustrate current and desired process business objects from a business process in FIGS. 19A-19B. After completing the modeling of the current process 2000 in FIG. 20A, the user saves it. When the user saves the process 2000, BPE 512 asks the user whether the user wishes to save the process 2000 as a graphical representation or if the user wishes to fully activate the process 2000 within the BSM system 150. Full activation may need validation of all the listed activities. The user therefore decides to postpone validation until the user has explored other options. The user may be particularly focused on one desired option, “using a central hub for collaboration on requirements planning between it (an OEM) and its core suppliers.” FIG. 20B illustrates the user's desired process model.

After completing the modeling of the desired process 2002, the user saves it. When the user saves the process 2002, the system 150 asks the user whether the user wishes to save the process 2002 as a graphical representation or if the user wishes to fully activate the process 2002 within the BSM system 150. The user may decide to continue with the validation procedure. Based on the structures that were defined in the BSM Solution Development Management 516, the system 150 recognizes the defined process as the process object RealTimeCollaborationWithPartner. When the user saves the graphical model, the system 150 immediately prompts the user with the question Q RealTimeCollaborationWithPartner. The user responds affirmatively.

BPE 512 instantiates a RealTimeCollaborationWithPartner process object, and instantiates the corresponding business object template 1116P. BPE 512 then compares the activities listed in the graphical representation to the activities listed in the business template 1116P. The result is that BSM 150 utilizes the SDS 1108 to identify the unresolved parameters and present them for the user's resolution, assuring the proper functioning of the business and related technology objects.

Once activation is complete, the user has produced instances of the following objects within the Business Process 1204 that the user described as Collaborative Requirements Planning

1. A RealTimeCollaborationWithPartner process object

2. A BTRealTimeCollaborationWithPartner business template

3. A development task object

4. A NewApplication technology object (ConcurrentEditor)

5. A technology template associated to the NewApplication object

6. A ConcurrentEditView technology object

7. A TTConcurrentEditView technology template

The user has also created an instance of the solution template 1114 associated to the business template BTRealTimeCollaborationWithPartner. This solution template 1114 includes the business template 1116 as well as the technology templates 1118 associated to ConcurrentEditor and the ConcurrentEditView technology object. Note that the DataControl object that instantiates ConcurrentEditor dictates that the rule NewApplicationDevelopment be executed. This rule establishes the following information:

How does the application communicate with external systems?

What is the application's functional API?

This information specifies how the application is to interact with the other technology objects and thus allows the BSM STE function 514 to place the application in the solution work area 1200. Once activation is complete, the user employs the STE 514 to demonstrate how the technology objects in the solution work area 1200 execute the process of real-time collaboration.

On the process level 1204 (FIG. 19B), the STE 514 asks the user to assign activities to main technology objects. The system 150 has filled the solution work area 1200 with the standard technology objects from the technology object template 1118. The user can edit the work area 1200 by modifying or deleting existing objects and by adding new objects. Every activity 1206 of the process 1204 is executed on one or more technology objects.

FIGS. 21A-21B illustrates a process-related technology solution work template. FIGS. 21A-21B shows an assignment of technology objects 2102 and activities 2100. The activity objects 2100 represented in the list on the right are mapped to technology objects 2102. After this process-level assignment of technology objects 2102, the user may step through each activity 2100 in the process. The STE 514 highlights the particular technology components 2102 that work together to execute the activity 2100.

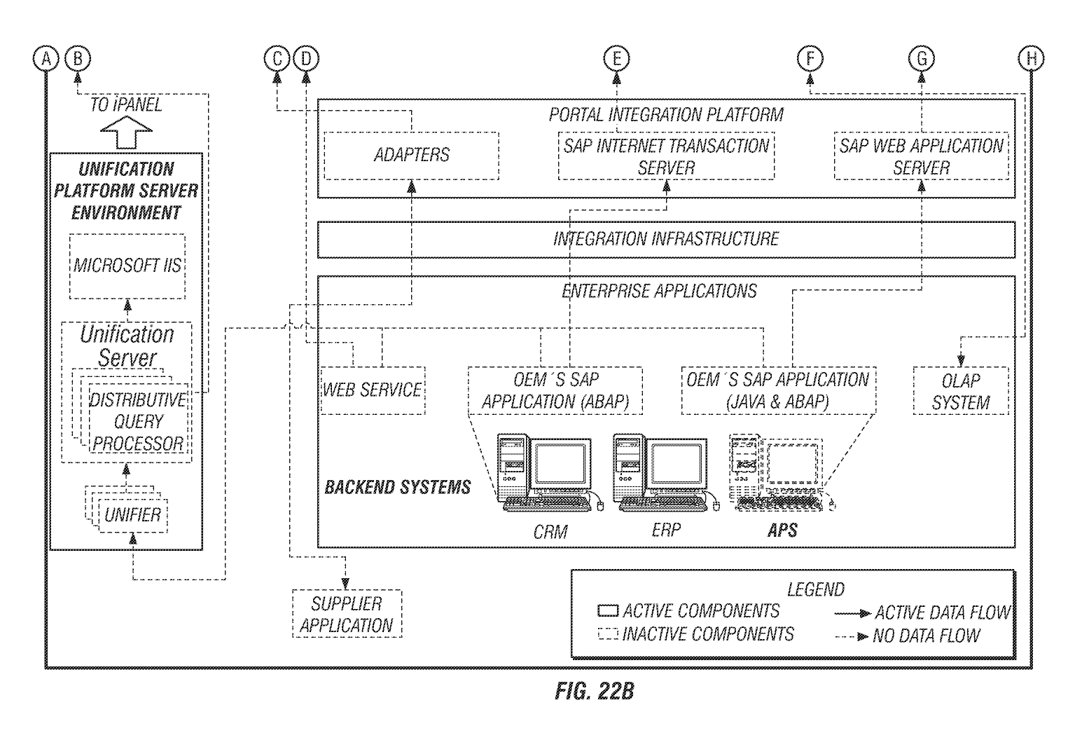

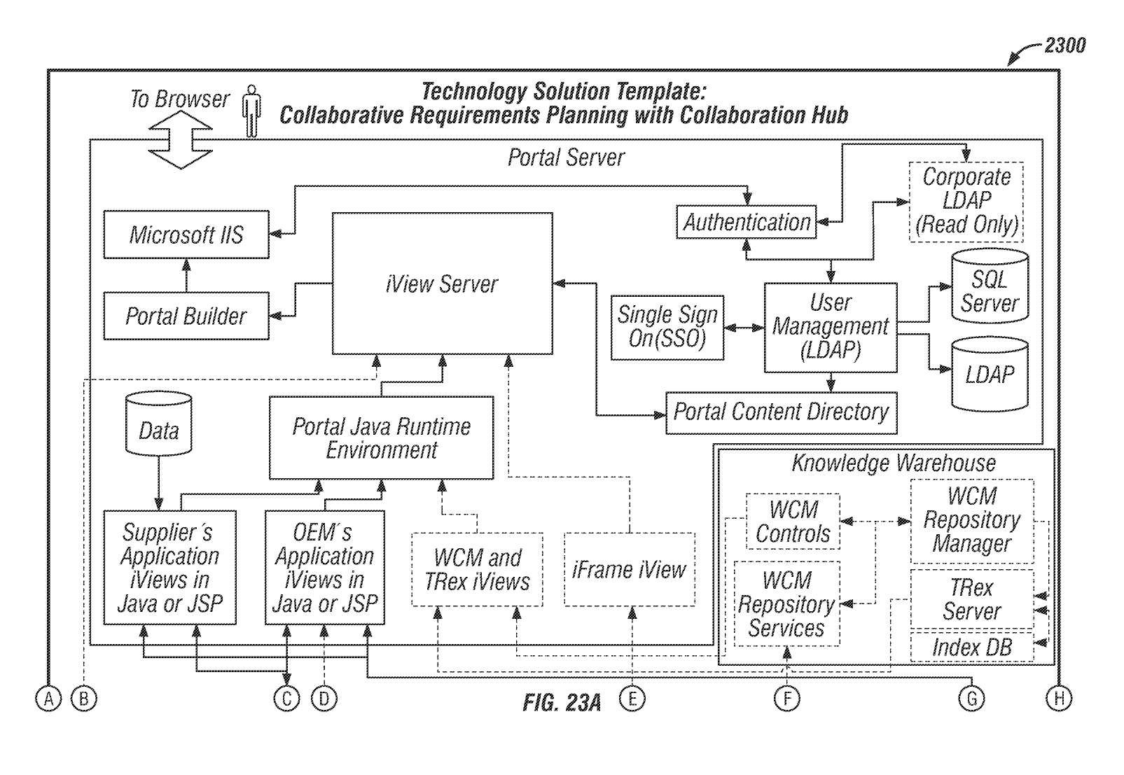

FIGS. 22A-22B illustrates an activity-related technology template and shows how a graphical assignment of business steps to technology objects may work. Specifically, FIGS. 22A-22B illustrates steps of Activity 5 from the activity list 2202 in FIGS. 21A-21B.

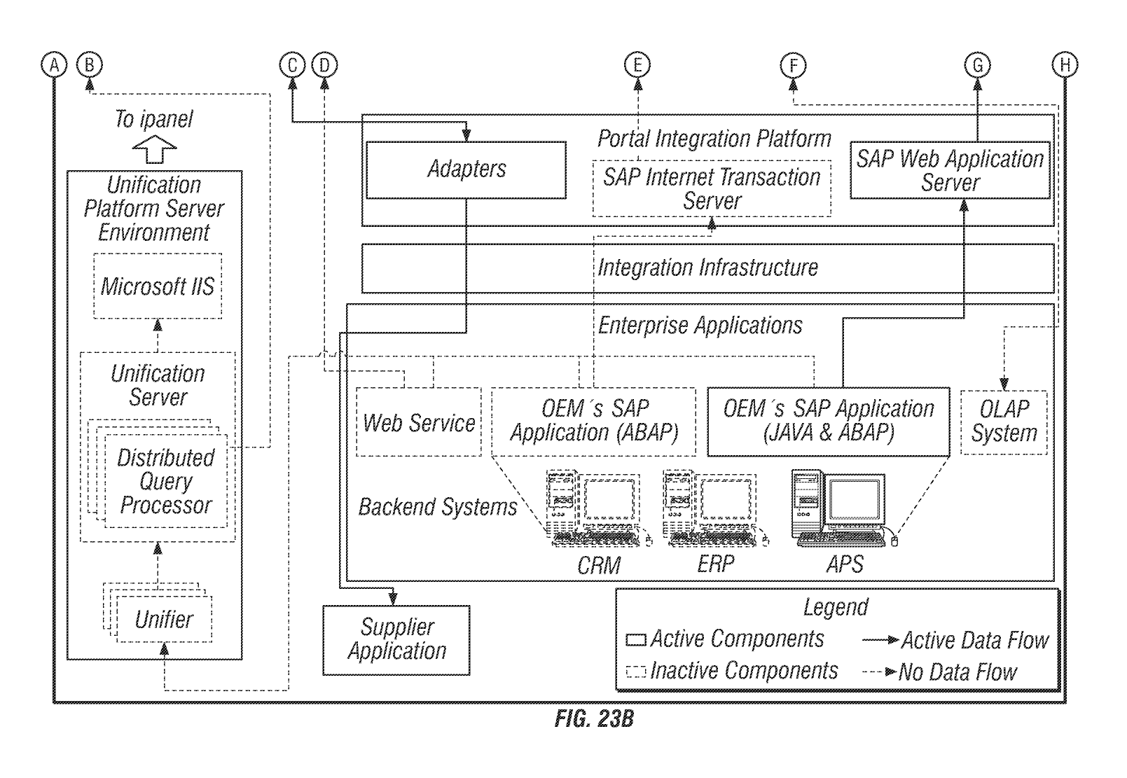

After the user has identified all of the technology objects 2102 (FIGS. 21A-21B) that comprise the solution, the user can view the final technology landscape 2300 (FIGS. 23A-23B) that contains all these technology objects 2102 in the STE 514.

FIGS. 23A-23B illustrates a final solution technology landscape or map 2300. This landscape 2300 represents the current state of the technology template of the solution work area 1200, and thus is the basis for the following validation and prototype development and configuration. The landscape 2300 specifically highlights those technology components of the generic technology template that are needed to realize the business objects in the current work area, for example the RealTimeCollaborationWithPartner process object.

Next, the user and the customer need to prototype the solution. Prototyping may need the configuration of existing technology objects as well as development and configuration of new applications. In particular, the user may needs to develop, configure, and deploy the application ConcurrentEditor.

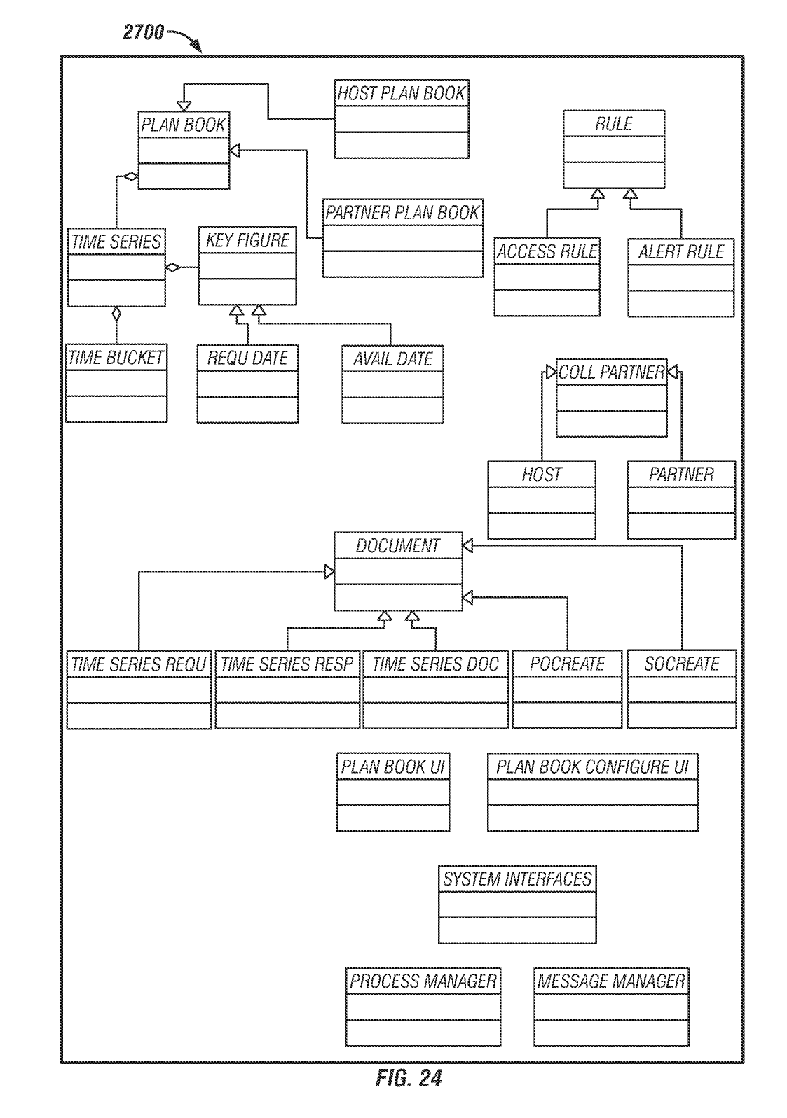

FIG. 24 illustrates a Class diagram of a prototype application called ConcurrentEditor 2400. The user has already identified how the application 2400 communicates with external systems and the application's functional API. The user has also identified the system requirements during the identification of the activity and its steps. The main classes involved in the development may flow directly from the textual description of the activity and steps. STE 514 displays these classes in a static structure 2400. STE 514 also instantiates a technology object and a corresponding technology template for each class represented in the static structure 2400. STE 514 waits for the user to supply public methods and each method's signature for all of classes in the static structure 2400. Each class's methods are stored as attributes in the technology template corresponding to the class. The STE 514 then asks the user to group the classes into packages. Since all of the classes corresponding to ConcurrentEditor are closely related, the user may place all of the classes into a single package. STE 514 then instantiates a technology object and its corresponding technology template. Both in turn correspond to the newly created package. Each of the classes in the package is stored as components of the technology template.

The STE 514 utilizes the SDS 1108 to determine that the user should identify the technical information desired to realize the application. To do so, the STE 514 prompts the user for the following information.

What is the development language?

What is the application platform?

What physical server will host the application?

The user may respond with the values: Java, SAP WebApp Server, BIN. The system 150 now generates skeleton code that implements the technical API that the user specified in STE 514.

Once Design and Engineering 508 is complete, the user and the customer have a fully functioning prototype solution that executes all of the desired processes. The next functional area is to move the prototype into a productive environment, which may be handled by the Integrated Implementation Management function 534 (FIG. 5B).

Integrated Implementation Management

Integrated Implementation Management 534 in FIG. 5B may include:
Complete configuration of technology components in a solution, e.g., FIGS. 23A-23B;
Complete integration of the solution's technology components;
Complete testing and realization of the solution; and
Productive solution landscape implementation.

In the last part of the Solution Design and Engineering 508, the user created one or two solution prototypes to validate the best alternative business and technology solutions. This process used the Integrated Implementation Management (IIM) function 534 to the extent that configuration occurred to pursue these prototype validations.

The IIM function 534 encompasses the final and complete configuration and integration of all of the solution's technology components, e.g., FIGS. 23A-23B. The goal is to assure a successful implementation of a productive solution throughout the enterprise's landscape. The integration may affect all solution components and actor roles involved in the implementation process.

The user may use IIM 534 to configure and administrate the technology components of the designed and engineered solution in the post-Solution Design and Engineering (SDE) solution landscape from one central point. This includes monitoring technology components. All relevant configuration and implementation information may be maintained in one location. This significantly facilitates and accelerates the implementation of complex, distributed solution architectures.

The integration requirements for a solution's technology components were identified during the SDE processes. A user may use IIM 534 to automatically connect to and perform these configuration settings based on pre-defined mapping templates in the Integration Infrastructure 506 (FIG. 5B) (also 2104 in FIGS. 21A-21B) of the BSM system 150 (FIGS. 3A-3B). The consultants or developers who are responsible for the solution's implementation maintain configuration data in the BSM system 150, and the system 150 transmits this information to the respective solution components. IIM 534 may perform automated generation of documentation.

BSM's communication to external applications is based on the direct exchange of relevant data between the functions of the BSM system 150 and other systems. The IIM function 534 reads configuration parameters of selected technology objects within a solution and sends the values of these parameters to the appropriate system component using the integration infrastructure layer 2104 (FIGS. 21A-21B) of BSM 150. The IIM function 534 can also retrieve actual configuration and status information from the technology components, and then display the information to users.

The BSM IIM technology may be based on:

mySAP Exchange Infrastructure 114 (FIGS. 3A-3B) for configuration of business processes and solution components in the Integration repository and directory;

SAP Web Apps Server IMG;

SAP R/3 IMG;

Project management tools;

Documentation or word processing tools for the automated generation of application, project or user documentation; and

SAP and non-SAP development tools for the automated generation of code frameworks from diagrams.

In order to enter all relevant configuration data for the systems involved in the solution, the systems to be configured should be connected to the BSM system 150. In this manner, the centrally maintained configuration data can be simultaneously communicated to the systems to be configured. This function is performed in the Exchange Infrastructure 114 of the BSM architecture 150. A typical procedure was briefly described in an earlier section “Infrastructure Management” 501 with regard to the APO system.

The configuration of the connection to new systems may also be performed from IIM 534, as IIM 534 is integrated with the BSM Integration Infrastructure components 2104 (FIGS. 21A-21B). The Integration Infrastructure 2104 (FIGS. 21A-21B) may be based on mySAP Exchange Infrastructure technology and may be used to configure and execute all forms of communication between BSM 150 and external systems. Configuration information for every external system with which the BSM system 150 needs to communicate should be entered in an Integration Directory, which may be based on the integration directory functionality in mySAP Exchange Infrastructure technology. In IIM 534, the user of the BSM system 150 should assign the information on these external systems that has been written into the BSM Integration Directory.

For external systems that are web service enabled, the systems have described their functionalities using WSDL and have published these services to a Universal Description, Discovery, and Integration (UDDI) registry (such as the SAP UDDI registry). Information on these services can be located and updated in the BSM Integration Directory so that appropriate service invocation can simply be triggered with standard SOAP protocol. In such a setup, the actual configuration data and response may be transmitted as payloads of the message.

Application of Integrated Implementation Management to the Example Scenario

The scenario below describes configuration of main components involved in the sample solution designed in the previously described Solution Design and Engineering 508. The scenario includes (a) an Advanced Planner and Optimizer (APO) system, which contains the “master” requirements data of the OEM, (b) a new application developed in Java that resides in the Extranet of the OEM that manages the collaboration requirements and availability data, and (c) a SAP Business Connector (BC) connecting the APO and this new application.

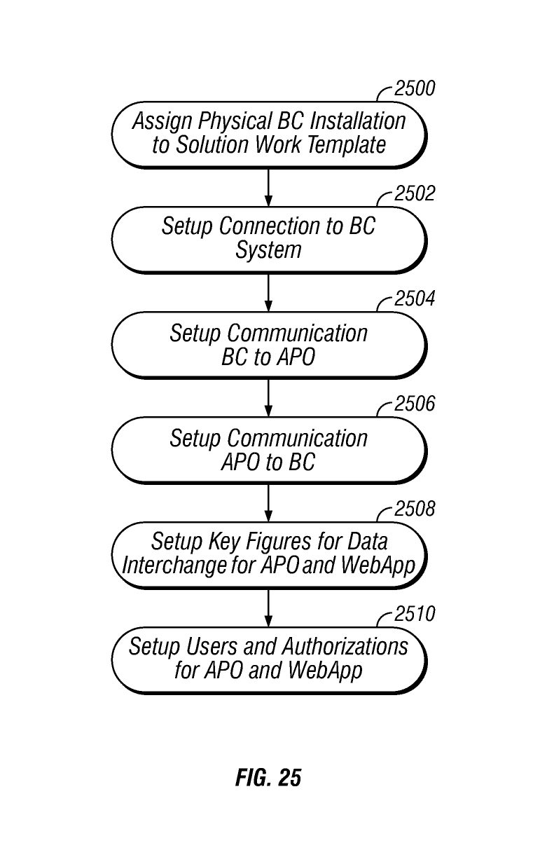

FIG. 25 illustrates a process of setting up a Business Connector (BC), an Advanced Planner and Optimizer (APO) and other configurations. This scenario assumes that the development of a Java application for Collaborative Requirements Planning already occurred, and the application is ready for deployment. Consultants responsible for the technical and functional configuration of the solution will perform the activities and steps in the scenario.

Since IIM 534 is closely integrated with the Project Management function 222 (FIGS. 3A-3B) of the BSM system 150, all steps described in this scenario may be assigned to different users of the system. The first four steps of this scenario in FIG. 25 are technical in nature and are more likely to be performed by a basis consultant. Either a functional or a business consultant may perform the last two steps.

In this example, the actual configuration data and response may not be transmitted as payloads of the message. The external systems may not have this capability in the production landscape. As a result, the communication and the protocol are system-specific, e.g., SAP RFC call, etc. The BSM system 150 is not limited to SAP communication protocols. This by no means implies the limitations or restrictions in system integration functionality of a BSM system 150.

In the scenario, the user adds a Business Connector (BC) component as part of the solution to the implementation landscape. In order to do so, the user chooses a function of the IIM 534 that links to the BSM Integration Directory (not shown). In the BSM Integration Directory, the user enters information about the physical installation of the BC component and its communication parameters, and then saves these inputs. Back in IIM 534, the user assigns the created external component to the respective technology component of the BSM solution object. The flowchart in FIG. 25 illustrates the basic flow of the activities that a consultant will go through to successfully connect and configure various systems using IIM functionality 534.

After blocks 2500-2506 in FIG. 25, the BSM system 150 is now properly configured to communicate with the APO as well as with the BC. The user may want to configure the direct communication between APO and BC without explicitly logging on to the APO and the BC separately and entering the required settings in each system at a time. Therefore, the IIM user requests one or more configuration tables from the BSM Implementation Repository 250B (FIGS. 3A-3B). The user inputs all relevant configuration data to set up communication between the two systems, such as RFC connection information for the APO and authorization information for the BC. The IIM 534 then sends this information in one execution step to both systems using the BSM Integration Engine, which may be based on the Integration Engine (runtime) in mySAP Exchange Infrastructure technology. This step first transforms the data according to the mapping schemas in the BSM Integration Directory, and then routes the messages to the destination systems. Positive responses from both systems routed back to IIM 534 will inform the user that the communication channel has been established.

After establishing the communication between both systems, there are some key figures that the solution needs for the OEM and his supplier to collaborate. Block 2508 in FIG. 25 sets up key figures for data interchange. These key figure configurations have to be maintained in the APO system as well as in the new DMZ Collaborative Requirements Planning application. The user can again request a central table within the IIM 534, which contains all configuration data for the key figures, such as key figure name, time bucket size, planning horizon, etc. The table definitions stored in the BSM Implementation Repository 250B should be the output from one of the development tasks that the solution implementation team completed previously. After entering and submitting the information needed, it is populated to both the APO and the Java application, again using the integration process described above.

Finally, user information needs to be set up in both systems, as shown in block 2510 in FIG. 25. The user information provides users of the Collaborative Requirements Planning solution with the appropriate authorizations to send, view and edit the key figures according to their respective roles. This is managed centrally from the IIM 534 by creating user IDs, passwords, and assigning user roles. These settings are then mapped into the respective roles and authorizations of the APO system and/or the Java application. If some BSM user IDs were already synchronized with APO (for instance in our example, Solution Designer John Smith), the IIM user can simply re-synchronize the three systems so that BSM 150, APO, and the new application all have the same user information.

Project Management

Project Management 538 may include:
Creating, managing, and controlling business solution development efforts as projects through a unified multi-level plan that is centrally generated and maintained;
Ensuring that each BSM project is defined, managed, and executed in accordance with the desired methodology throughout the project's lifecycle, from initiative declaration to final implementation;
Providing a central user interface for the definition, and monitoring of project structures, task objects, resources, assignments, progress, milestones, cost management, and timelines of a BSM project; and
Export and import object-based project plan templates and project plans to external project management systems, such as SAP R/3 Enterprise PS module.

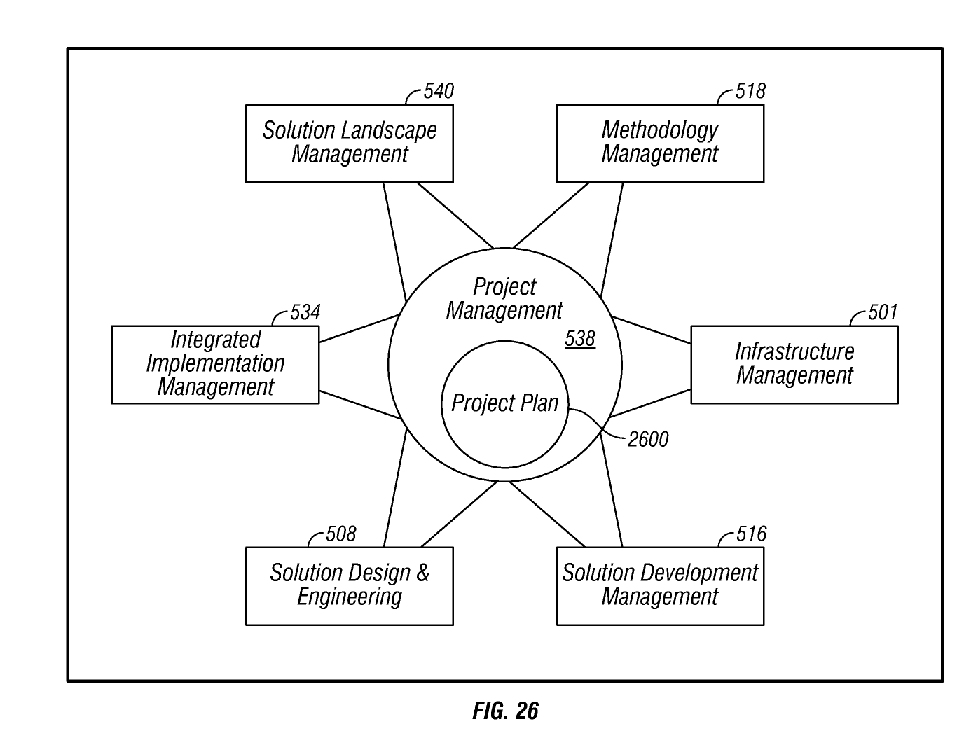

FIG. 26 illustrates project management 538 and other functions of FIG. 5B. Project Management 538 provides the complete functionality to schedule and track all tasks related to identifying, defining, creating, designing, and implementing business solution developments, encompassing solution methodology and determination structures, business process analyses, technology solution validations, and solution realization. Each project plan 2600 is continuously updated as the contents and/or status of each task is affected by BSM activities.

In the administrative area, solution designers 608 (FIG. 6) and project managers 614 may use this function 538 to generate and manage BSM projects. On the execution side, users such as sales, consultants 612, and developers 606 may access the Program Management function 538 to input information regarding the time estimate to complete each task, to enter additional resource information, and to update progress of the various tasks.

Project Management (PM) 538 may be completely integrated within the BSM system 150. PM 538 communicates with BSM Infrastructure Management 501 to assure that the proper access and application of project management functionality reflects the settings for users, roles, and access rules as defined there.

BSM 150 has a complete repository of projects templates and task objects 300 managed through the Solution Development Management 516 function. A vast, comprehensive suite of these templates and objects, which represent SAP's complete technology and application offering, may be provided by BSM. PM 538 applies these templates and objects throughout its scope of processes. In addition, the user can copy any of these standard project templates and/or objects, assign new IDs, and then modify them. Further, they can create their own objects and templates as they desire. Finally, project templates and objects from non-SAP vendors can be loaded to the project object repositories if these structures are object-based.

Project templates 1120 (FIG. 11) are linked through control objects 1004 (FIG. 10) to the parameters 904 of Solution Determination Structures (SDS) 910A. This linkage is pre-defined for the BSM standard SDS 908 (FIG. 9). As an Initiative 1110 is created within Solution Design and Engineering (SDE) 508, the user selects a SDS 1108 to be applied throughout the initiative 1110. An open project template with an elementary set of task objects is created and assigned to the initiative 1110 by the PM system 538. Predefined roles can also be assigned during the generation and will be subject to changes by the Solution Designer 608 (FIG. 6). These tasks and their resource assignments stored as a part of business practices are more generic so that they can be flexible to changes and modifications. For instance, in order to successfully measure the ROI on collaborative requirements planning, a business task can be created to calculate the overall cost of component purchase per transaction before and after the implementation and realization of the solution.

As underlying Business Areas 1202 (FIG. 12), Processes 1204, and Activities 1206 are created and linked to the initiative 1110, the SDE 1108 applies the SDS roadmap to work with the PM function 538 to create a nesting of projects that reflects the desired project template 1120 at each level. As new business and technology objects are identified in the solution determination process, the SDE 508 will instruct the PM 538 to activate templates and/or task objects, or even to create new projects as desired, according to the SDS parameters 904 (FIG. 9) and the control objects 1004 within Solution Determination Procedure 1000 assigned to the individual parameter. There is a similar relationship between the Integrated Implementation Management (IIM) function 534 and PM 538. Configuration and integration requirements area are identified in the IIM 534 based on the SDS 910A. Then IIM 534 interoperates with PM 538 to activate or create the desired task objects or project templates in PM 538 which are identified in IIM 534.

Each project template 1120 (FIG. 12) includes a project plan 2600 (FIG. 26). Information on a specific task of configuration and set up of a web application server, such as man-days needed & hardware requirements, may be obtained from either the project template's object for the specific component, or from parameters stored within the technology object web application server created in the Technology Object Management function 524. The user will be alerted to the requirement to assign and schedule task objects/templates whenever they are updated.

PM 538 allows an export of a project plan 2600 to an external object-based project plan management application such as Microsoft Project. Projects can then be managed off-line and later on be imported back into BSM's PM system 538. This approach, however, may limit the degree of integration that PM 538 has with other functional areas within BSM 150, in particular SDS 308 (FIGS. 3A-3B). Alternatively, BSM 150 enables bi-directional functional integration using APIs and document exchange with external project management tools, such as a R/3 project system or to publish functionality within PM 538 as web services to allow integration with either SAP or non-SAP tools.

In the example scenario used throughout this document, a new application may be developed to facilitate collaborative requirements planning Therefore, a new “project” dubbed Create New Application will be created and linked to the existing solution project plan at the process level 1204, and its initial contents can be suggested through a template. All the tasks and projects may be customized in the subsequent design stage. Specific development tasks associated with a creation of new application should be elaborated and further defined in PM so that they can be carried out effectively in the realization stage.

Finally, the execution of the project plan 2600 is carefully monitored to ensure the fulfillment of each assignment. Continuous updates and revisions to the status of each task contribute to the successful completion of the Solution Development initiative. Thus, any changes and modifications to any tasks or to the technology components during the design and validation of the solution architecture may be flagged and the project plan 2600 will be updated accordingly.

Solution Landscape Management

Solution Landscape Management 520 should not be confused with Solution Lifecycle Management even though both terms have the acronym “SLM.” Solution Landscape Management 520 may include:

loading and maintaining a generic technology landscape;

loading of an enterprise's IT landscape into parameter-defined architecture, business object template structures, technology object template structures, rule-based and classification/dependency-based control linkages;

SDS definition of business solution within enterprise landscape; and

Graphical object-based model of business solution within enterprise landscape.

Solution Landscape Management 540 is the primary BSM toolset for the IT executive 616 (FIG. 6) and the IT management team. Solution Landscape Management 540 is entirely focused on the IT perspective and the need to manage according to what solutions are productive and what solutions are in progress. The BSM Solution Landscape Management (SLM) function 540 builds on business solution development design and structures. SLM 540 encompasses a complete enterprise landscape repository containing all of the enterprise's individual business solutions. There may be one enterprise landscape maintained across all business areas 1204 (FIG. 12). For each business area 1204, there are individual solution landscapes that encompass business process landscape, and in turn the activity landscape. Each landscape level consists of solution templates 1114 that are linked to their respective SDS parameter-defined architecture templates, the related business object templates 1116, and the related generic technology template. The BSM system 150 has a complete repository of data that defines the entire enterprise landscape at all levels.

There are basically two different template types within the SLM function 540: productive and work in progress (not shown). As a WIP template is being assigned to a productive status (or on request), a validation process similar to the one performed during the solution design within Solution Technology Engineering 514 will be performed to verify the legitimacy of the enhanced landscape. Any discrepancy between the desired functionality of the business requirement and that provided by the architecture will be flagged and the deviations resolved before the landscape addition is validated.

SLM 540 utilizes the same BSM technology and structure models discussed above regarding Solution Design Engineering (SDE) 508 and Integrated Implementation Management (IIM) 532 to provide the information to its users. The SLM user can display the entire enterprise's landscape, either textually or graphically (a) from a specific step 1208 (FIG. 12) within an activity 1206 up to the entire enterprise landscape, (b) from a business model perspective, (c) from a generic technology perspective, (d) from a specific technology solution perspective, including components and configuration, or (e) from solution development costs and performance measurement results.

Additionally, these templates can be drawn into the creation and evaluation of alternative solution development proposals. Using this information, the current landscape can be further enhanced to optimize performance, to minimize cost, or to achieve any other business- or technology-driven objectives identified by the user.

The landscape may be updated by the other BSM components regarding changes in productive or WIP solution templates. Additionally, the BSM system 150 may provide an evaluation service for the comparison of new component releases to the current landscape's component releases. The release-specific information for SAP technologies and applications is provided over time to the BSM system 150. Other vendors' release-specific attributes can be loaded into release version technology templates for possible evaluation applications.

Sample Business Object Templates

This sections contains examples of business object templates 1116 (FIG. 11) in two different formats: graphical and parameter-based.

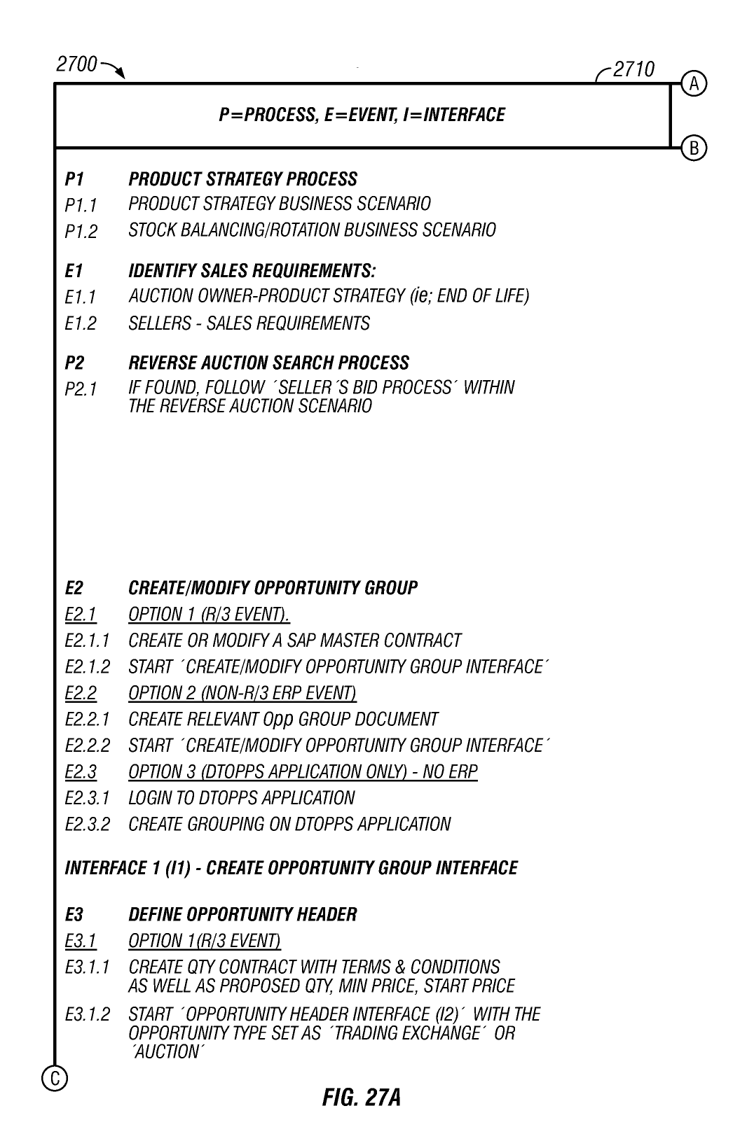

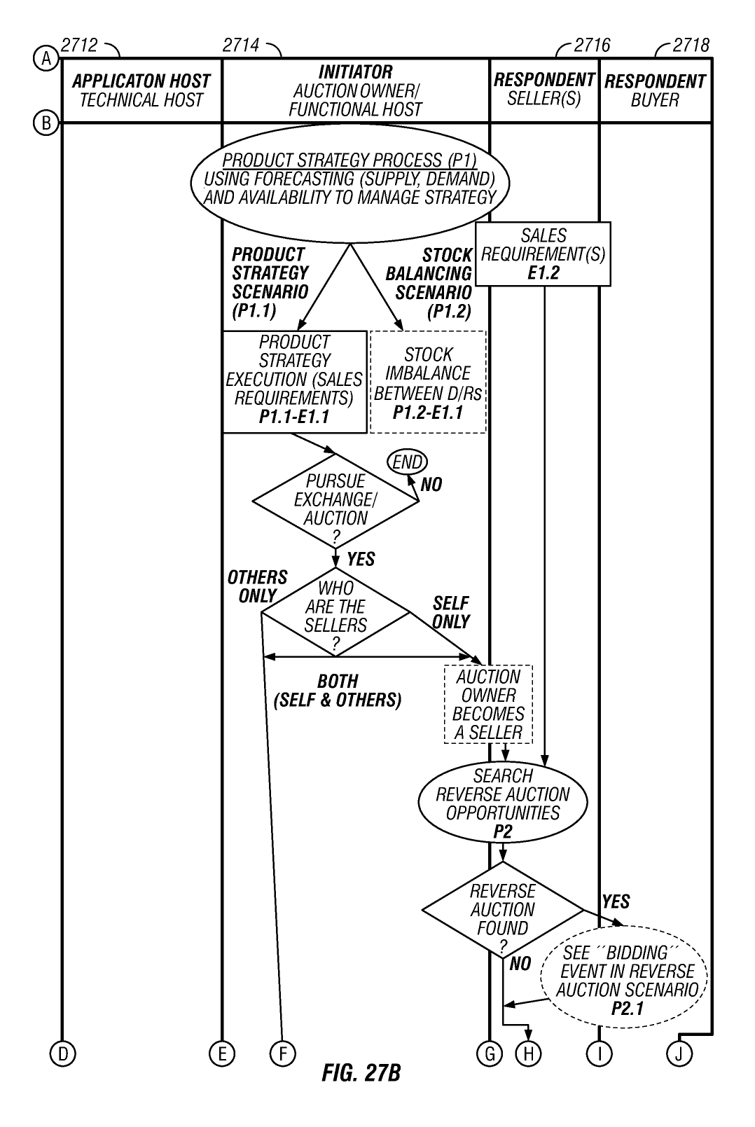

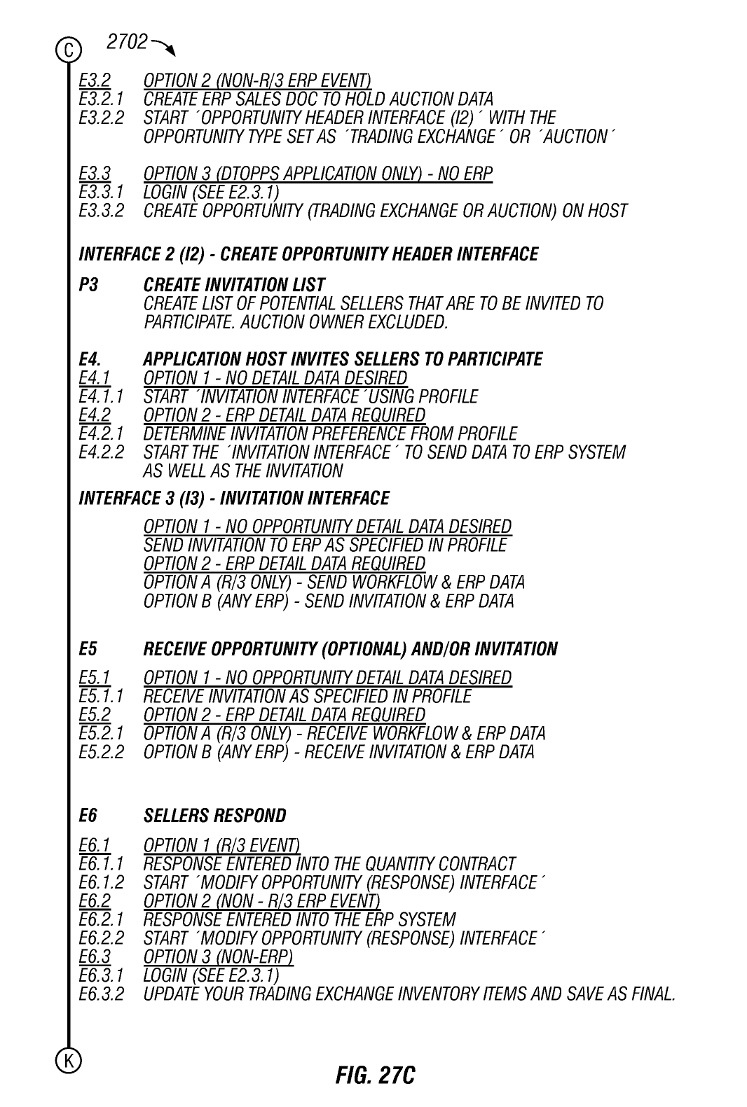

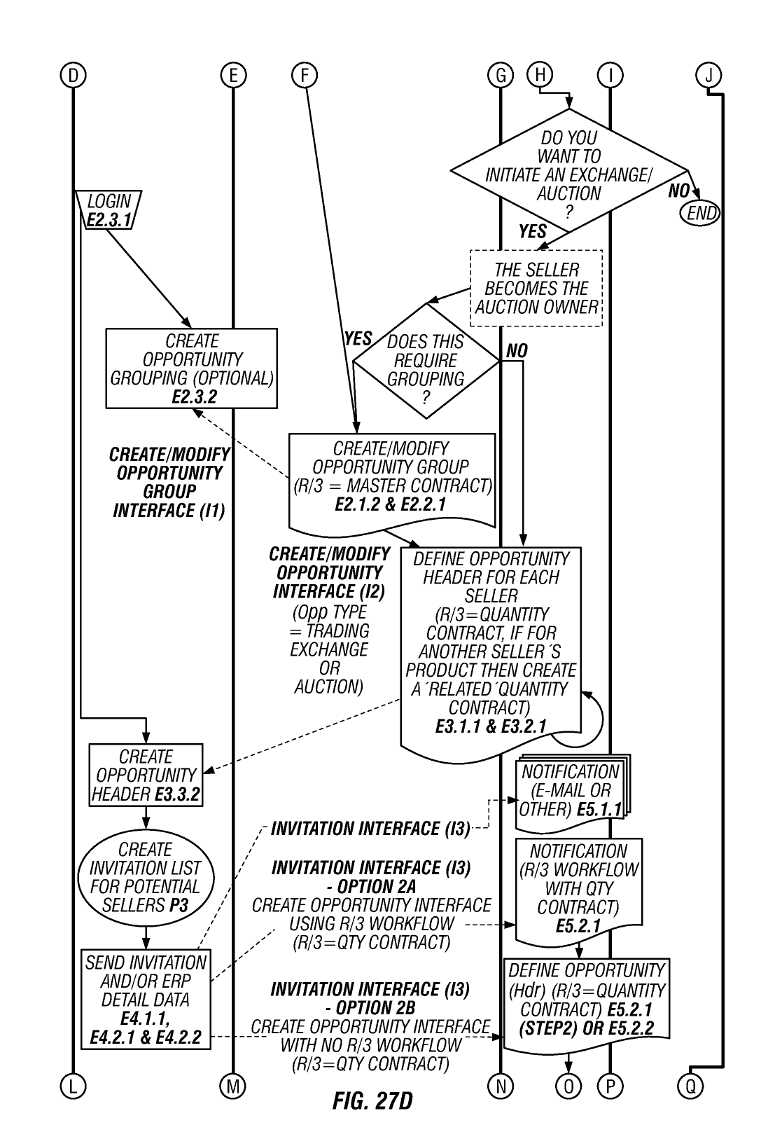

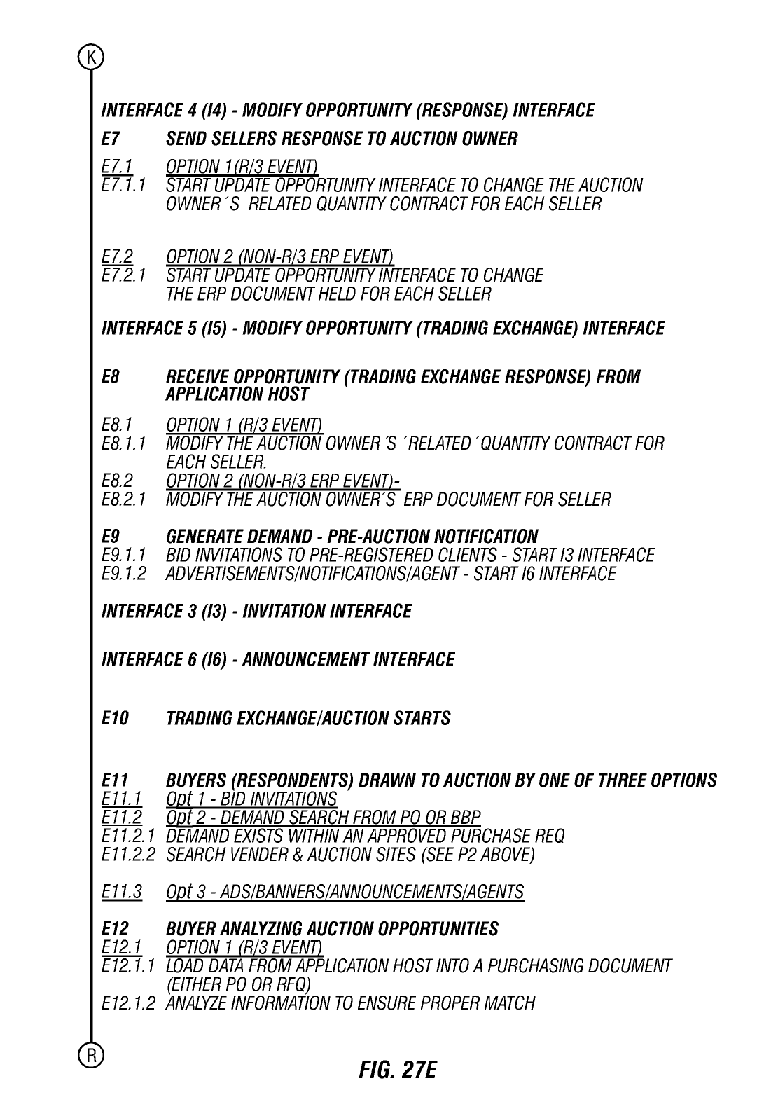

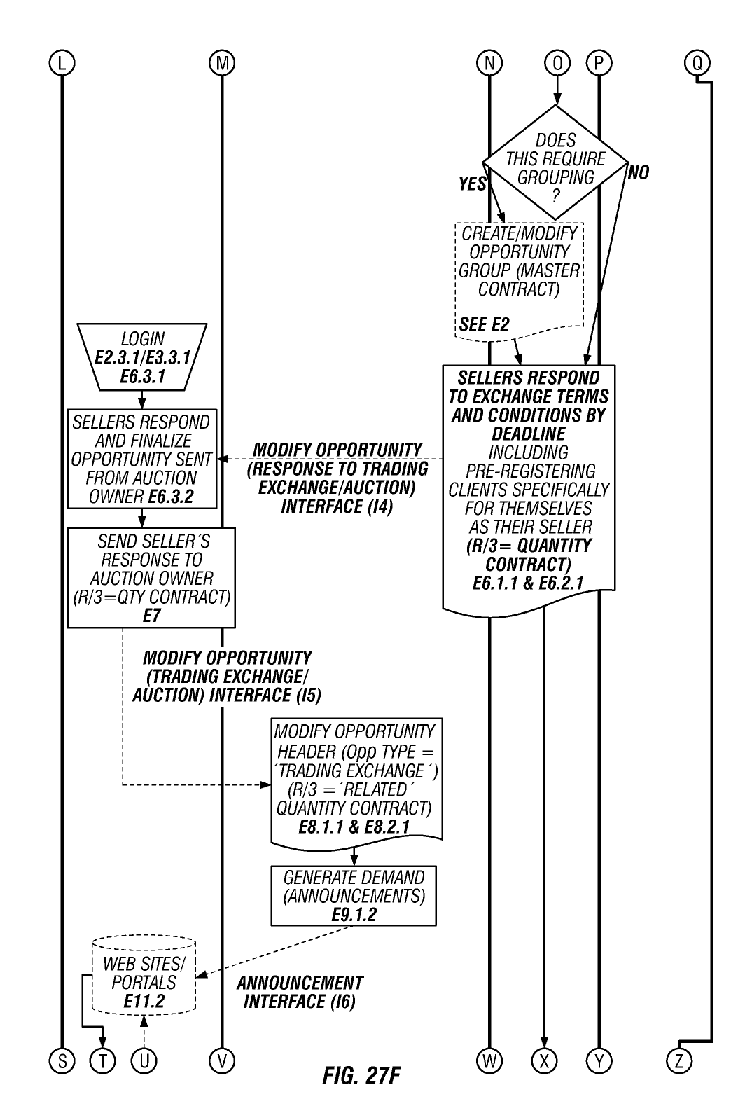

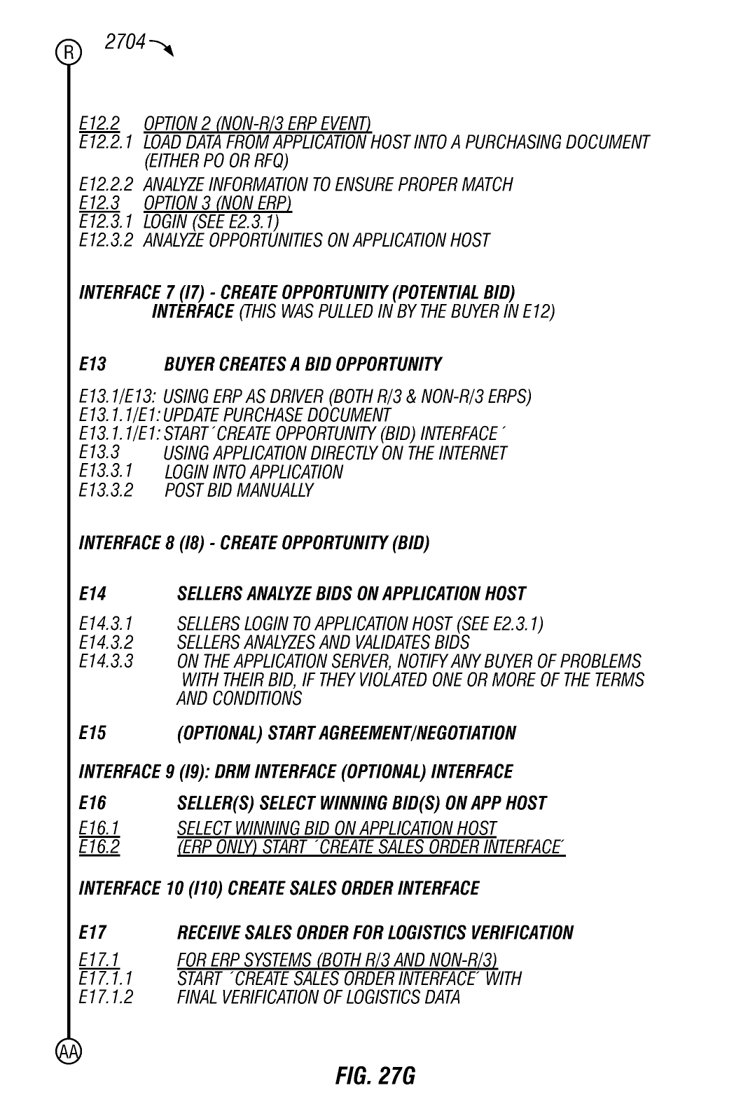

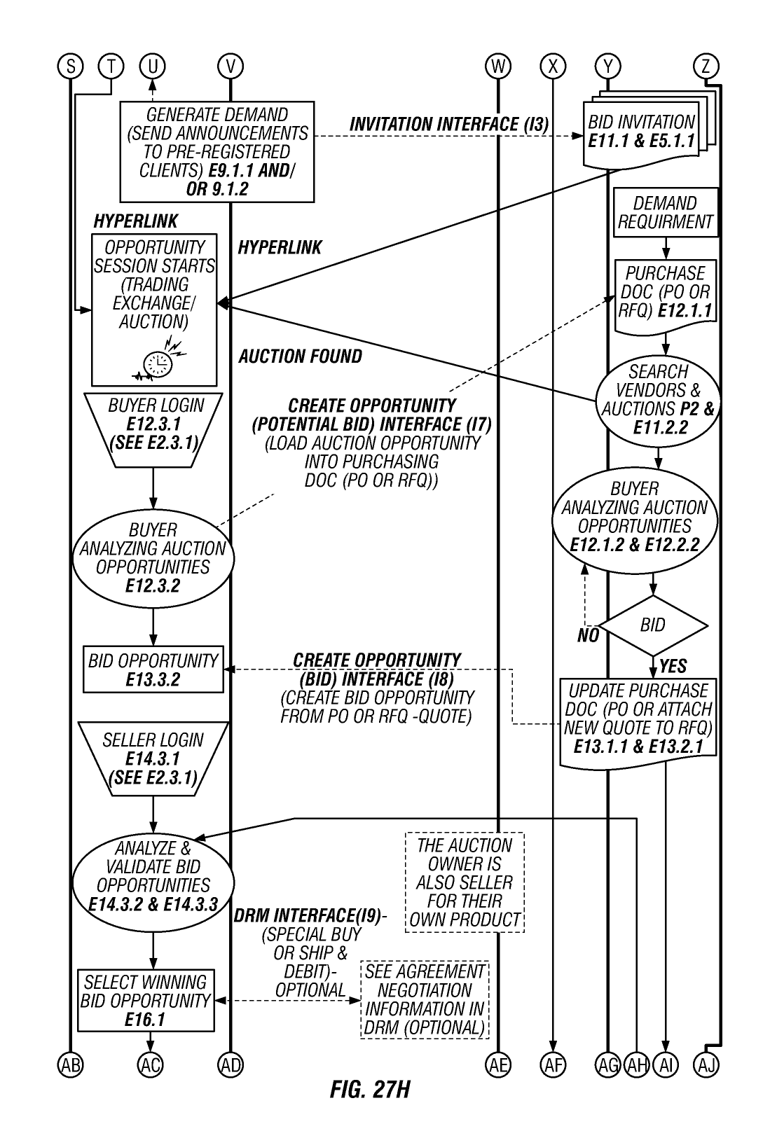

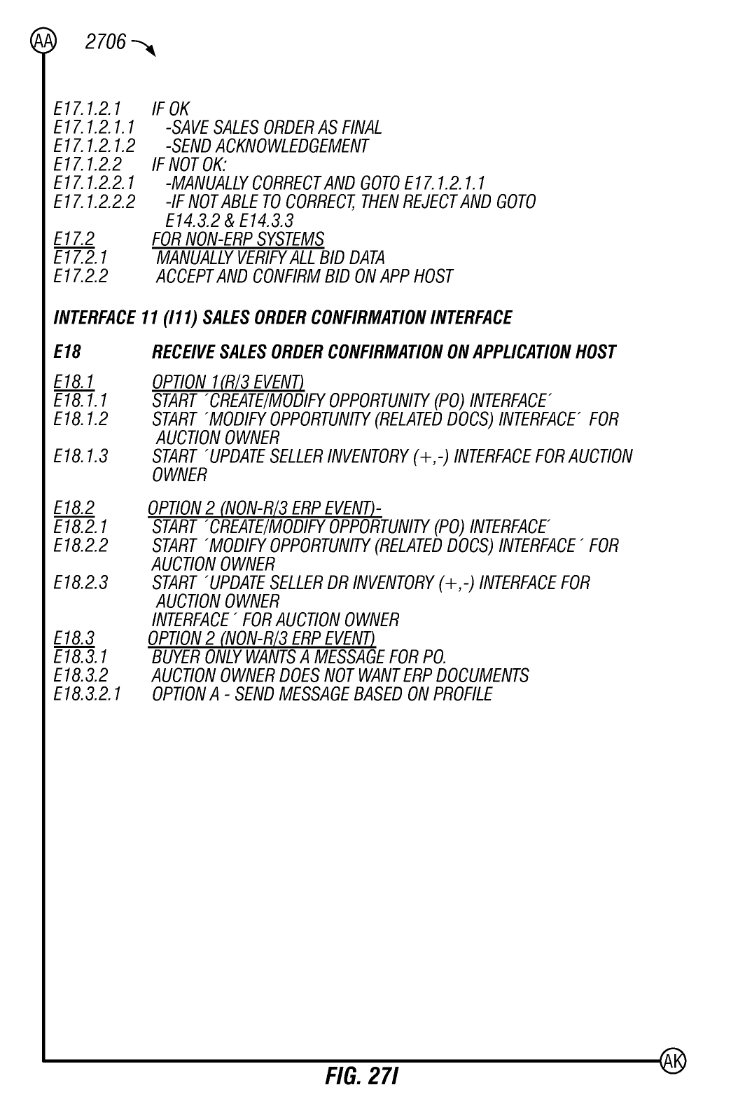

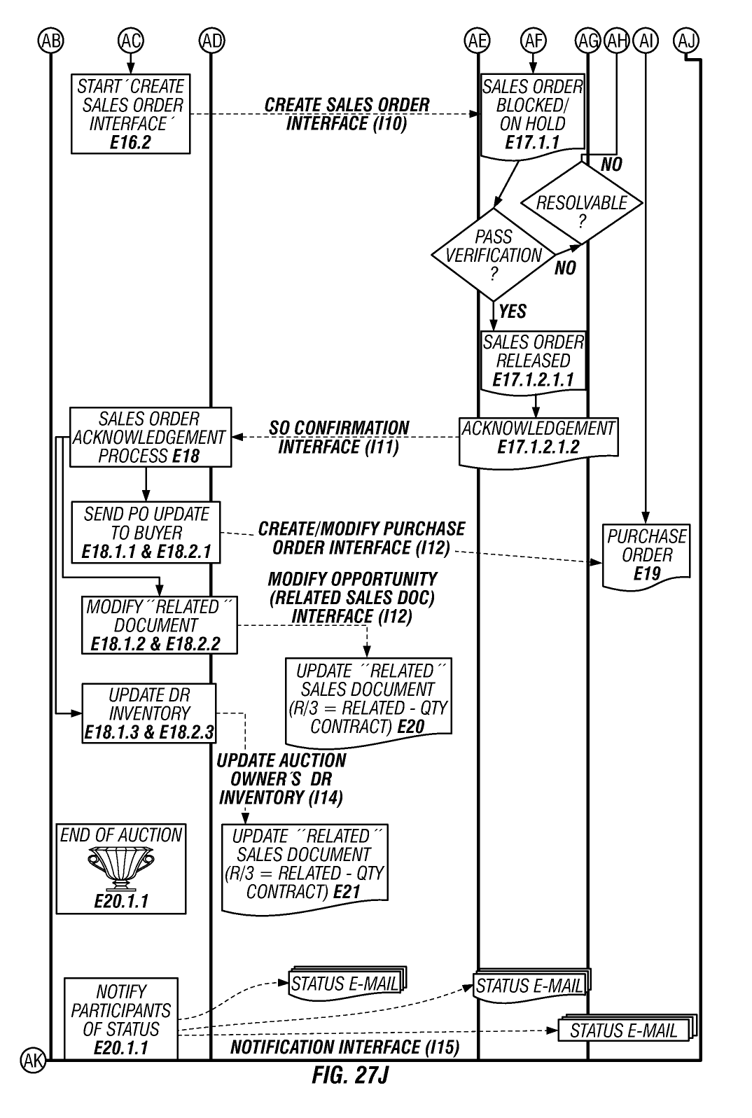

FIGS. 27A-27J illustrate user views of sample graphical format business object templates 2700, 2702, 2704, 2706, which combine graphical and textual information in one depiction. The templates 2700, 2702, 2704, 2706 may combine elements of conventional flowcharts and UML activity diagrams. FIGS. 27A-27J shows a “Product Strategy” process designed for a DTOPPS application. The templates 2700, 2702, 2704, 2706 may have a process, event and interface column 2710, an application host column 2712, an initiator column 2714, a respondent column 2716 and a respondent column 2718.

The events (E) marked as Ex.x are closely aligned to the activity objects 1206 (FIG. 12) of the BSM system 150, and events marked as Ex.x.x are consequently on the level of BSM step objects 1208. FIGS. 27A-27J also contain ‘swim-lanes’ for the different actors of the process, as well as links of events to data or document objects.

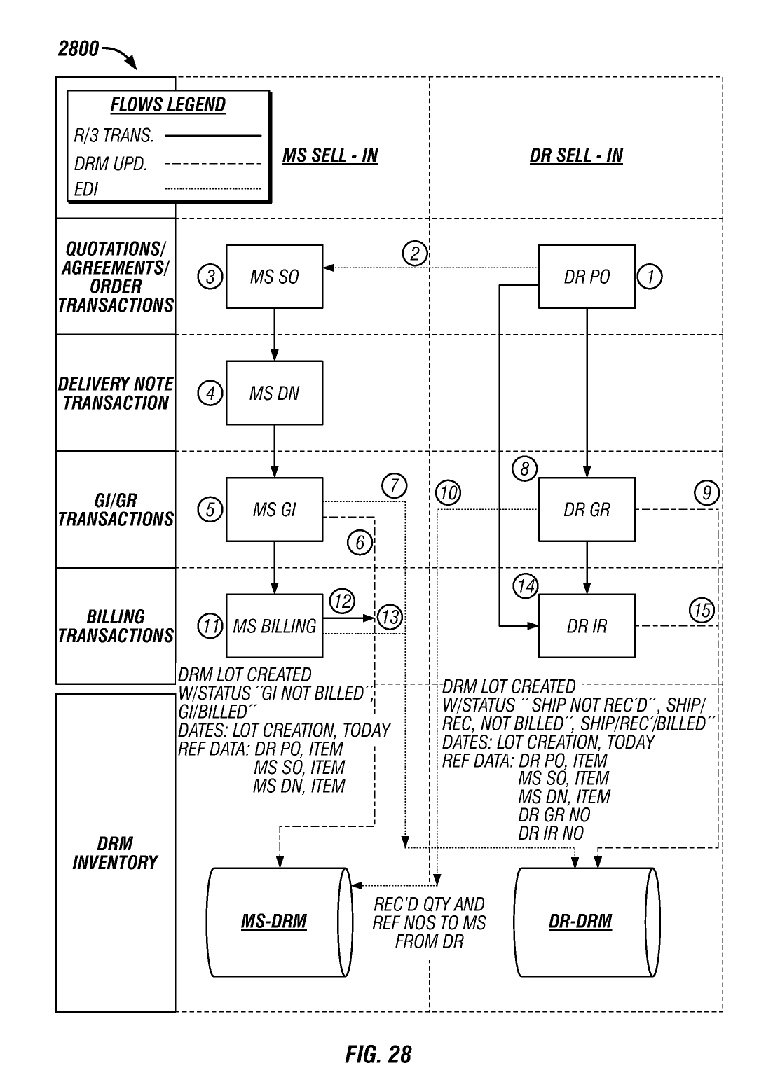

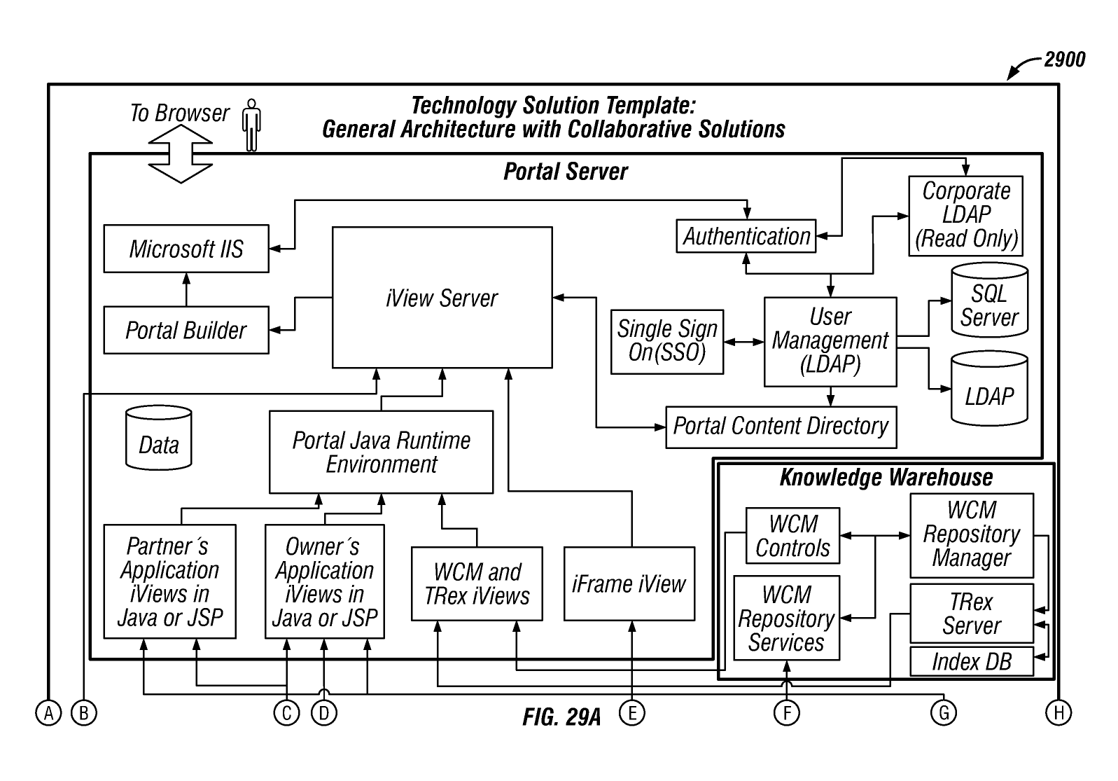

FIG. 28 illustrates an example of a parameter-based format business object template 2800, which shows graphical and parameter-based, textual information separately and creates linkages between these types of information through references. FIG. 28 illustrates a Sell-In process in Distributor and Reseller Management (DRM). FIG. 28 shows a flow of activities and assigns numbers to these activities. These numbers are described below, where the sequences of steps within each activity are listed. When a manufacturing company sells its products indirectly, it sells them usually to distributors or resellers. “Sell-in” is the amount that the manufacturer sells to the distributor or reseller. “Sell-through” is the amount that this distributor or reseller sells to the actual end consumer.

Activity 1: DR R/3 Transaction—Purchase Order

1. The DR creates a purchase order for its normal sell—in inventory requirements from a specific source of the material desired.

1.1. The DR will apply purchasing info pricing condition master.

1.2. Price lists may include Distributor Base Price (Disti, DBP, or DC), MPP (Marketing Price Program), DMR (Distributor Market Resale), or other price lists.

1.3. The appropriate price list value is applied. Therefore, typically the price list condition type with the lowest applicable active master data will be the price protectable value of the material purchased.

1.4. PO currency may be different from inventory currency.

1.5. The PO item's Unit of Measure may be different from inventory UoM.

2. The DR will provide the MS with the DR's appropriate tracking partner identification. The tracking partner represents the DR's grouping of procured inventories for use in the MS tracking of DR inventories. This is a DRM-specific partner role/function.

3. The output of the PO may include EDI, fax, mail, etc.

4. Actual vendor on PO may not be the manufacturer of the material. Price protection rules are established and maintained by the manufacturer/supplier.

Additionally, DR and Vendor may have an arrangement for a volume purchase agreement. MS may have provided special promotion pricing that may be document specific (without price master record) or extended price conditions.

Activity 2: EDI Transaction—Purchase Order

1. EDI is issued by the DR to the vendor

2. The Idoc is output directly from the PO.

3. If either the DR or its vendor do not utilize EDI, then layout sets or some other manual applications will be utilized for this communication.

Activity 3: MS R/3 transaction—Sales Order

1. DR's vendor receives the purchase order data and creates a sales order.

1.1. If both the MS and DR support the EDI transaction, the sales order is created automatically.

1.2. If EDI is not supported, the sales order is created manually.

2. MS assigns PO number and line item number to the sales order and line item.

3. MS has maintained multiple price lists for its DR customer base

3.1. MS will maintain sales price lists master data.

3.2. DRM will select the price protectable value from the price procedure as a predetermined condition type.

4. Currency of the customer may be different from the currency of the base price lists' values.

5. UoM of the sales unit to the customer may be different from the price protectable UoM of the MS.

MS may use a field on the customer master record to identify which price list the DR customer is valid for. A possible solution is to use either the price list type or the customer pricing group fields of the standard R/3 customer master. MS may use a field on the material master record to identify which price list the material is valid for, e.g. MPP. A possible solution is to use the material price group field. MS may apply standard R/3 pricing solution tools such as pricing agreement, exclusion groups, etc. to arrive at desired price to the DR.

Activity 4: MS R/3 Transaction—Delivery Note

1. The MS creates a delivery note for the picking and shipment of the material to the DR.

Activity 5: MS R/3 Transaction—Goods Issue

1. The MS records the goods issue/shipment of the materials to the DR.

2. The goods issue creates an output to update the MS DRM Lot table

3. The goods issue creates an Idoc output for the DR's DRM system, advising of the shipment.

4. If either the MS or DR do not support the EDI transaction, other goods issue output media (fax, email, bills of lading, waybill, etc.) may be used to allow shipment advise to be generated to the DR.

Activity 6: MS—DRM Lot Table Update

1. MS-DRM lot table is updated from the Delivery Note goods issue transaction

1.1. Lot identifies tracking partner of DR, material, normal sell-in lot type

1.2. Status of the lot in DRM is set to “Shipped not billed”

1.3. Quantity is taken from the goods issue transaction

1.4. Price protectable value is taken from the sales order's pricing procedure. A possible solution is to copy the active condition type value to another condition type which gives the price protectable component.

2. For additional reference information, DRM stores:

2.1. The associated DR PO and PO Item numbers

2.2. The MS sales order and sales order line item number

2.3. The MS delivery note and delivery note line item number

2.4. The MS goods issue material movement document number

Activity 7: EDI Transaction—Shipment Advice from MS to DR

1. The EDI Transaction created by the MS goods issue transaction will contain the following key information for the DR.

1.1. DR PO and line item numbers

1.2. MS sales order and line item numbers

1.3. MS delivery note and line item numbers

1.4. MS goods issue document number

1.5. DR tracking partner from the MS sales order's line item

1.6. Quantity from the MS goods issue document

1.7. Price protectable value from the MS sales order item's active condition type value

1.8. Total value that is expected to be billed for the quantity shipped.

2. If the DR utilizes EDI for this Shipment Advice, the DR-DRM system will be updated.

3. If the DR's goods receipt transaction has not been previously recorded, this data is used by the DR-DRM system to create a new DR IM batch

3.1. The DR IM batch created will contain quantity of zero.

3.2. The DRM status for the batch will be “Shipped by MS, not yet received”

3.3. MS expected billing value would be stored.

3.4. The expected price protectable value is also maintained.

3.5. The DR's vendor ID of the supplying MS

3.6. DR PO and line item numbers

3.7. MS sales order and line item numbers

3.8. MS delivery note and line item numbers

3.9. MS goods issue document number

4. If the DR's goods receipt transaction occurs before the receipt of this shipment advice, or if the MS or DR do not utilize EDI for these advanced ship notifications, the shipment documents that accompany the receipt of goods at the DR may be used for manual DRM entry of key data to the system.

Activity 8: R/3 Transaction—DR Goods Receipt

1. The DR records the goods receipt for the material shipment.

2. If the goods receipt occurs before the receipt of a Shipment Advice from the MS, or the either the MS or DR do not utilize EDI for this Shipment Advice:

2.1. The goods receipt will create a new IM batch

2.2. The DR IM batch created will contain quantity received.

2.3. The DRM status for the DRM information structure will be “Received not yet billed”

2.4. The batch values will be derived from the PO

2.5. DRM will also maintain the DR's PO price protectable value

2.6. The DR's vendor ID of the supplying MS from the PO

2.7. DR PO and line item numbers

2.8. On receipt of the shipment documentation from the MS, the DR users may enter the following data manually to the DRM lot information:

2.8.1 MS Sales order and line item numbers

2.8.2 MS delivery note and line item numbers

2.8.3 MS goods issue document number

3. If the goods receipt occurs after the data from the MS-Shipment Advice is entered into the DR system, the goods receipt will update the batch created at receipt of the Shipment Advice.

3.1. The batch will be updated to the quantity received.

3.2. The status will be changed to “Received not yet billed”

Activity 9: R/3 Transaction-DR-DRM Lot Data Update

1. All data recorded from the goods receipt transaction that is not part of the IM batch data, or an extension of the IM batch data, will be posted to an extended DRM lot table that is cross-indexed to the related batch in IM.

Activity 10: EDI Transaction-DR Goods Receipt Notification to the MS

1. The goods receipt transaction document will create an Idoc for an EDI notification by the DR to the MS.

2. The Idoc and EDI will contain:

2.1. The DR PO and line item numbers

2.2. The DR goods receipt document number

2.3. The MS sales order and line item number

2.4. The MS delivery and line item number

2.5. The date of the goods receipt

2.6. The quantity received

2.7. The batch ID Number

b 3. If EDI is not utilized by either the MS or the DR for this activity, then the output from the DR goods receipt may be email, fax, etc.

4. The MS-DRM system updates the MS lot data with the DR's goods receipt notification data

4.1. Status “Shipped, received, not yet billed”

4.2. The DR goods receipt document number and line item number.

4.3. The DR quantity received

4.4. The DR batch number assigned

Activity 11: R/3 Transaction-MS Billing Document

1. The MS generates a billing document to invoice the DR

2. If price changes and related price protection occurs before the billing document; new pricing may or may not be calculated at the creation of the billing document. This should be synchronized with the MS “billup” rules and procedures.

Activity 12: MS-DRM Update for Billing

1. The final total billed value is drawn from the net value of the billing item.

2. The final price protectable value is drawn from the active condition type of the billing document.

3. The status of the DRM lot is reset to “Shipped, Received and billed”

4. The MS billing document and line item numbers are assigned to the DRM lot

Activity 13: EDI Transaction with MS Billed Information

1. The MS billing document generates outputs that may include an Idoc for EDI, email, fax, etc.

2. If the MS and DR both utilize EDI for billing, the DR-DRM system will be updated from the EDI data with:

2.1. MS billing document and line item numbers.

2.2. The final total billed value is drawn from the net value of the billing item.

2.3. The invoice price protectable value is drawn from the active condition type of the billing document.

2.4. DR PO No., PO Line Item No.

2.5. MS SO No., SO Line Item No.

2.6. MS DN No., DN Line Item No.

2.7. MS Invoice Date.

3. The batch price protectable value is updated with actual PP Value.

Activity 14: R/3 Transaction-DR Invoice Receipt

1. The invoice from the MS is received and recorded within the DR's R/3 system.

2. The batch value is updated with actual billed value drawn from the IR.

3. The batch status is reset to “Received and billed”

It may be possible to apply the billing EDI from the MS in activity 13 directly to the automatic creation of the invoice receipt in activity 15. Then DRM update for the billing information would not come from both activity 13 and 15.

Activity 15: DR-DRM Update

1. All data recorded from the invoice receipt transaction that is not part of the IM batch data, or an extension of the IM batch data, will be posted to an extended DRM lot table that is cross-indexed to the related batch in IM.

Technology Object Templates of the Example Scenario

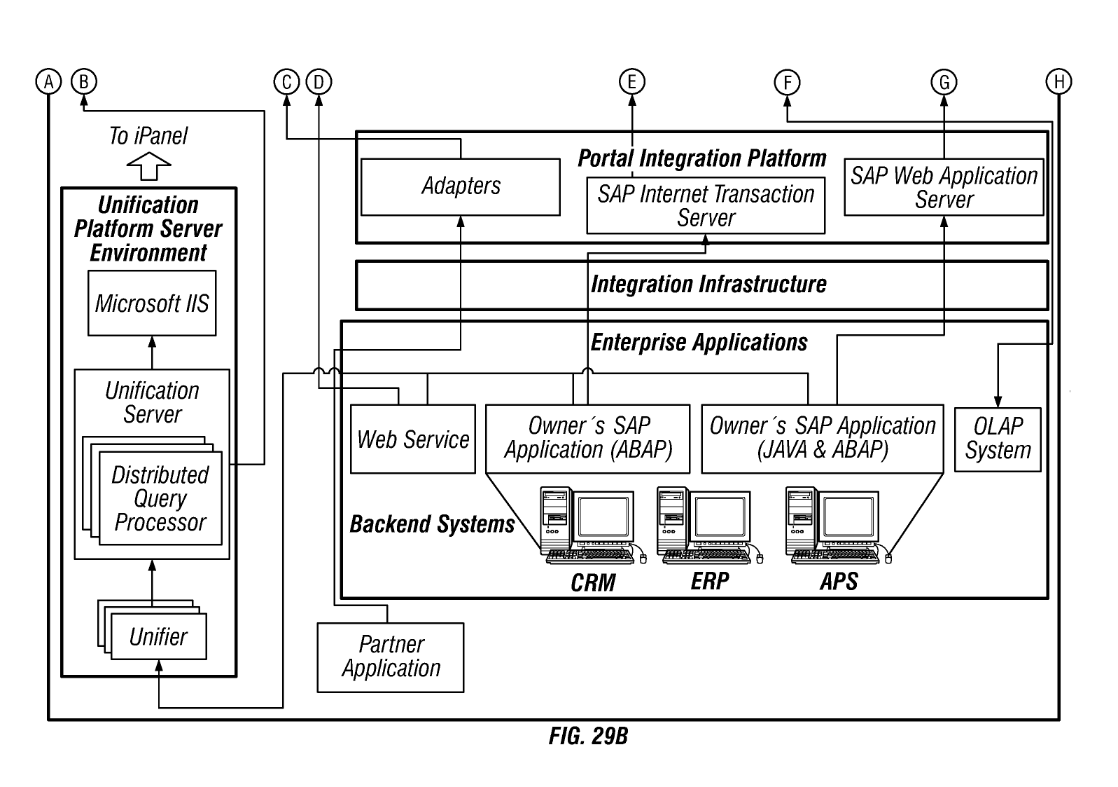

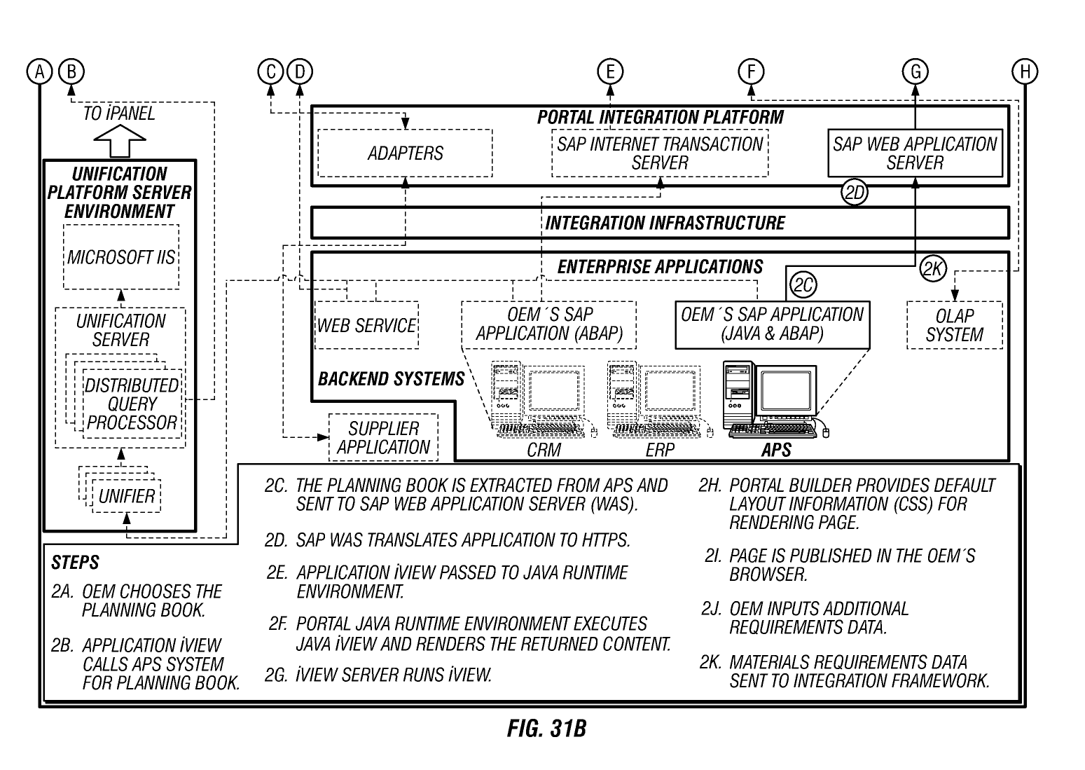

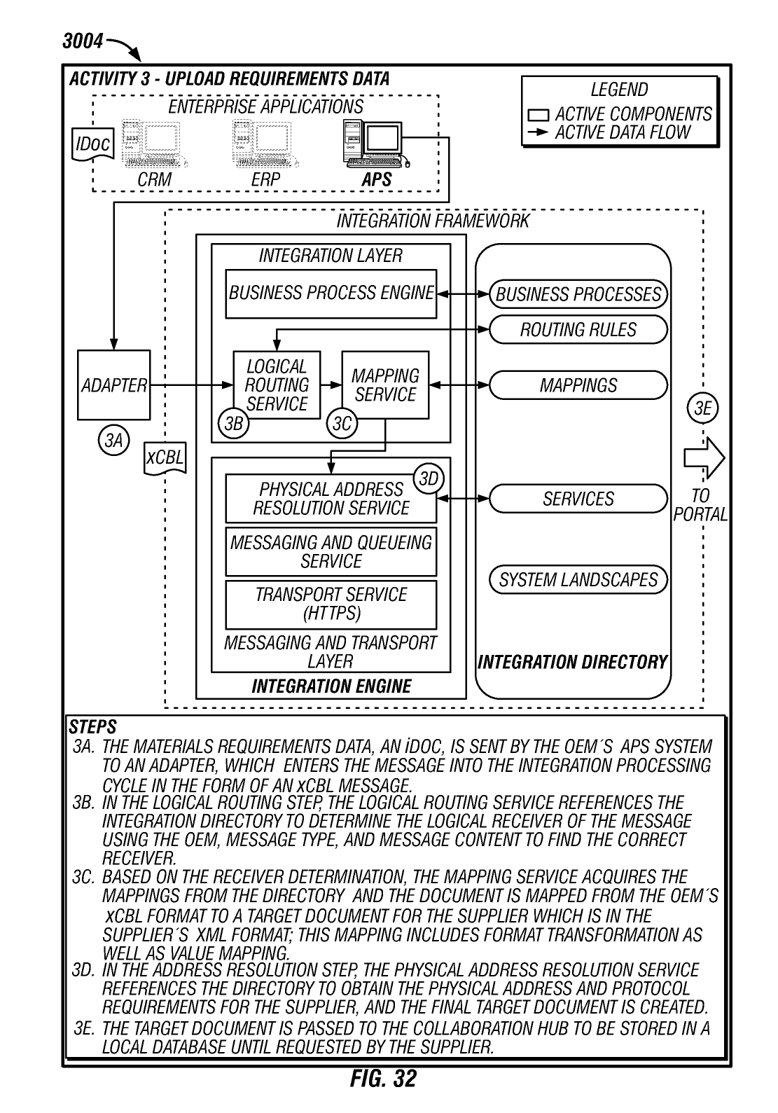

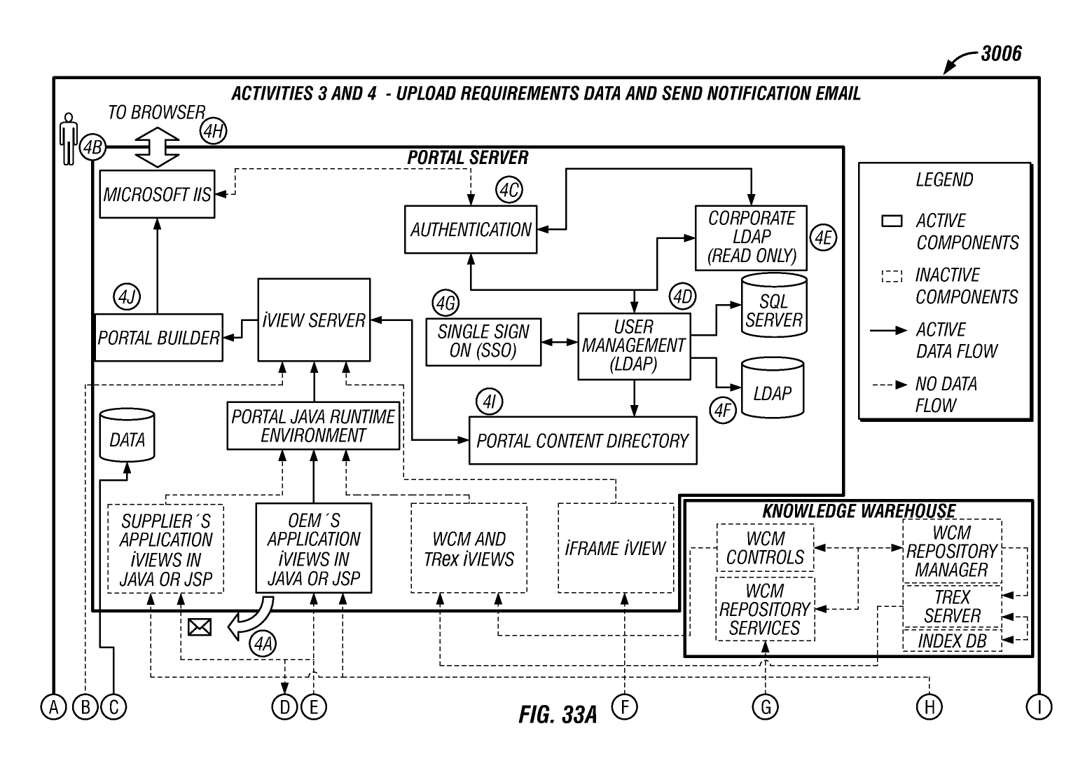

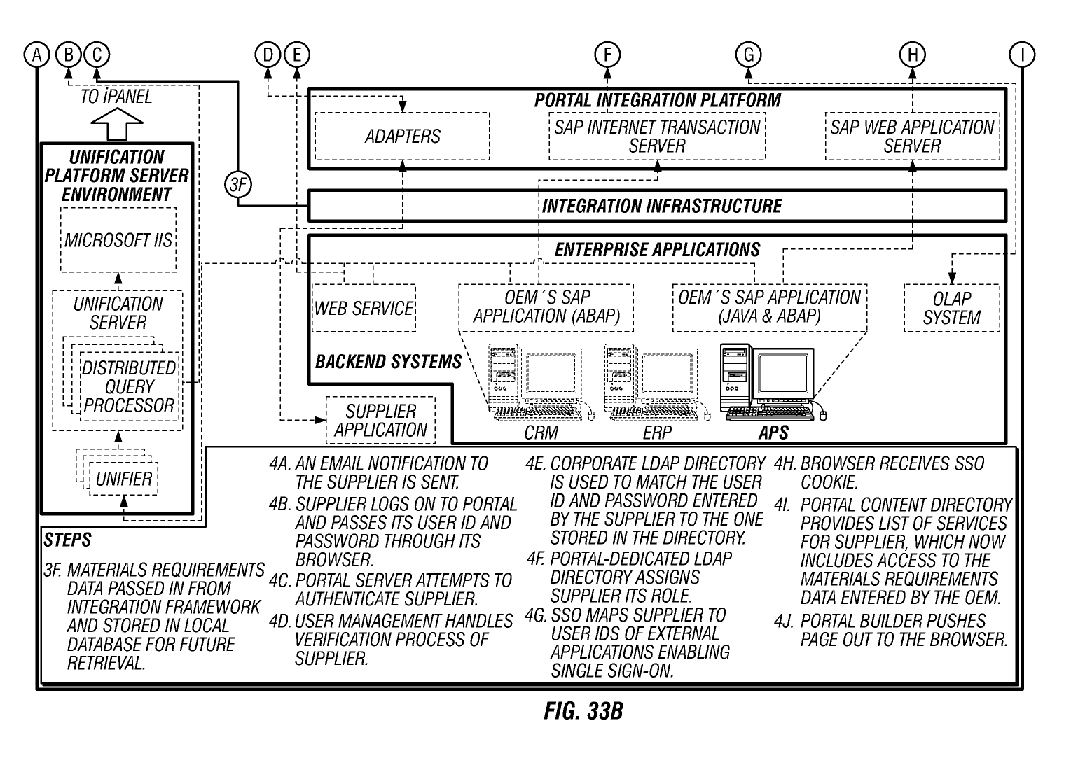

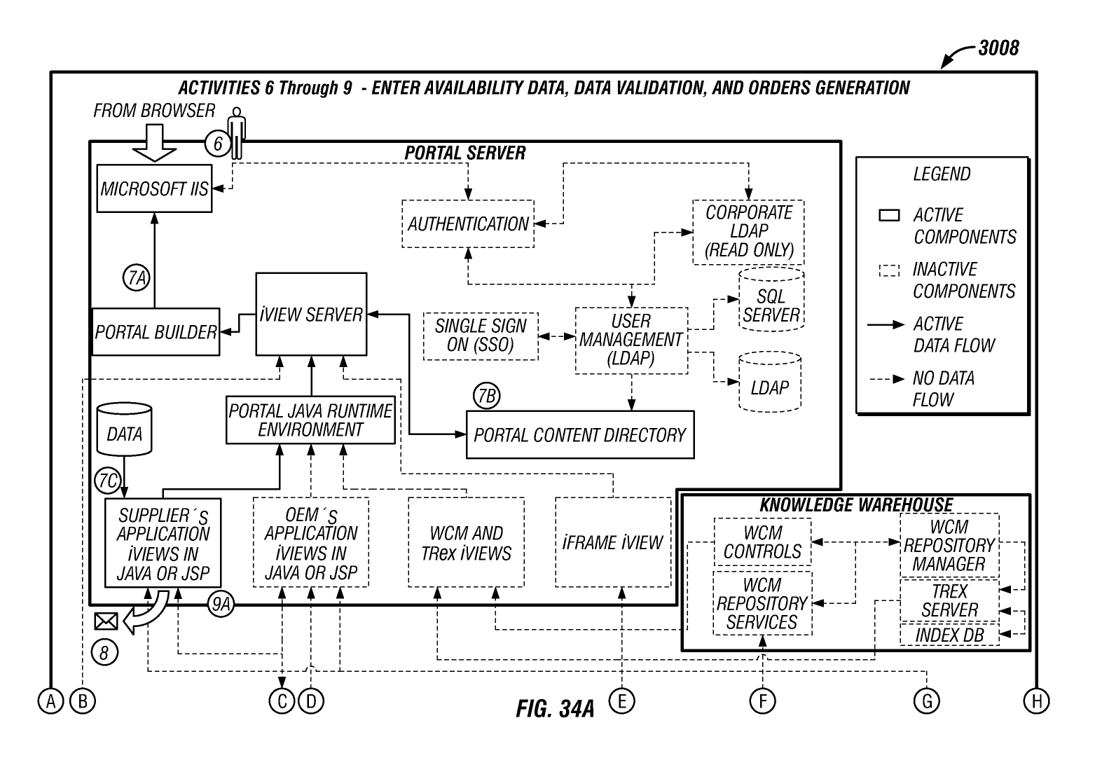

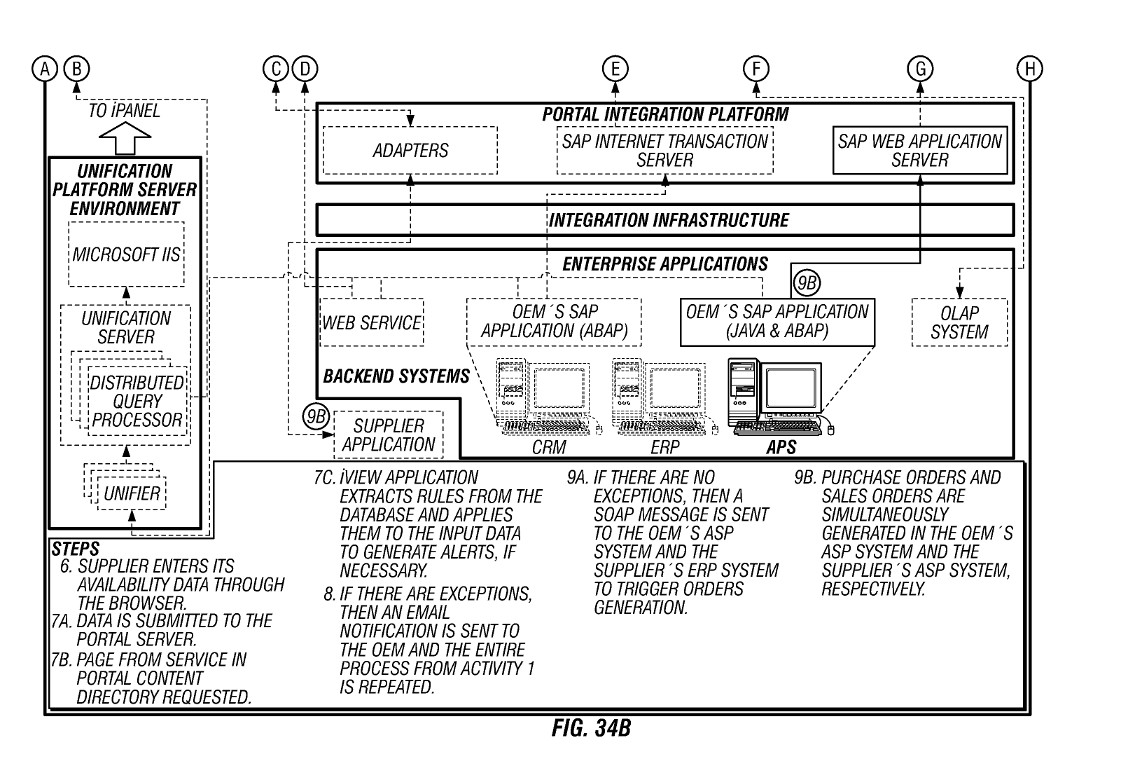

FIGS. 29A-34B illustrate examples of technology object templates 2900, 3000-3008, which are related to FIGS. 21-23 described above. FIGS. 29A-29B show a generic technology object template 2900, which comprises a plurality of technology objects that may be used in two-party collaboration applications. FIGS. 29A-29B may be a more detailed diagram of FIGS. 21A-21B. The concrete technology landscape that is developed during the SDE process 508 (FIG. 5B) is a subset of this generic template 2900.

Solution-specific technology object templates 3000-3008 in FIGS. 22, 30A-34B are generated by highlighting specific technology objects involved in the desired business process. Therefore, the user identifies the technology objects to be used for every activity 1206 (FIG. 12) and step 1208 of the process 1204 with the support of the BSM system 150.

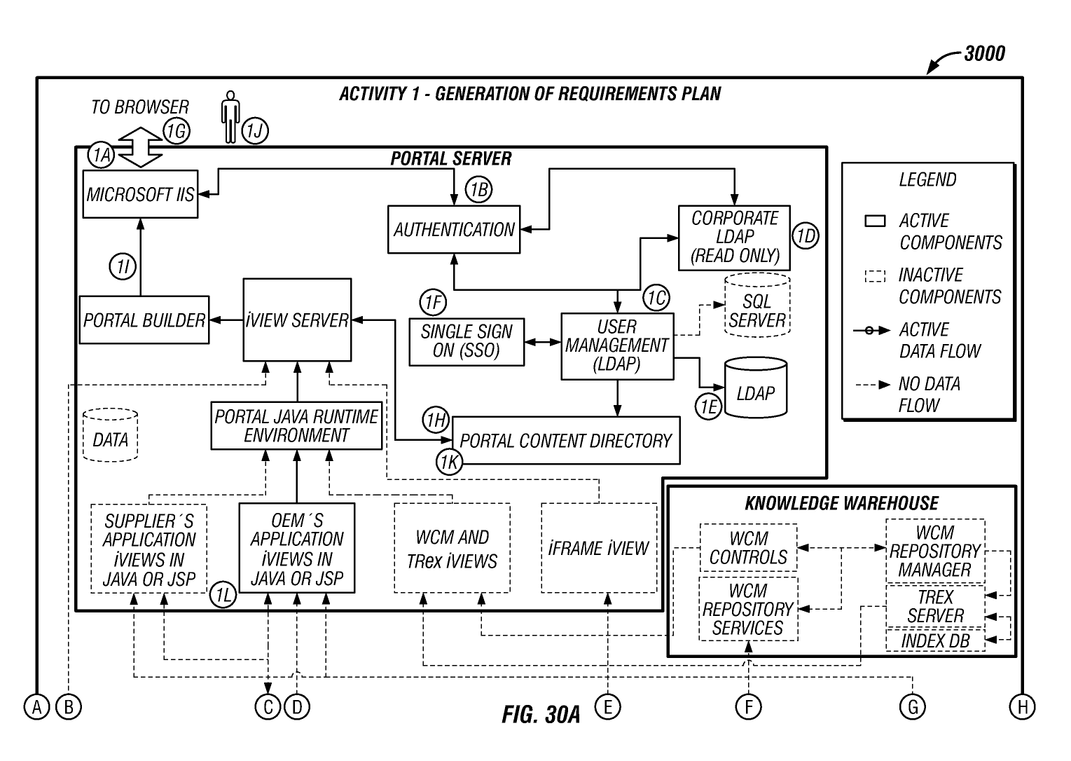

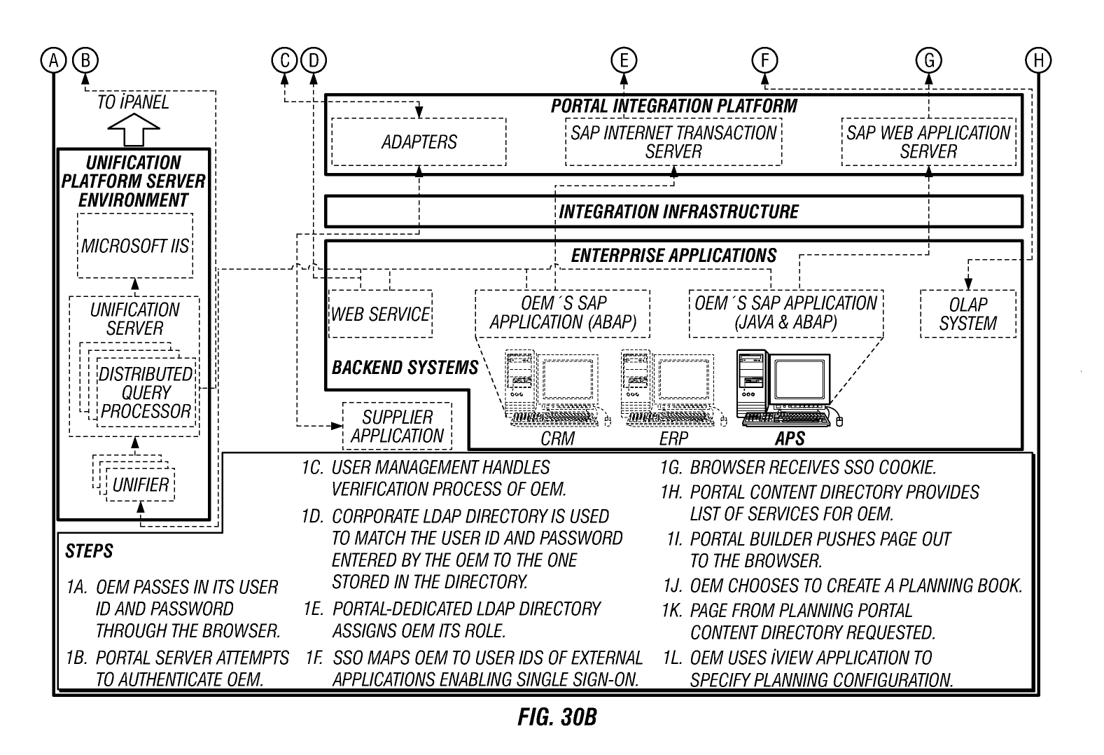

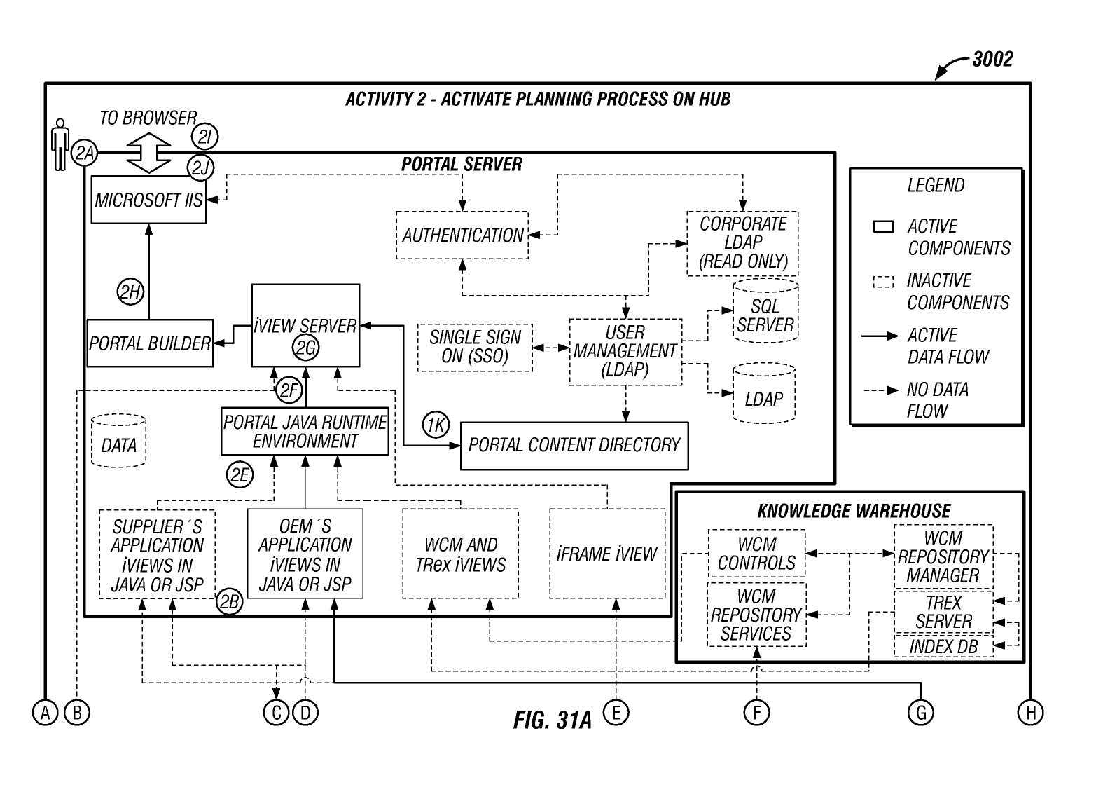

This procedure of highlighting the technology objects used for the sample process of “Collaborative Requirements Planning” was explained above with FIGS. 22A-22B, which shows one technology object template 2200 related to one specific activity of the collaborative requirements process. FIGS. 30A-30E display the complete set of technology object templates for each activity of the sample process.

Cascading Style Sheet (CSS) define style rules that dictate the presentation of an HTML document.

Common Information Model (CIM) is a common data model of an implementation-neutral schema for describing overall management information in a network/enterprise environment.

Lightweight Directory Access Protocol (LDAP) is a protocol for accessing online directory services and runs directly over TCP.

Simple Object Access Protocol (SOAP) is the fundamental message-passing protocol that defines how to send data, typically in XML format, among applications across a network and can be used to build connections between applications, which are described using WSDL. Universal Description, Discovery, and Integration (UDDI) is a set of protocols and APIs that define a registry repository where Web services and their associated WSDL descriptions can be catalogued and searched. Businesses may first search UDDI registries to find suppliers.

Web Services Description Language (WSDL)-WSDL is an XML format for describing network services as a set of communication endpoints, or ports, operating on messages containing either document-oriented or procedure-oriented information. The operations and messages are described abstractly, and then bound to a concrete network protocol and message format to define an endpoint. Related concrete endpoints are combined into abstract endpoints (services).

eXtensible Markup Language (XML) is the universal format for structured documents and data on the Web.

xCBL is a form of XML defined by Commerce One.

As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Computer programs (also known as programs, software, modules, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. The logic flows depicted in the Figures do not require the particular order shown, or sequential order, to achieve desirable results. In certain implementations, multitasking and parallel processing may be preferable. Other embodiments may be within the scope of the following claims.

1-20. (canceled)

21. A method performed with a distributed computing environment for managing a business solution model, comprising:
receiving, with a first computing system within a distributed computing environment, a plurality of business objectives, a plurality of business performance goals, and a plurality of target business areas from a user at a second computing system within the distributed computing environment, the business objectives defining business enterprise strategies, the business performance goals defining desired results of the business enterprise, and the target business areas defining enterprise workflows;
instantiating, with the first computing system, a business initiative object that defines a highest level of an object model of a business solution;
storing, with the first computing system, the one or more received business objectives, the received one or more business performance goals, and the received one or more target business areas as attributes of the instantiated business initiative object;
storing, in a repository communicably coupled to the first computing system, the instantiated business initiative object;
creating, with the first computing system, one or more business solution templates based on the instantiated business initiative object, each of the business solution templates comprising one or more predefined business objects;
generating a graphical model of the business solution based on the one or more business solution templates;
receiving a specified one of the target business areas from the user, the specified business area comprising one of the defined enterprise workflows defining at least one of a sales area, a procurement area, or a manufacturing area; and
associating the generated graphical business solution model with the specified business area.

22. The method of claim 21, further comprising:
assigning an ID, a title, and a description to the instantiated business initiative object;
receiving a request comprising at least one of the assigned ID, title, or description;
presenting the generated graphical business solution model to a second user in response to the request; and
receiving a second plurality of business objectives, a second plurality of business performance goals, and a second plurality of target business areas from the second user; and
modifying the instantiated business initiative object based on the received second plurality of business objectives, second plurality of business performance goals, and second plurality of target business areas.

23. The method of claim 21, wherein the instantiated business initiative object is stored in a database layer of a multilayered architecture comprising the database layer, a portal layer, an application layer and an exchange layer.

24. The method of claim 23, wherein receiving a plurality of business objectives, a plurality of business performance goals, and a plurality of target business areas from a user comprises:
receiving, through a GUI extended from the portal layer to the user, the plurality of business objectives, the plurality of business performance goals, and the plurality of target business areas; and
providing the received plurality of business objectives, the plurality of business performance goals, and the plurality of target business areas from the portal layer to the database layer.

25. The method of claim 24, further comprising:
receiving a selection of a planning process from the user, the selected planning process defining: pre-defined and user-selected user roles, pre-defined and user-selected worksets, pre-defined and user-selected authorization profiles, and pre-defined and user-selected assignments of worksets and authorizations to the user roles; and
implementing the selected planning process to instantiate one or more business objects, each of the one or more business objects linked to at least one of the business solution templates.

26. The method of claim 25, wherein the selected planning process comprises one of a question and answer process or a graphical modeling process.

27. The method of claim 23, wherein each of the business solution templates comprises a business object template, a project template, and a technology object template, the technology object template defining one or more hardware specification of the distributed computing system that includes the multilayered architecture comprising the database layer, the portal layer, the application layer, and the exchange layer.

28. A non-transitory computer storage medium encoded with a computer program, the program comprising instructions that when executed by one or more computers cause the one or more computers to perform operations comprising:
receiving, with a first computing system within a distributed computing environment, a plurality of business objectives, a plurality of business performance goals, and a plurality of target business areas, from a user at a second computing system within the distributed computing environment, the business objectives defining business enterprise strategies, the business performance goals defining desired results of the business enterprise, and the target business areas defining enterprise workflows;
instantiating, with the first computing system, a business initiative object that defines a highest level of an object model of a business solution;
storing, with the first computing system, the one or more received business objectives, the received one or more business performance goals, and the received one or more target business areas as attributes of the instantiated business initiative object;
storing, in a repository communicably coupled to the first computing system, the instantiated business initiative object;
creating, with the first computing system, one or more business solution templates based on the instantiated business initiative object, each of the business solution templates comprising one or more predefined business objects;
generating a graphical model of the business solution based on the one or more business solution templates;
receiving a specified one of the target business areas from the user, the specified business area comprising one of the defined enterprise workflows defining at least one of a sales area, a procurement area, or a manufacturing area; and
associating the generated graphical business solution model with the specified business area.

29. The medium of claim 28, wherein the operations further comprise:
assigning an ID, a title, and a description to the instantiated business initiative object;
receiving a request comprising at least one of the assigned ID, title, or description;
presenting the generated graphical business solution model to a second user in response to the request; and
receiving a second plurality of business objectives, a second plurality of business performance goals, and a second plurality of target business areas from the second user; and
modifying the instantiated business initiative object based on the received second plurality of business objectives, second plurality of business performance goals, and second plurality of target business areas.

30. The medium of claim 28, wherein the instantiated business initiative object is stored in a database layer of a multilayered architecture comprising the database layer, a portal layer, an application layer and an exchange layer.

31. The medium of claim 30, wherein receiving a plurality of business objectives, a plurality of business performance goals, and a plurality of target business areas from a user comprises:
receiving, through a GUI extended from the portal layer to the user, the plurality of business objectives, the plurality of business performance goals, and the plurality of target business areas; and
providing the received plurality of business objectives, the plurality of business performance goals, and the plurality of target business areas from the portal layer to the database layer.

32. The medium of claim 31, wherein the operations further comprise:
receiving a selection of a planning process from the user, the selected planning process defining: pre-defined and user-selected user roles, pre-defined and user-selected worksets, pre-defined and user-selected authorization profiles, and pre-defined and user-selected assignments of worksets and authorizations to the user roles; and
implementing the selected planning process to instantiate one or more business objects, each of the one or more business objects linked to at least one of the business solution templates.

33. The medium of claim 32, wherein the selected planning process comprises one of a question and answer process or a graphical modeling process.

34. The medium of claim 28, wherein each of the business solution templates comprises a business object template, a project template, and a technology object template, the technology object template defining one or more hardware specification of the distributed computing system that includes the multilayered architecture comprising the database layer, the portal layer, the application layer, and the exchange layer.

35. A system of one or more computers configured to perform operations comprising:
receiving, with a first computing system within a distributed computing environment, a plurality of business objectives, a plurality of business performance goals, and a plurality of target business areas, from a user at a second computing system within the distributed computing environment, the business objectives defining business enterprise strategies, the business performance goals defining desired results of the business enterprise, and the target business areas defining enterprise workflows;
instantiating, with the first computing system, a business initiative object that defines a highest level of an object model of a business solution;
storing, with the first computing system, the one or more received business objectives, the received one or more business performance goals, and the received one or more target business areas as attributes of the instantiated business initiative object;
storing, in a repository communicably coupled to the first computing system, the instantiated business initiative object;
creating, with the first computing system, one or more business solution templates based on the instantiated business initiative object, each of the business solution templates comprising one or more predefined business objects;
generating a graphical model of the business solution based on the one or more business solution templates;
receiving a specified one of the target business areas from the user, the specified business area comprising one of the defined enterprise workflows defining at least one of a sales area, a procurement area, or a manufacturing area; and
associating the generated graphical business solution model with the specified business area.

36. The system of claim 35, wherein the operations further comprise:
assigning an ID, a title, and a description to the instantiated business initiative object;
receiving a request comprising at least one of the assigned ID, title, or description;
presenting the generated graphical business solution model to a second user in response to the request; and
receiving a second plurality of business objectives, a second plurality of business performance goals, and a second plurality of target business areas from the second user; and
modifying the instantiated business initiative object based on the received second plurality of business objectives, second plurality of business performance goals, and second plurality of target business areas.

37. The system of claim 35, wherein the instantiated business initiative object is stored in a database layer of a multilayered architecture comprising the database layer, a portal layer, an application layer and an exchange layer.

38. The system of claim 37, wherein receiving a plurality of business objectives, a plurality of business performance goals, and a plurality of target business areas from a user comprises:
receiving, through a GUI extended from the portal layer to the user, the plurality of business objectives, the plurality of business performance goals, and the plurality of target business areas; and
providing the received plurality of business objectives, the plurality of business performance goals, and the plurality of target business areas from the portal layer to the database layer.

39. The system of claim 38, wherein the operations further comprise:
receiving a selection of a planning process from the user, the selected planning process defining: pre-defined and user-selected user roles, pre-defined and user-selected worksets, pre-defined and user-selected authorization profiles, and pre-defined and user-selected assignments of worksets and authorizations to the user roles; and
implementing the selected planning process to instantiate one or more business objects, each of the one or more business objects linked to at least one of the business solution templates.

40. The system of claim 35, wherein each of the business solution templates comprises a business object template, a project template, and a technology object template, the technology object template defining one or more hardware specification of the distributed computing system that includes the multilayered architecture comprising the database layer, the portal layer, the application layer, and the exchange layer.
